(19) United States
(12) Patent Application Publication
(10) Pub. No.: US 2026/0237167 A1
(43) Pub. Date: Aug. 13, 2026

(54) DEVICES, METHODS, AND GRAPHICAL USER INTERFACES FOR SCANNING PHYSICAL ENVIRONMENTS

(71) Applicant: Apple Inc., Cupertino, CA (US)

(72) Inventors: Praveen SHARMA, Brooklyn, NY (US); Noah D. BEDARD, Los Gatos, CA (US); Edward CHAO, Palo Alto, CA (US); Adam J. LEONARD, San Francisco, CA (US); Joseph A. MALIA, London (GB); Jonathan A. TOPF, London (GB)

(21) Appl. No.: 19/532,881

(22) Filed: Feb. 6, 2026

Related U.S. Application Data
(60) Provisional application No. 63/756,669, filed on Feb. 10, 2025.

(51) Int. Cl. G06T 19/00; G06F 3/04815; G06T 13/20; G06V 20/20; G06V 20/40; G06V 40/20

(52) U.S. Cl. CPC G06T 19/006; G06F 3/04815; G06T 13/20; G06V 20/20; G06V 20/44; G06V 40/25; G06V 2201/07

(57) ABSTRACT

The present disclosure generally relates to methods and interfaces for interacting with a physical environment using a computer system. In some examples, symbolic representations of detected objects are displayed without displaying a representation of the physical environment. In some examples, a prompt to change an optical sensor position is provided based on a detected object in the physical environment. In some examples, different types of feedback are provided while scanning depending on an active scan mode. In some examples, in response to detecting a spatial event, different alerts are provided based on different detected optical sensor information.

### CROSS-REFERENCE TO RELATED APPLICATIONS

This application claims priority to U.S. Patent Application No. 63/756,669, entitled “DEVICES, METHODS, AND GRAPHICAL USER INTERFACES FOR SCANNING PHYSICAL ENVIRONMENTS,” filed on Feb. 10, 2025, the content of which is hereby incorporated by reference in its entirety.

### TECHNICAL FIELD

The present disclosure relates generally to computer systems that are in communication with one or more output devices (e.g., optionally including one or more display generation components) and one or more sensors, including one or more optical sensors, and, optionally, one or more spatial information sensors, that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touchscreen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with a physical environment using a computer system are cumbersome, inefficient, and limited. For example, systems that provide insufficient feedback about the physical environment, systems that require a series of inputs to scan and/or interact with the physical environment, and systems in which scanning the physical environment is complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for interacting with a physical environment using a computer system that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges. Such methods and interfaces reduce processing power, thereby reducing heat emitted by the computing devices, which is particularly important for wearable computing devices that can become uncomfortable for a user to wear if too much heat is produced, even when operating well within operational parameters for the device components.

In accordance with some embodiments, a method performed at a computer system that is in communication with one or more display generation components and one or more optical sensors is described. The method includes: detecting, in a portion of a physical environment captured via the one or more optical sensors, a first set of one or more objects; and in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a non-transitory computer-readable storage medium is described. The non-transitory computer-readable storage medium stores one or more programs configured to be executed by one or more processors of a computer system that is in communication with one or more display generation components and one or more optical sensors, the one or more programs including instructions for: detecting, in a portion of a physical environment captured via the one or more optical sensors, a first set of one or more objects; and in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a transitory computer-readable storage medium is described. The transitory computer-readable storage medium stores one or more programs configured to be executed by one or more processors of a computer system that is in communication with one or more display generation components and one or more optical sensors, the one or more programs including instructions for: detecting, in a portion of a physical environment captured via the one or more optical sensors, a first set of one or more objects; and in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a computer system is described. The computer system is configured to communicate with one or more display generation components and one or more optical sensors, and the computer system comprises: one or more processors; and memory storing one or more programs configured to be executed by the one or more processors, the one or more programs including instructions for: detecting, in a portion of a physical environment captured via the one or more optical sensors, a first set of one or more objects; and in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a computer system is described. The computer system is configured to communicate with one or more display generation components and one or more optical sensors, and the computer system comprises: means for detecting, in a portion of a physical environment captured via the one or more optical sensors, a first set of one or more objects; and means for, in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a computer program product is described. The computer program product is configured to be executed by one or more processors of a computer system that is in communication with one or more display generation components and one or more optical sensors, the one or more programs including instructions for: detecting, in a portion of a physical environment captured via the one or more optical sensors, a first set of one or more objects; and in response to detecting the first set of one or more objects, displaying, via the one or more display generation components, a first set of one or more symbolic representations corresponding to the first set of one or more objects, wherein the first set of one or more symbolic representations is displayed without displaying, via the one or more display generation components, a representation of the portion of the physical environment captured via the one or more optical sensors.

In accordance with some embodiments, a method performed at a computer system that is in communication with one or more output devices and one or more sensors, wherein the one or more sensors include one or more optical sensors, is described. The method includes: scanning, via the one or more sensors, a physical environment; and while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a non-transitory computer-readable storage medium is described. The non-transitory computer-readable storage medium stores one or more programs configured to be executed by one or more processors of a computer system that is in communication with one or more output devices and one or more sensors, wherein the one or more sensors include one or more optical sensors, the one or more programs including instructions for: scanning, via the one or more sensors, a physical environment; and while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a transitory computer-readable storage medium is described. The transitory computer-readable storage medium stores one or more programs configured to be executed by one or more processors of a computer system that is in communication with one or more output devices and one or more sensors, wherein the one or more sensors include one or more optical sensors, the one or more programs including instructions for: scanning, via the one or more sensors, a physical environment; and while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a computer system is described. The computer system is configured to communicate with one or more output devices and one or more sensors, wherein the one or more sensors include one or more optical sensors, and the computer system comprises: one or more processors; and memory storing one or more programs configured to be executed by the one or more processors, the one or more programs including instructions for: scanning, via the one or more sensors, a physical environment; and while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a computer system is described. The computer system is configured to communicate with one or more output devices and one or more sensors, wherein the one or more sensors include one or more optical sensors, and the computer system comprises: means for scanning, via the one or more sensors, a physical environment; and means for, while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a computer program product is described. The computer program product is configured to be executed by one or more processors of a computer system that is in communication with one or more output devices and one or more sensors, wherein the one or more sensors include one or more optical sensors, the one or more programs including instructions for: scanning, via the one or more sensors, a physical environment; and while scanning the physical environment: in accordance with a determination that a set of criteria is satisfied, wherein the set of criteria includes a requirement that a scan criterion is satisfied in order for the set of criteria to be satisfied, wherein the scan criterion is satisfied when the physical environment includes a respective type of feature, providing, via the one or more output devices, a prompt to change a position of the one or more optical sensors within the physical environment, wherein the prompt is based on a detected position of the respective type of feature in the physical environment.

In accordance with some embodiments, a method performed at a computer system that is in communication with one or more output devices and one or more sensors, wherein the one or more sensors includes one or more optical sensors, is described. The method includes: scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a non-transitory computer-readable storage medium is described. The non-transitory computer-readable storage medium stores one or more programs configured to be executed by one or more processors of a computer system that is in communication with one or more output devices and one or more sensors, wherein the one or more sensors includes one or more optical sensors, the one or more programs including instructions for: scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a transitory computer-readable storage medium is described. The transitory computer-readable storage medium stores one or more programs configured to be executed by one or more processors of a computer system that is in communication with one or more output devices and one or more sensors, wherein the one or more sensors includes one or more optical sensors, the one or more programs including instructions for: scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a computer system is described. The computer system is configured to communicate with one or more output devices and one or more sensors, wherein the one or more sensors includes one or more optical sensors, and the computer system comprises: one or more processors; and memory storing one or more programs configured to be executed by the one or more processors, the one or more programs including instructions for: scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a computer system is described. The computer system is configured to communicate with one or more output devices and one or more sensors, wherein the one or more sensors includes one or more optical sensors, and the computer system comprises: means for scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and means for, while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a computer program product is described. The computer program product is configured to be executed by one or more processors of a computer system that is in communication with one or more output devices and one or more sensors, wherein the one or more sensors includes one or more optical sensors, the one or more programs including instructions for: scanning, via the one or more sensors, a physical environment, wherein scanning the physical environment includes capturing, via the one or more optical sensors, optical scan data representing a field-of-view of the one or more optical sensors while the field-of-view of the one or more optical sensors moves with respect to the physical environment; and while scanning the physical environment, providing, via the one or more output devices, scanning feedback indicating information about the physical environment, including: in accordance with a determination that a first scan mode is active, initiating a first process for providing, via the one or more output devices, first scanning feedback of a first feedback type; and in accordance with a determination that a second scan mode is active, wherein the second scan mode is different from the first scan mode, initiating a second process for providing, via the one or more output devices, second scanning feedback of a second feedback type that is different from the first feedback type.

In accordance with some embodiments, a method performed at a computer system that is in communication with one or more output devices and one or more sensors, wherein the one or more sensors includes one or more optical sensors and one or more spatial information sensors, is described. The method includes: detecting, based at least in part on spatial information captured via the one or more spatial information sensors that indicates a location and/or movement of the computer system, occurrence of an event; and in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

In accordance with some embodiments, a non-transitory computer-readable storage medium is described. The non-transitory computer-readable storage medium stores one or more programs configured to be executed by one or more processors of a computer system that is in communication with one or more output devices and one or more sensors, wherein the one or more sensors includes one or more optical sensors and one or more spatial information sensors, the one or more programs including instructions for: detecting, based at least in part on spatial information captured via the one or more spatial information sensors that indicates a location and/or movement of the computer system, occurrence of an event; and in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

In accordance with some embodiments, a transitory computer-readable storage medium is described. The transitory computer-readable storage medium stores one or more programs configured to be executed by one or more processors of a computer system that is in communication with one or more output devices and one or more sensors, wherein the one or more sensors includes one or more optical sensors and one or more spatial information sensors, the one or more programs including instructions for: detecting, based at least in part on spatial information captured via the one or more spatial information sensors that indicates a location and/or movement of the computer system, occurrence of an event; and in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

In accordance with some embodiments, a computer system is described. The computer system is configured to communicate with one or more output devices and one or more sensors, wherein the one or more sensors includes one or more optical sensors and one or more spatial information sensors, and the computer system comprises: one or more processors; and memory storing one or more programs configured to be executed by the one or more processors, the one or more programs including instructions for: detecting, based at least in part on spatial information captured via the one or more spatial information sensors that indicates a location and/or movement of the computer system, occurrence of an event; and in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

In accordance with some embodiments, a computer system is described. The computer system is configured to communicate with one or more output devices and one or more sensors, wherein the one or more sensors includes one or more optical sensors and one or more spatial information sensors, and the computer system comprises: means for detecting, based at least in part on spatial information captured via the one or more spatial information sensors that indicates a location and/or movement of the computer system, occurrence of an event; and means for, in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

In accordance with some embodiments, a computer program product is described. The computer program product is configured to be executed by one or more processors of a computer system that is in communication with one or more output devices and one or more sensors, wherein the one or more sensors includes one or more optical sensors and one or more spatial information sensors, the one or more programs including instructions for: detecting, based at least in part on spatial information captured via the one or more spatial information sensors that indicates a location and/or movement of the computer system, occurrence of an event; and in response to detecting the occurrence of the event based on the spatial information, generating, via the one or more output devices, an alert based on optical sensor data captured via the one or more optical sensors, wherein generating the alert includes: in accordance with a determination that first information is detected based on the optical sensor data captured via the one or more optical sensors, generating a first alert including first content; and in accordance with a determination that second information is detected based on the optical sensor data captured via the one or more optical sensors, wherein the second information is different from the first information, generating a second alert including second content, wherein the second content is different from the first content.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7Q illustrate example techniques for scanning a physical environment and providing scan results, in accordance with some embodiments.

FIG. 8 is a flow diagram of methods of scanning a physical environment and providing scan results, in accordance with some embodiments.

FIGS. 9A-9K illustrate example techniques for providing environment-aware guidance for scanning a physical environment, in accordance with some embodiments.

FIG. 10 is a flow diagram of methods of providing environment-aware guidance for scanning a physical environment, in accordance with some embodiments.

FIGS. 11A-11L illustrate example techniques for providing scanning outputs based on scanning a physical environment, in accordance with some embodiments.

FIG. 12 is a flow diagram of methods of providing feedback while scanning a physical environment in different scanning modes, in accordance with some embodiments.

FIG. 13 is a flow diagram of methods of providing alerts based on different information detected while scanning a physical environment, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with a physical environment in multiple ways.

In some embodiments, a computer system displays symbolic representations of objects detected (e.g., recognized) in a physical environment using one or more optical sensors. The symbolic representations of the detected objects are displayed without displaying another representation of the physical environment, such as a live- or near-live feed of a camera of the one or more optical sensors (e.g., a viewfinder). Displaying symbolic representations of objects detected in the physical environment allows the user to quickly review and interact with the computer system based on certain features detected in the environment without the distraction and/or visual clutter of a viewfinder. In addition, displaying symbolic representations of objects without a viewfinder allows scan results to be scaled to a variety of hardware, including computer systems with small displays and/or low-resolution optical sensors.

In some embodiments, while scanning a physical environment using one or more optical sensors, a computer system selectively provides scanning guidance for positioning the one or more optical sensors based on detection of a particular type of feature in the physical environment (e.g., a feature to be scanned). The scanning guidance prompts the user to change the position of the one or more optical sensors with respect to the detected feature in order to improve capture of the detected feature using the one or more optical sensors, allowing the computer system to provide scan results based on the optical sensor data. For example, the scanning guidance indicates to the user when the field-of-view of the optical sensors is misaligned with the feature to be scanned, when the optical sensors are too close to the feature to be scanned, and/or when the optical sensors are too far from the feature to be scanned. Selectively providing scanning guidance provides the user with feedback that assists the user with scanning the physical environment using the one or more optical sensors without cluttering a display with unnecessary visual outputs.

In some embodiments, a computer system provides different scan modes for scanning a physical environment using one or more optical sensors. Depending on the active scan mode, the computer system initiates different processes for providing scan results based on optical sensor data captured as the field-of-view of the one or more optical sensors moves with respect to the physical environment. For example, the different processes for providing scan results include providing the scan results in different conditions, generating different types of output, and/or generating different output content. Providing the different scan modes for scanning the physical environment provides users with more varied scan functionality without requiring numerous user inputs and/or displayed controls to access said functionality, improving the user experience with scanning the physical environment using the one or more optical sensors.

In some embodiments, a computer system detects, using one or more spatial information sensors, the occurrence of an event, such as a current state and/or change to a state of the computer system's location, position, and/or orientation within a physical environment. In response to the occurrence of an event, the computer system generates an alert. The alert includes different contents based on the detection of certain features in the physical environment using one or more optical sensors. Using a combination of spatial information sensor data and optical sensor data to generate alerts about the physical environment proactively provides users with useful, relevant, and/or desirable information and functionality without distracting the user with unnecessary, irrelevant, and/or unwanted alerts.

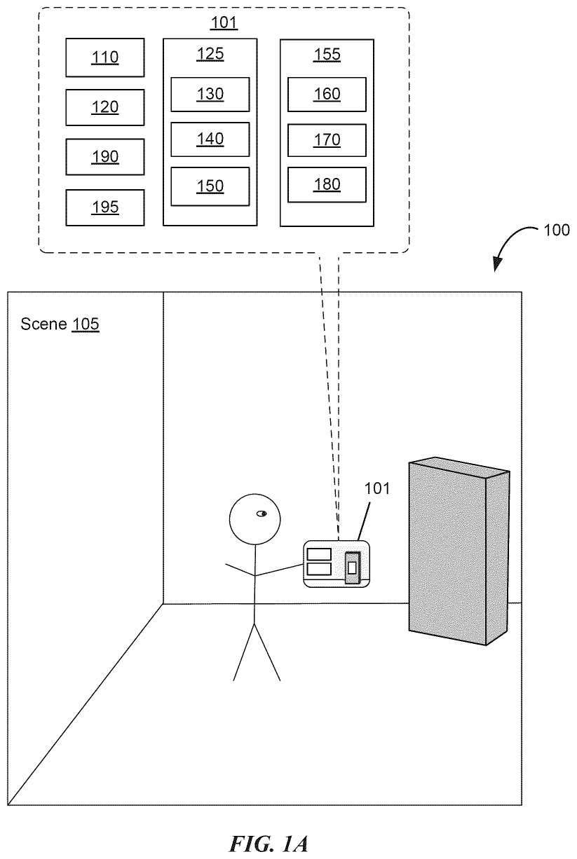

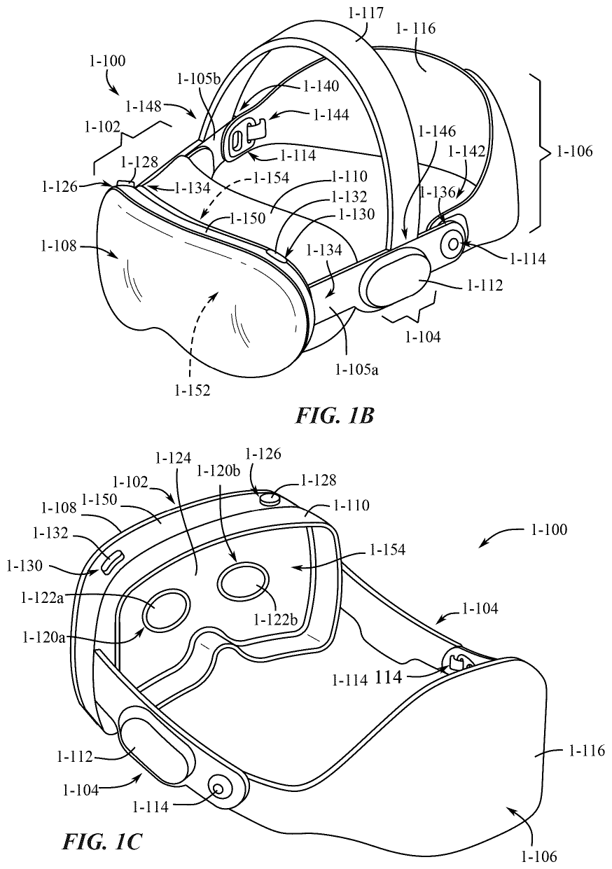

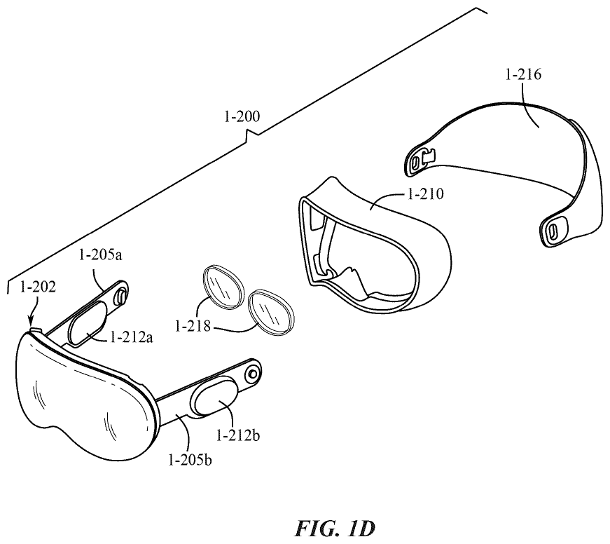

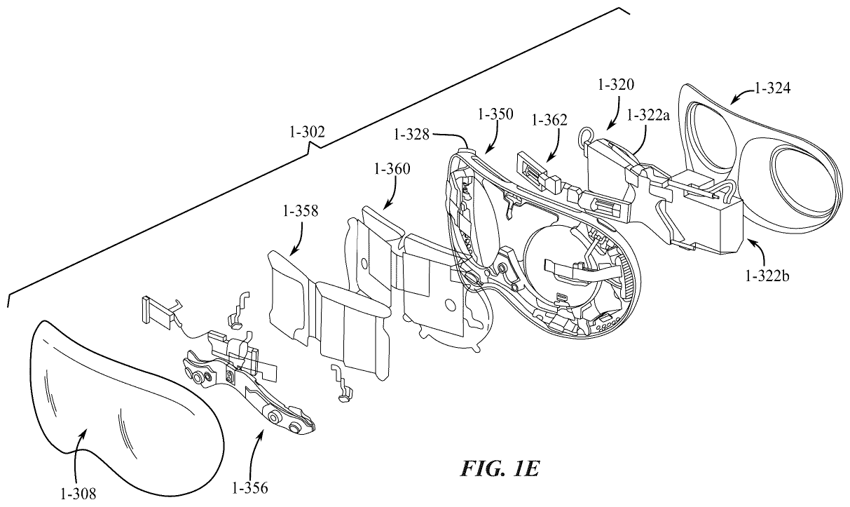

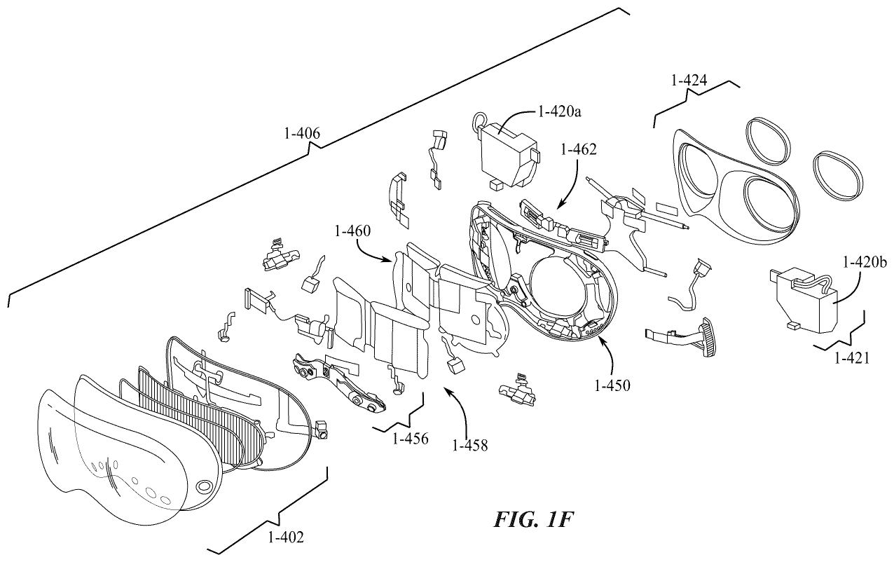

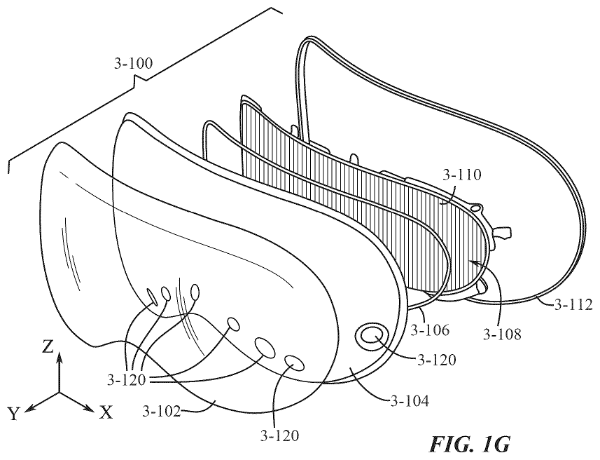

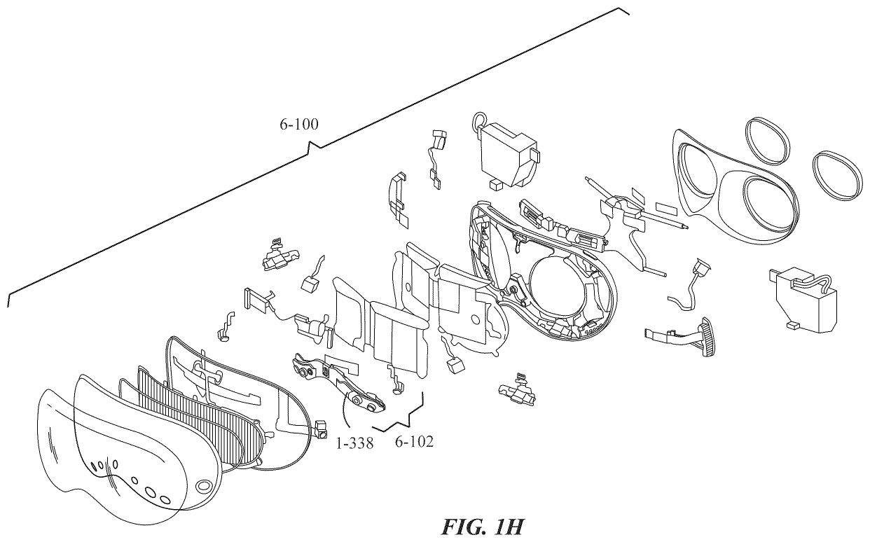

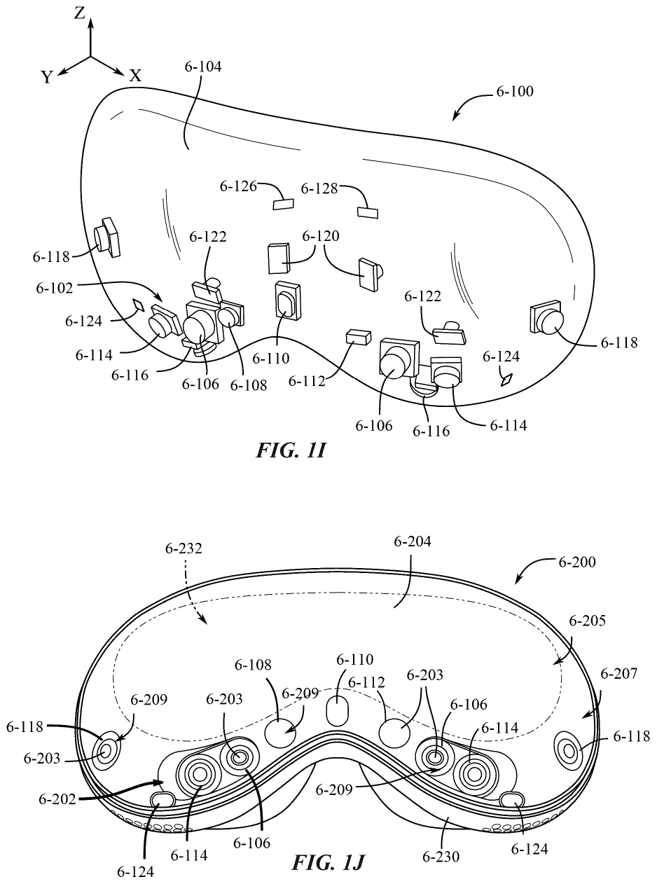

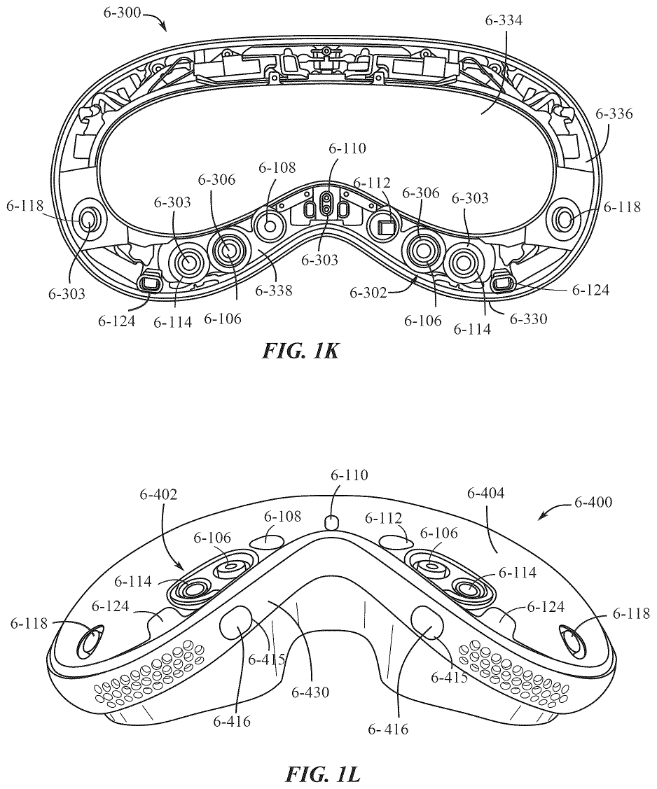

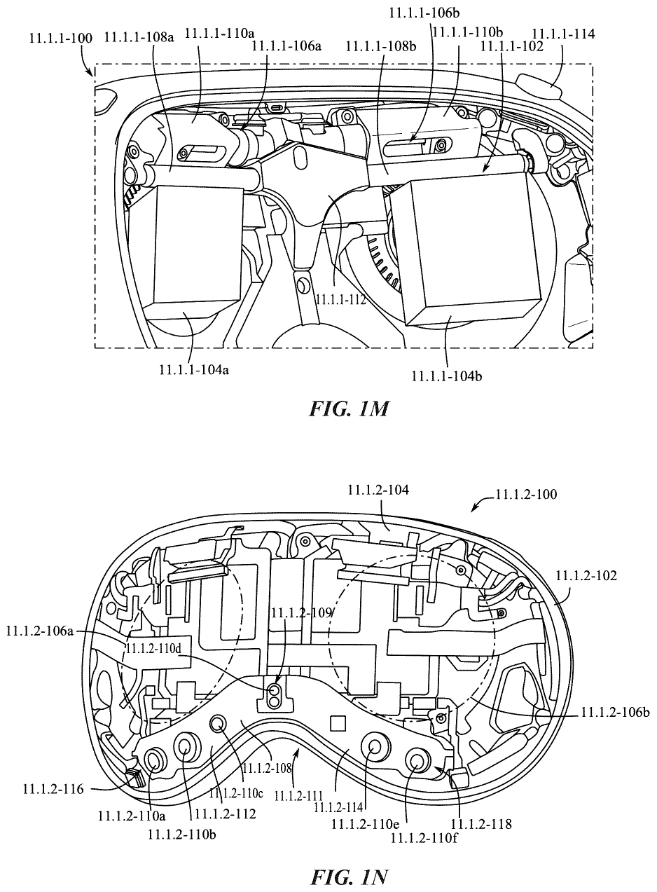

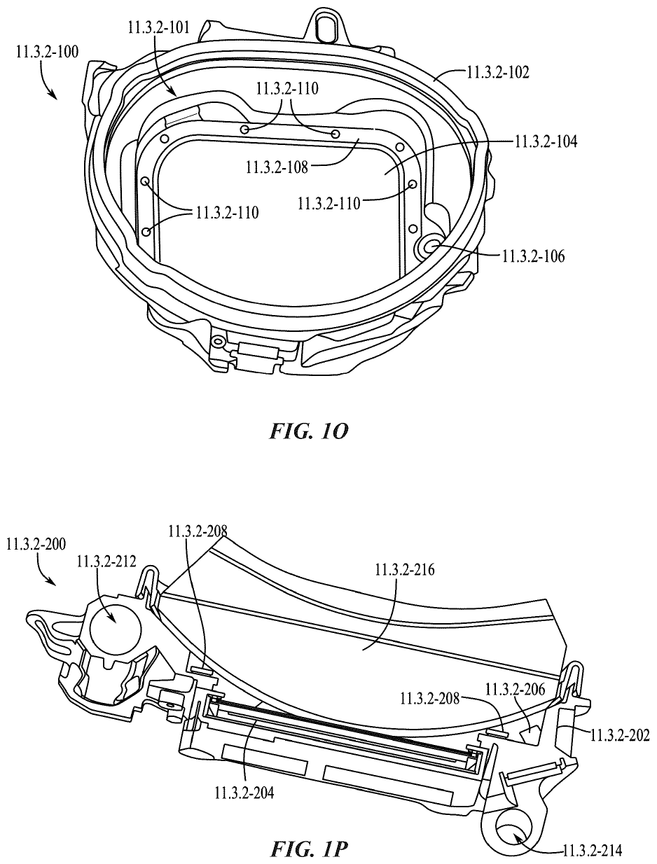

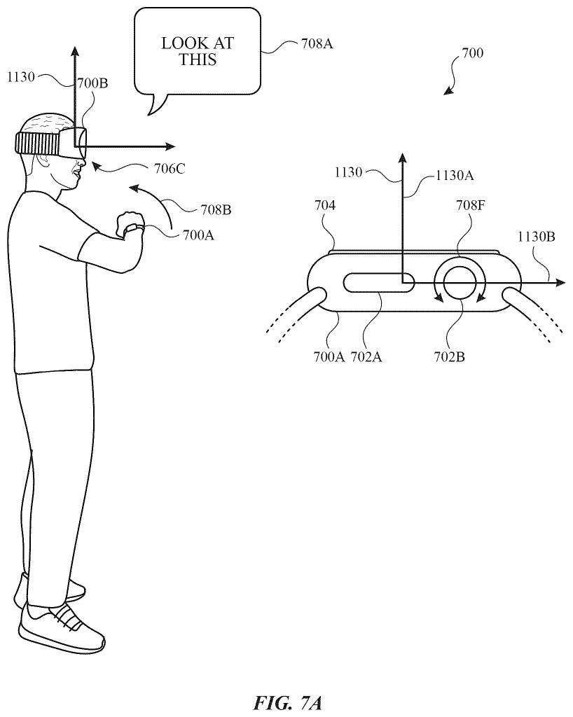

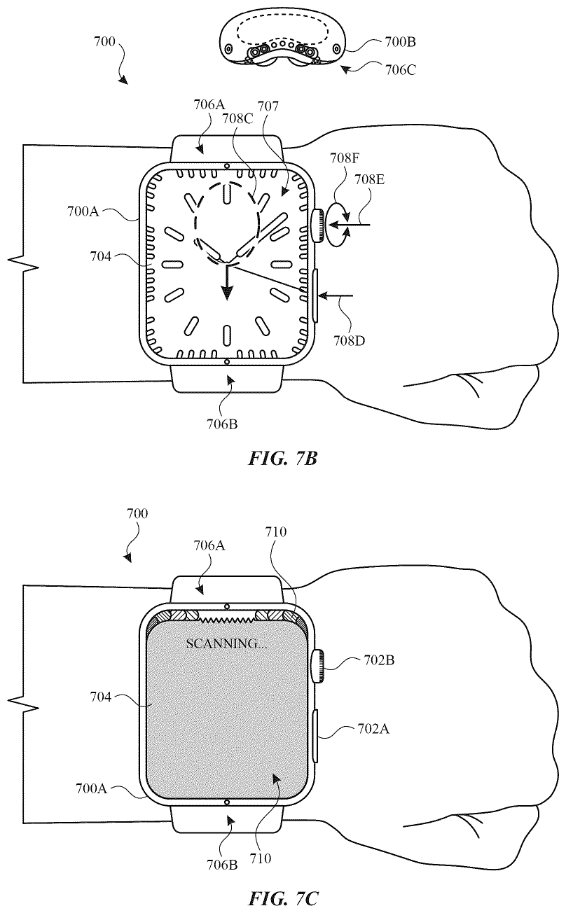

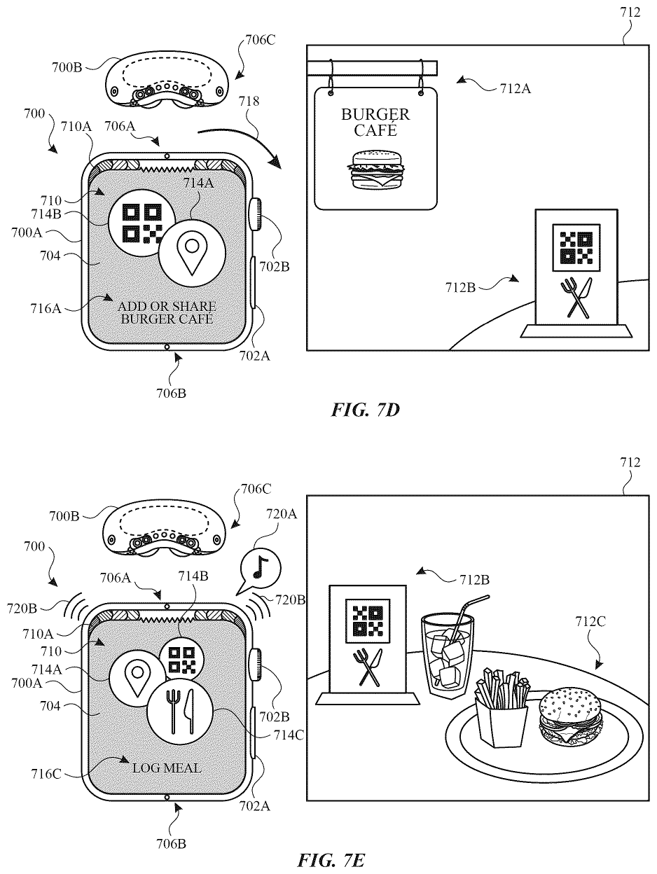

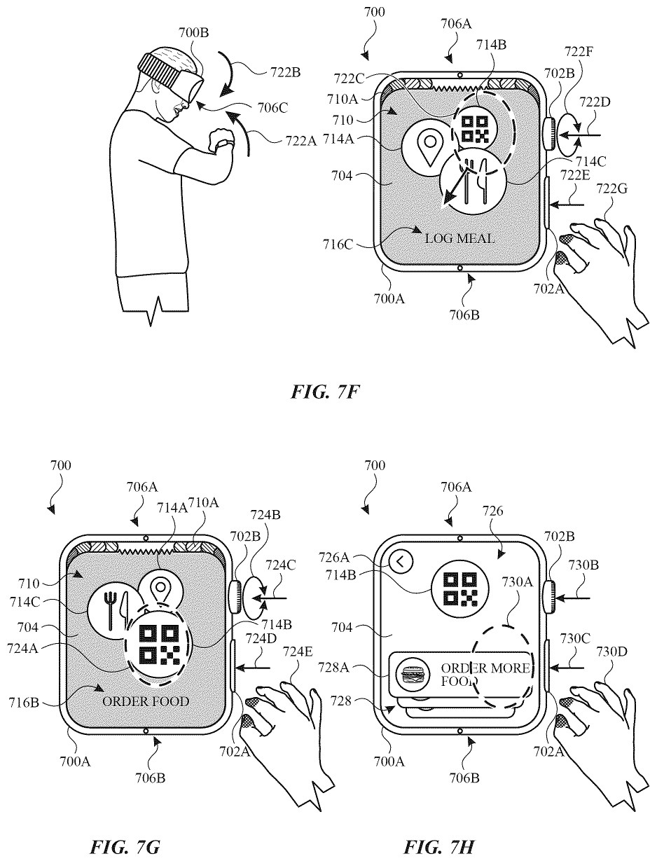

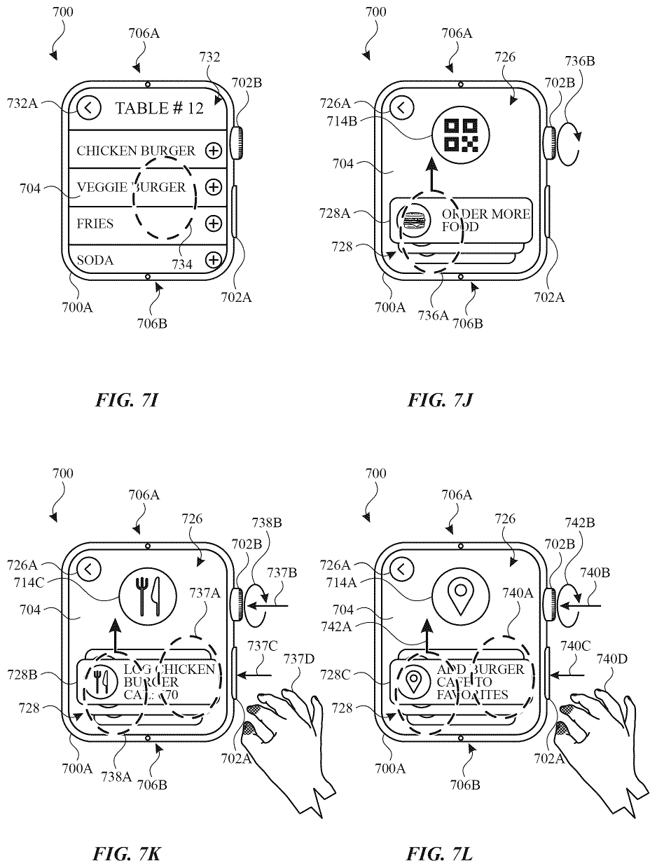

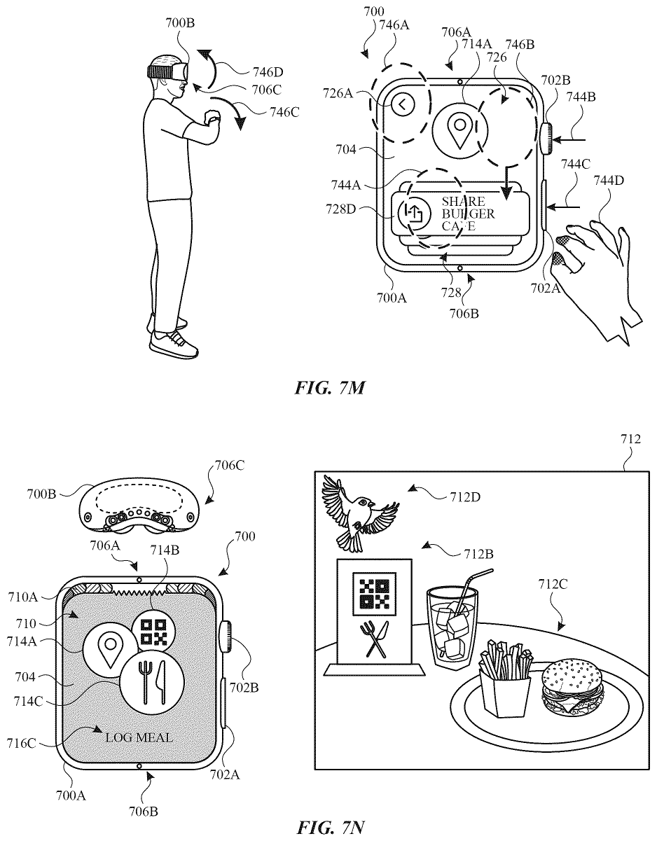

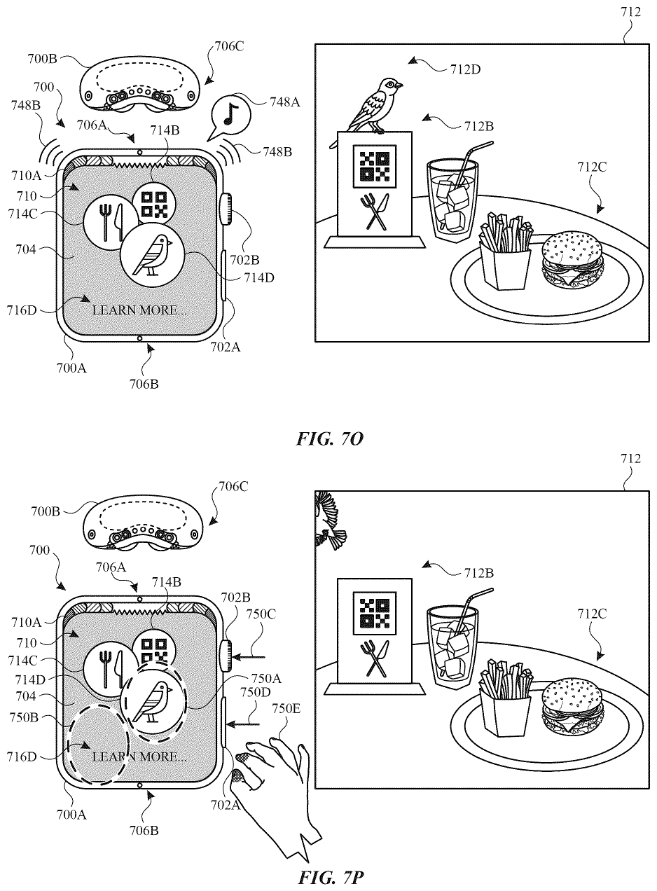

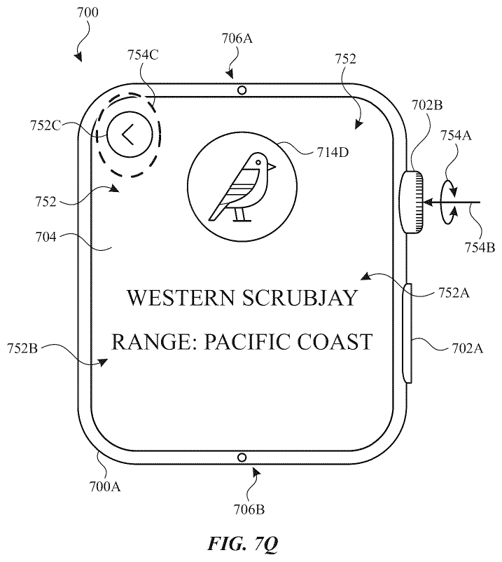

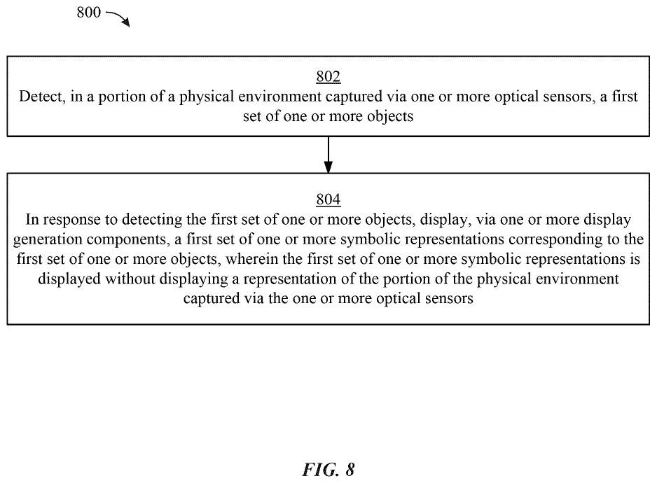

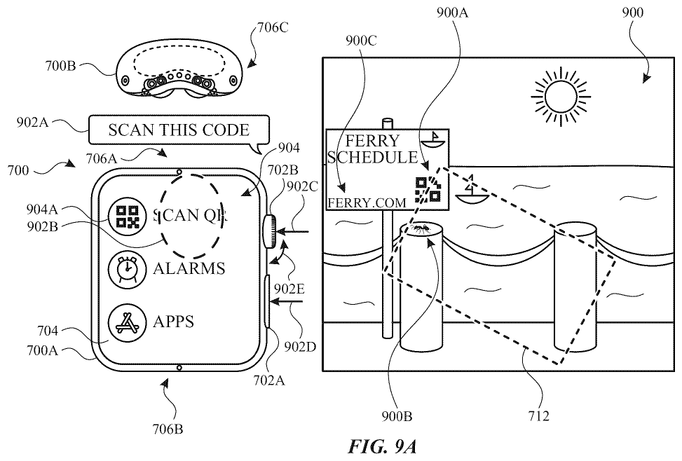

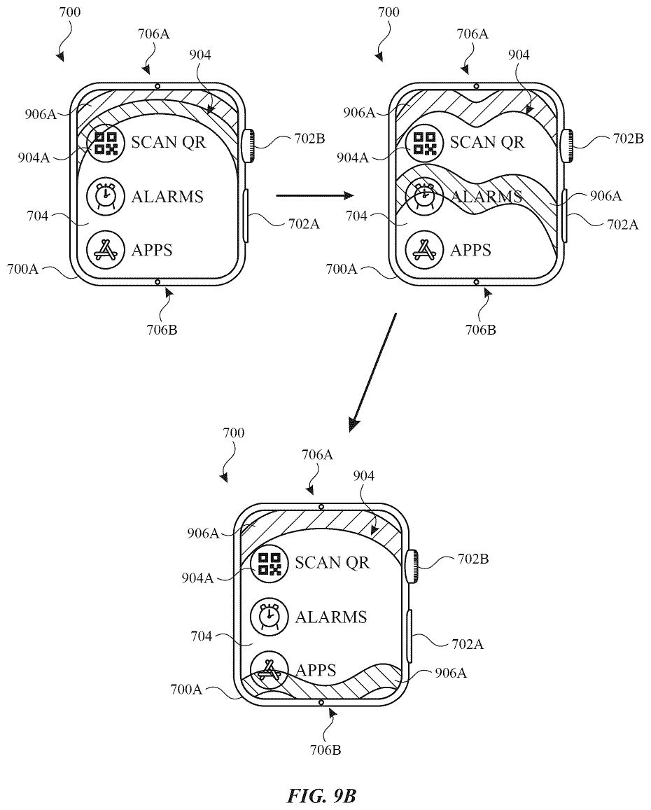

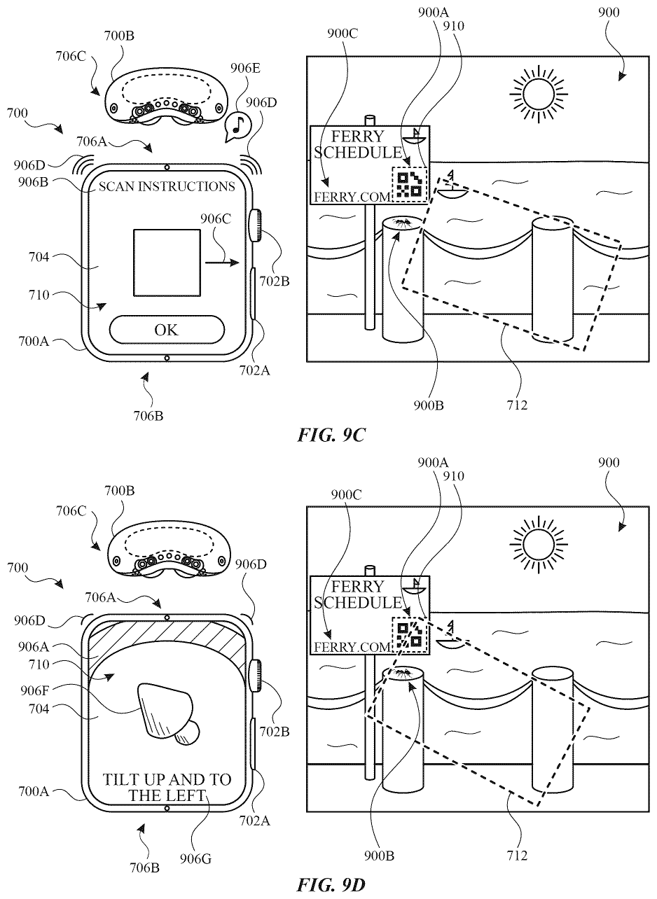

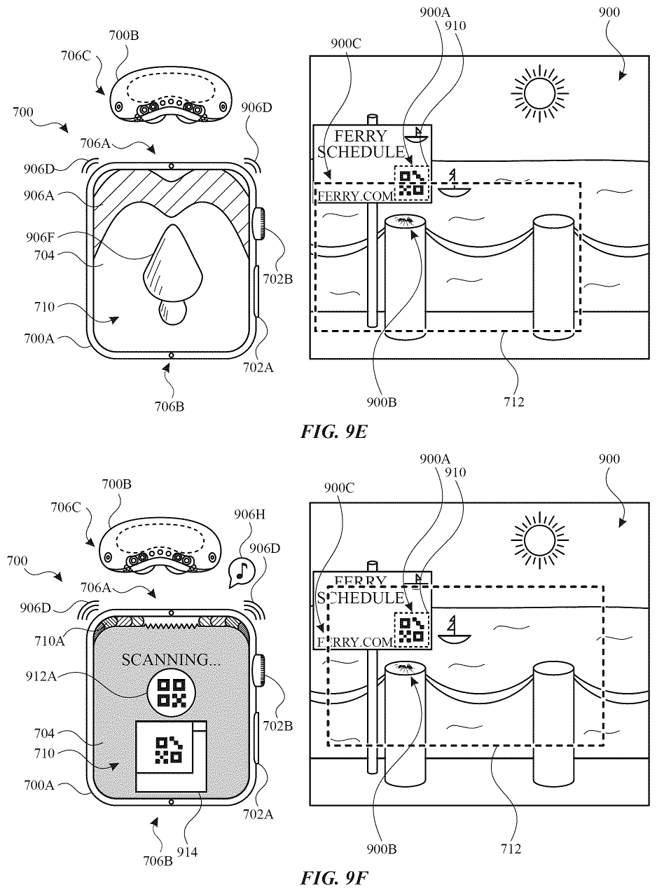

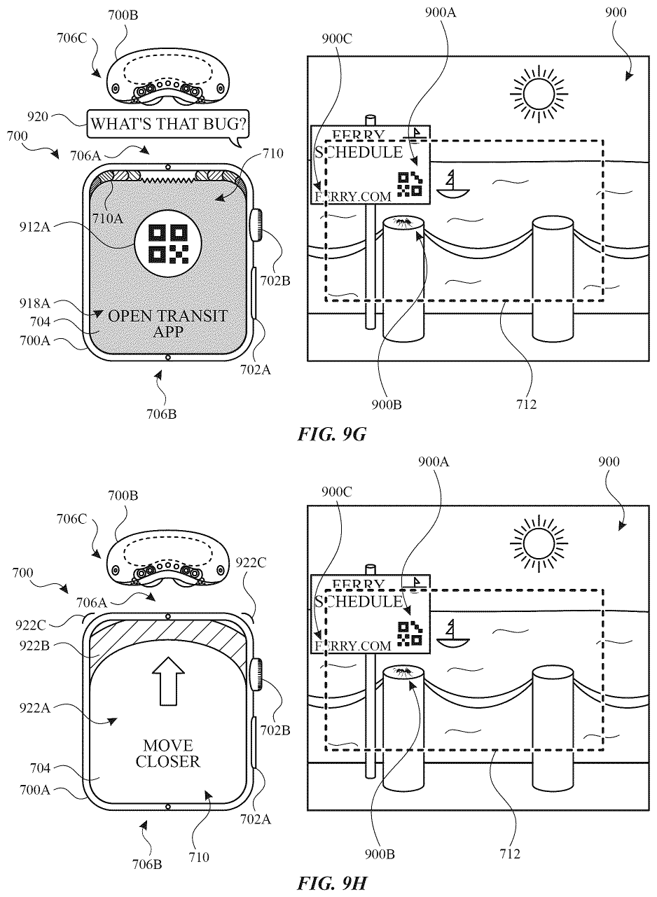

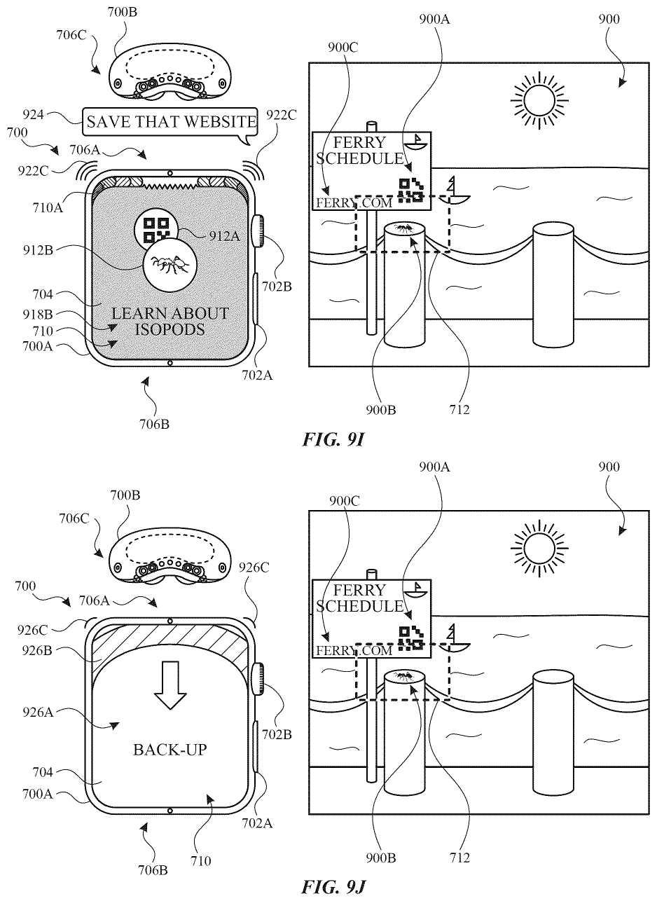

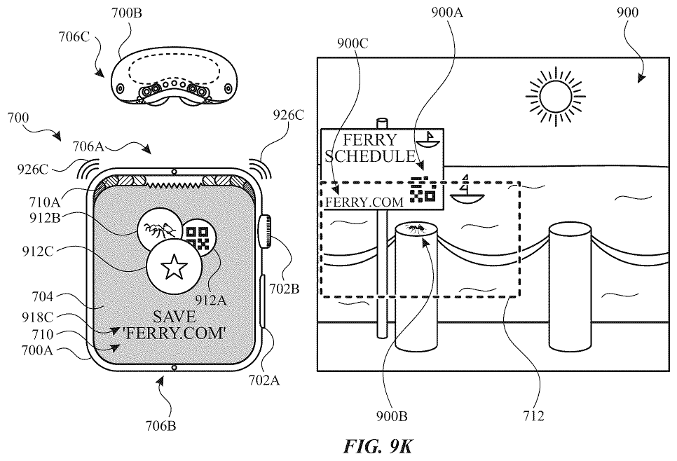

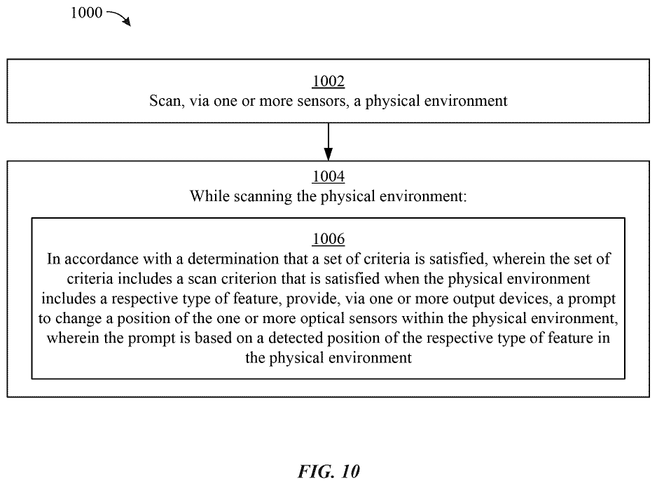

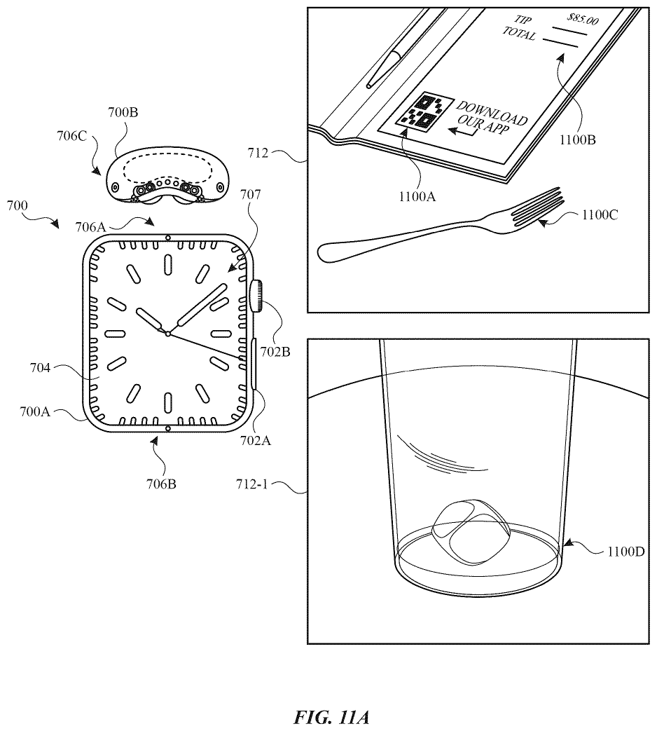

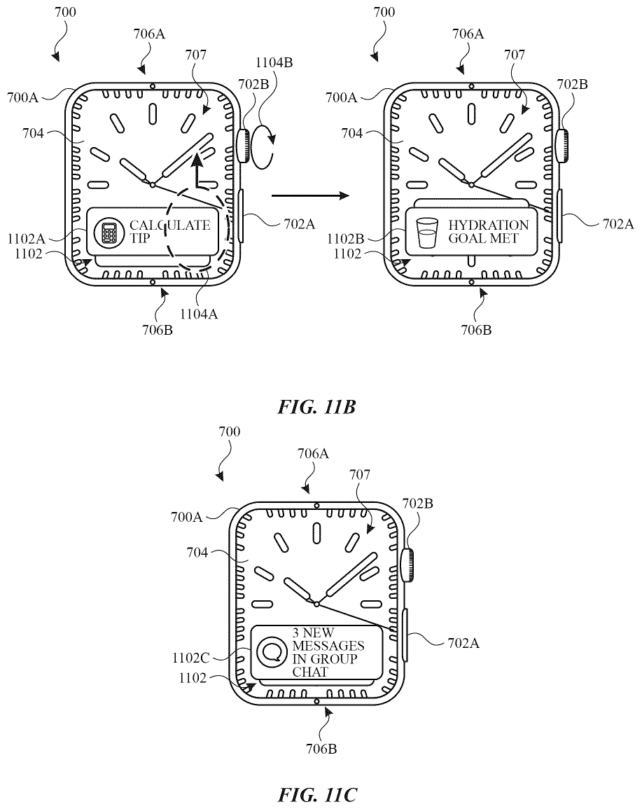

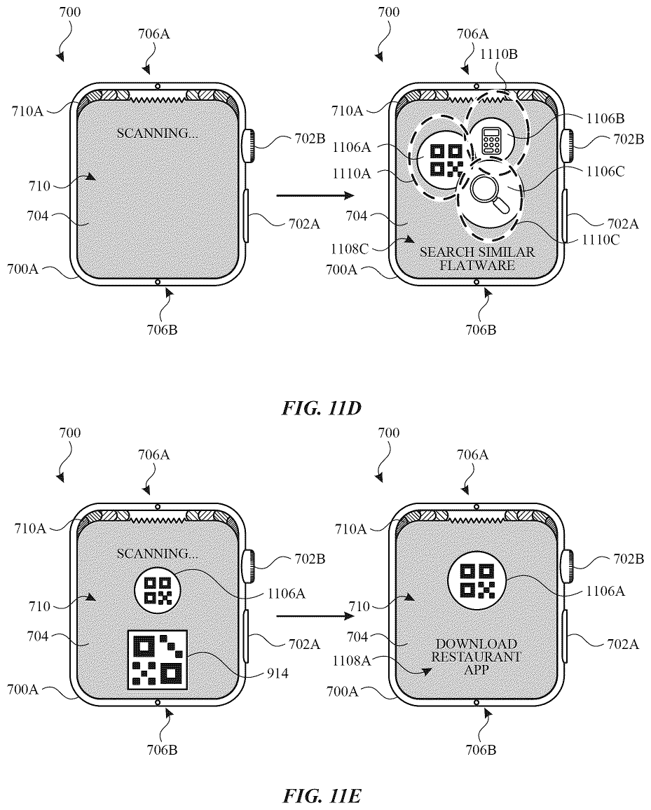

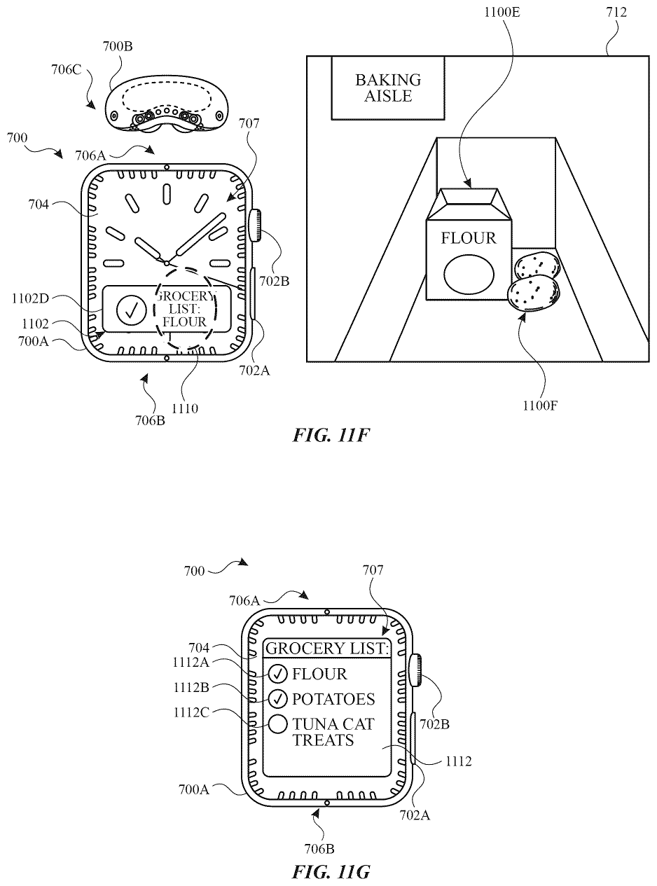

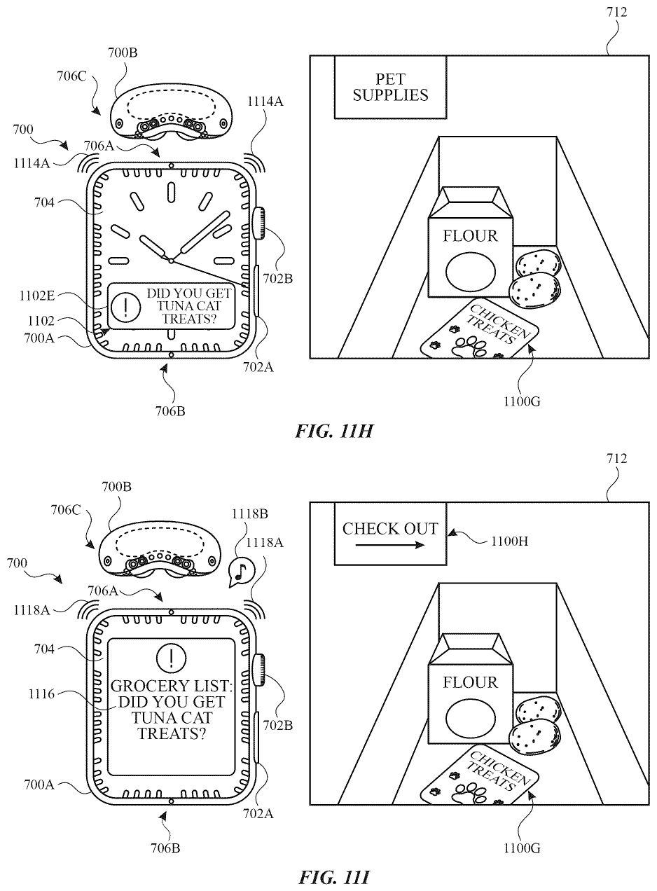

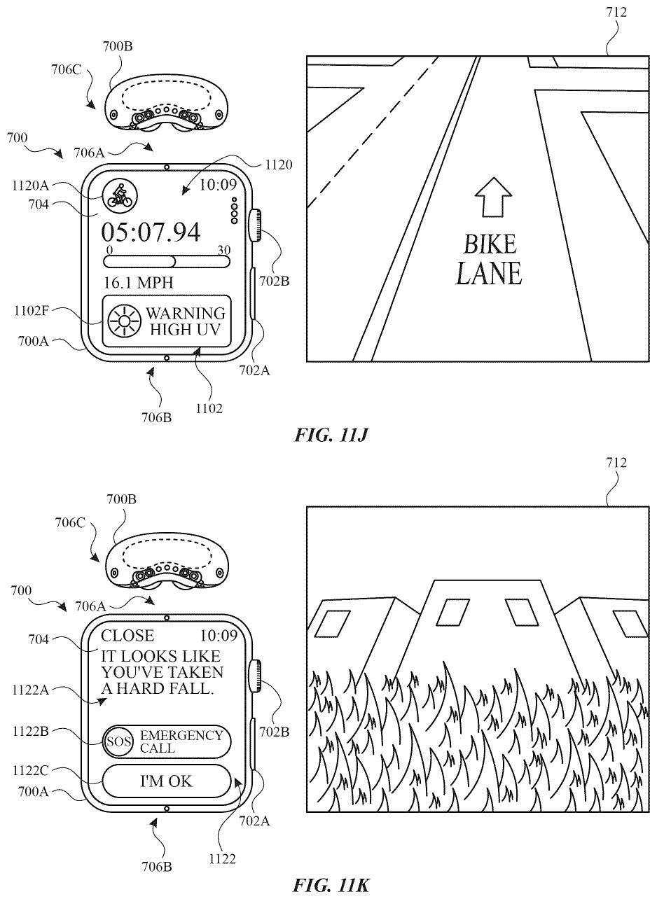

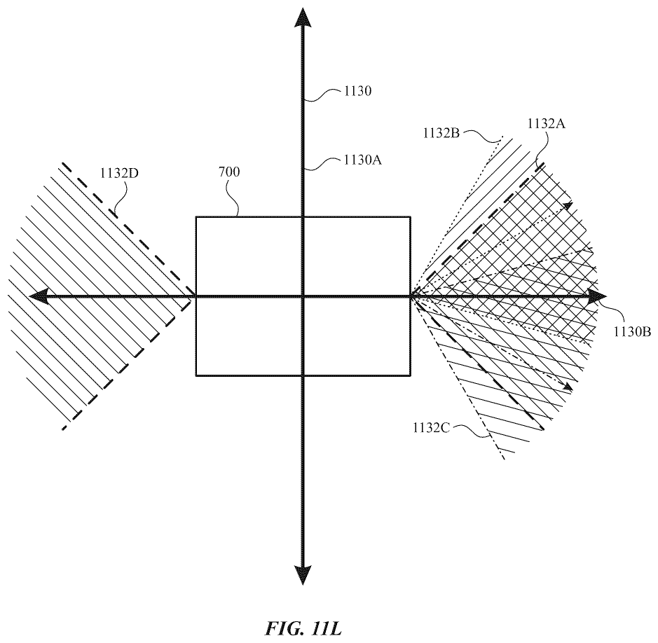

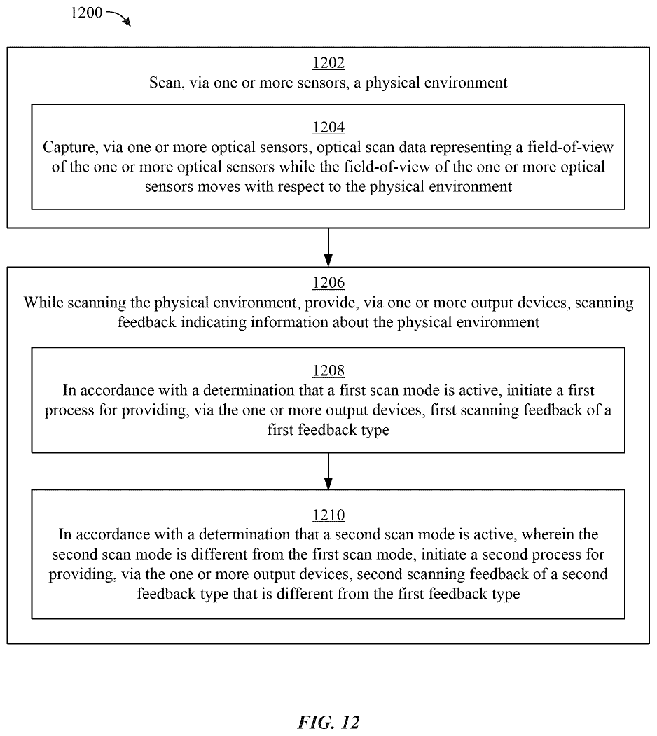

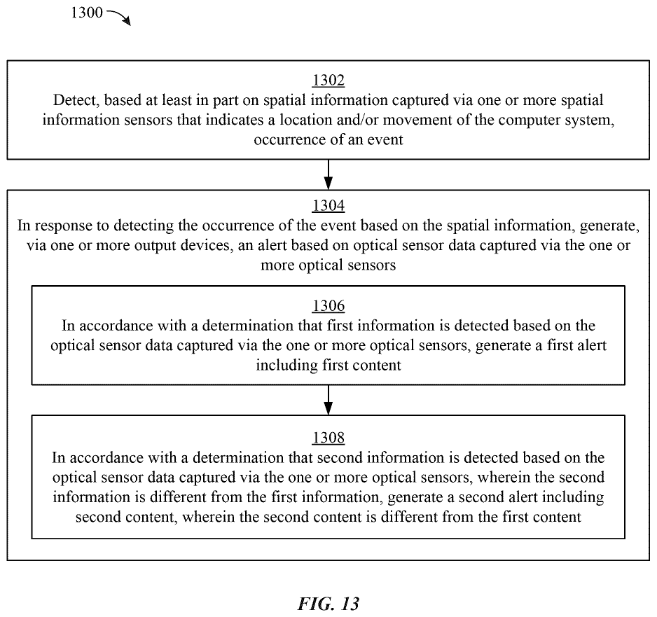

FIGS. 1A-6 provide a description of example computer systems for providing XR experiences to users. FIGS. 7A-7Q illustrate example techniques for scanning a physical environment and providing scan results, in some embodiments. FIG. 8 is a flow diagram of methods of scanning a physical environment and providing scan results, in some embodiments. The user interfaces in FIGS. 7A-7Q are used to illustrate the processes in FIG. 8. FIGS. 9A-9K illustrate example techniques for providing environment-aware guidance for scanning a physical environment, in some embodiments. FIG. 10 is a flow diagram of methods of providing environment-aware guidance for scanning a physical environment, in some embodiments. The user interfaces in FIGS. 9A-9K are used to illustrate the processes in FIG. 10. FIGS. 11A-11L illustrate example techniques for providing environment-aware guidance for scanning a physical environment, in some embodiments. FIG. 12 is a flow diagram of methods of providing feedback while scanning a physical environment in different scanning modes, in some embodiments. FIG. 13 is a flow diagram of methods of providing alerts based on different information detected while scanning a physical environment, in some embodiments. The user interfaces in FIGS. 11A-11L are used to illustrate the processes in FIGS. 12-13.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted display (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head-mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head-mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, or 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touchscreen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

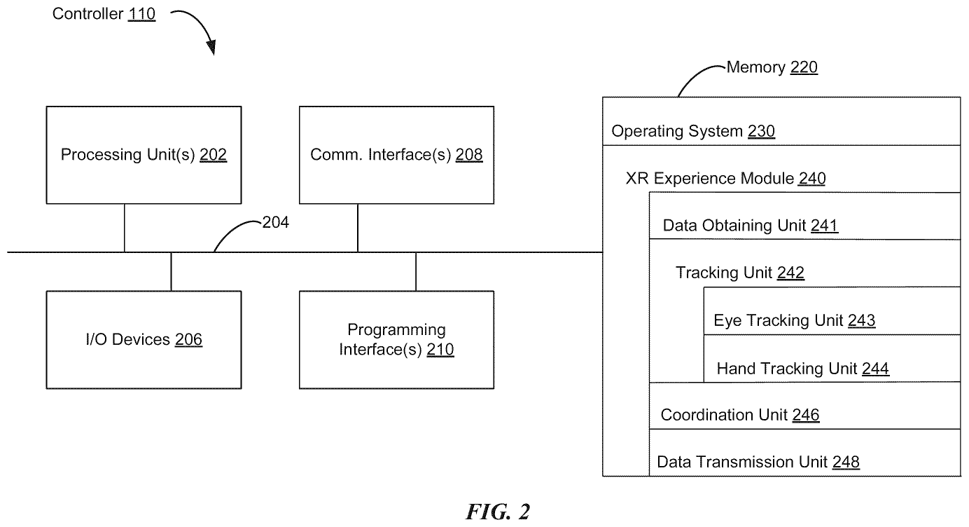

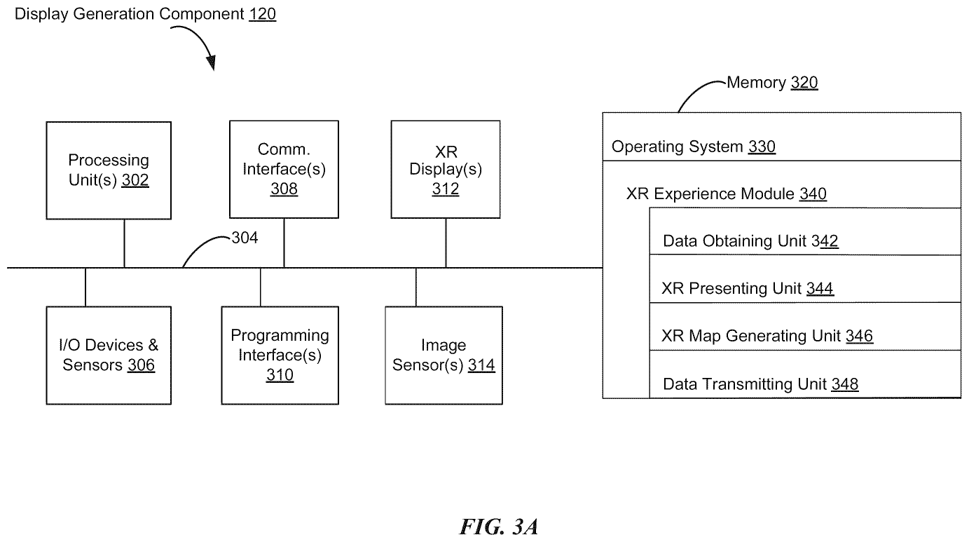

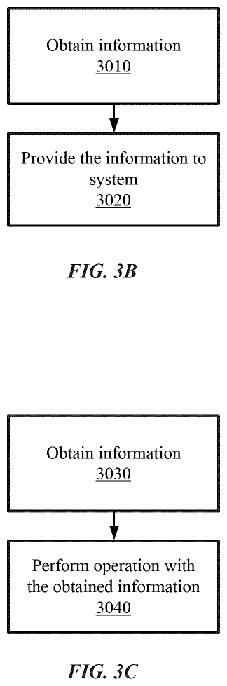

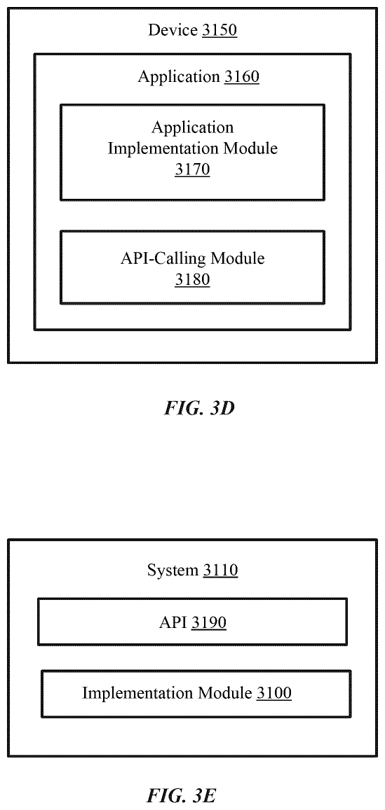

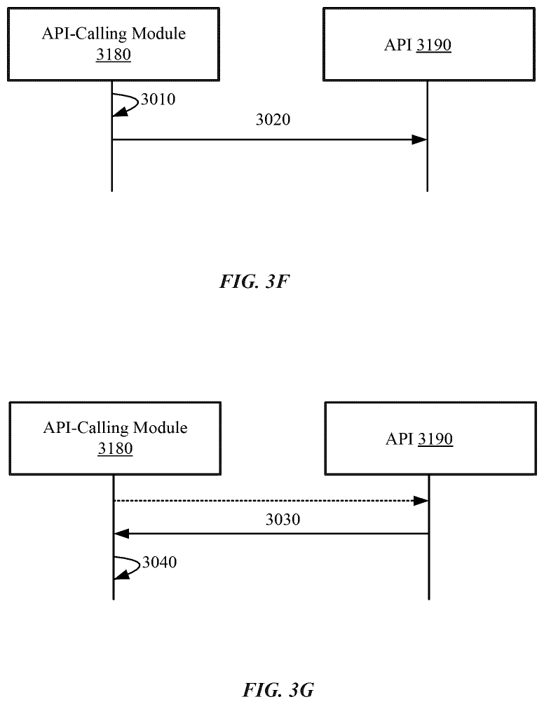

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user's head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward-facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1, 1C, and 1E-1F can be included, either alone or in any combination, in the example of the devices, features, components, and parts shown in FIG. 1D.

FIG. 1E illustrates an exploded view of an example of a display unit 1-302 of an HMD. The display unit 1-302 can include a front display assembly 1-308, a frame/housing assembly 1-350, and a curtain assembly 1-324. The display unit 1-302 can also include a sensor assembly 1-356, logic board assembly 1-358, and cooling assembly 1-360 disposed between the frame assembly 1-350 and the front display assembly 1-308. In at least one example, the display unit 1-302 can also include a rear-facing display assembly 1-320 including first and second rear-facing display screens 1-322a, 1-322b disposed between the frame 1-350 and the curtain assembly 1-324.

In at least one example, the display unit 1-302 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-302 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the display assembly 1-108 of the HMD 1-100 shown in FIG. 1B or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1I. Terms such as “vertical,” “up,” “down,” and similar terms refer to orientations or directions as indicated by the Z-axis shown in FIG. 1I. Terms such as “frontward,” “rearward,” “forward,” “backward,” and similar terms refer to orientations or directions as indicated by the Y-axis shown in FIG. 1I.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

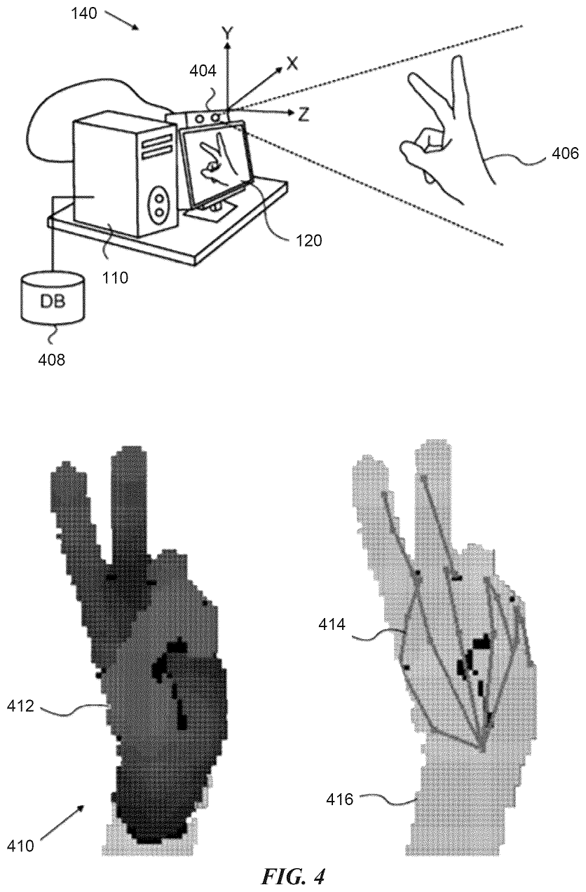

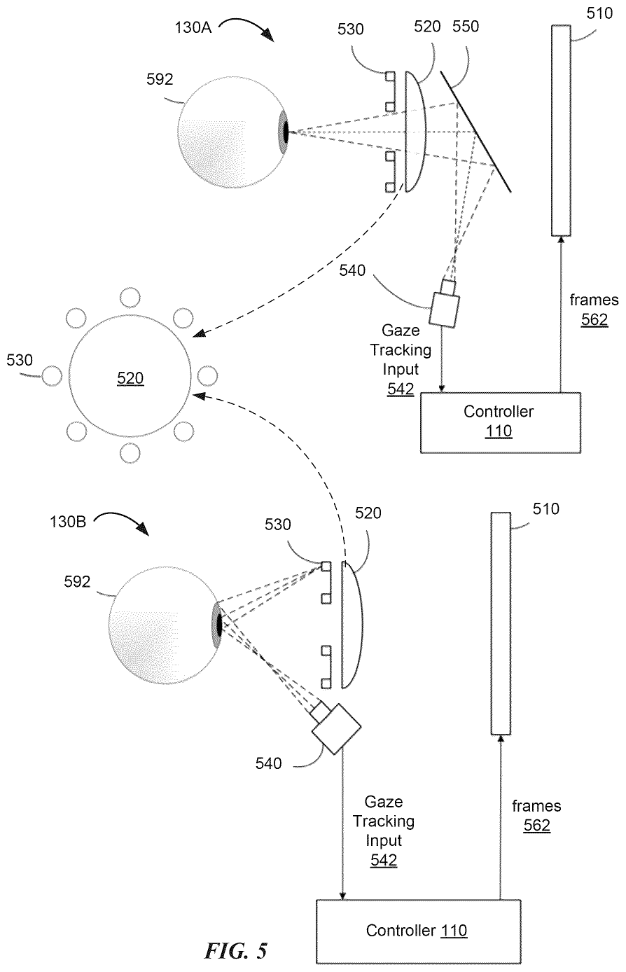

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 800, 1000, 1200, and/or 1300 (FIGS. 8, 10, 12, and/or 13) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105 or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, e.g., the measured z distance from the image sensors 404, with the shade of gray growing darker with increasing depth. The controller 110 processes these depth values in order to identify and segment a component of the image (e.g., a group of neighboring pixels) having characteristics of a human hand. These characteristics, may include, for example, overall size, shape, and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device and is optionally used in conjunction with a head-mounted display generation component. In some embodiments, the eye tracking device 130 is not a head-mounted device and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)) mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

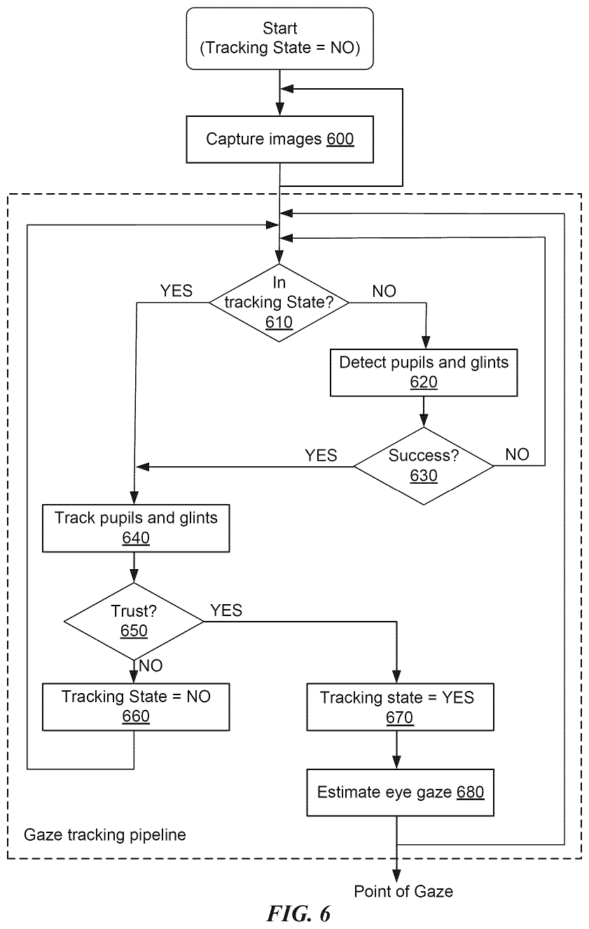

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head-mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

### User Interfaces and Associated Processes

Attention is now directed towards embodiments of user interfaces (“UI”) and associated processes that may be implemented on a computer system, such as a portable multifunction device or a head-mounted device, in communication with a one or more output devices (e.g., optionally including one or more display generation components) and one or more sensors, including one or more optical sensors, and, optionally, one or more spatial information sensors.

FIGS. 7A-7Q illustrate examples of techniques and systems for scanning a physical environment and providing scan results. FIG. 8 is a flow diagram of an exemplary method 800 for scanning a physical environment and providing scan results. The user interfaces in FIGS. 7A-7Q are used to illustrate the processes described below, including the processes in FIG. 8.

FIGS. 7A-7B illustrate computer system 700 receiving one or more inputs requesting to initiate active scanning of the physical environment using one or more optical sensors (e.g., 706A, 706B, and/or 706C), such as imaging sensors (e.g., visible light and/or IR cameras), depth sensors (e.g., structural light sensors, time-of-flight sensors (e.g., LIDAR), and/or stereoscopic camera sensors), and/or light sensors. In addition to the one or more optical sensors, in some embodiments, computer system 700 includes one or more other sensors, such as one or more spatial information sensors (e.g., accelerometers, gyroscopes, magnetometers, inertial measurement units (IMUs), and/or location sensors) and/or one or more other sensors (e.g., capacitive sensors, intensity sensors, motion sensors, vibration sensors, audio sensors, temperature sensors, and/or biometric sensors). In some embodiments, computer system 700 includes one or more audio generation components (e.g., an audio controller, one or more speakers, and/or other integrated and/or connected audio output devices) and/or tactile output generation components (e.g., haptic generators).

Computer system 700 includes wrist-worn device (e.g., smart watch) 700A, illustrated in FIGS. 7A-7B from the side (e.g., FIG. 7A) and front (e.g., FIG. 7B), which includes a set of hardware input devices including hardware button 702A and crown 702B (e.g., a depressible and rotatable input device), display 704 including a touch-sensitive surface, and optical sensors 706A and 706B (illustrated in FIG. 7B). For example, as further described with respect to FIGS. 11A and 11L, optical sensor 706A is oriented within wrist-worn device 700A to face towards the environment (e.g., forward) when display 704 is oriented towards the eyes of a user wearing wrist-worn device 700A, and optical sensor 706B is oriented to face towards the user (e.g., rearward) when display 704 is oriented towards the eyes of the user. In some embodiments, computer system 700 includes HMD 700B, illustrated in FIGS. 7A-7B from the side (e.g., FIG. 7A) and front (e.g., 7B), which includes one or more optical sensors 706C and/or one or more other hardware components (e.g., display generation components, hardware input devices, and/or sensors) as described with respect to HMD devices 1-100 and/or 6-100. For example, the one or more optical sensors 706C include one or more environment-facing (e.g., forward) optical sensors (e.g., scene cameras 6-106 and/or first depth sensor 6-108) and/or optical sensors oriented in other directions (e.g., downward facing cameras 6-114, jaw cameras 6-118, and/or side cameras 6-118). For example, in the following description, terms such as “front,” “forward,” and/or “environment-facing” refer to optical sensors oriented/directed substantially in the direction of the horizontal axis of axes 1130 (e.g., described further with respect to FIG. 11L), the frame of reference of the hardware (e.g., device housing) of computer system 700.

In some embodiments, computer system 700 is implemented using (e.g., in conjunction with computer system 700) one or more user devices (e.g., mobile phones, tablet computers, laptop computers, and/or wearable electronic devices (e.g., smart watches and/or head-mounted devices (HMDs))), remote devices (e.g., servers and/or network-connected devices), and/or peripheral devices (e.g., external storage drives, microphones, speakers, and/or hardware input devices). In some embodiments, one or more of the hardware components described above (e.g., the sensors, input devices, and/or output devices) are housed (e.g., included) in the same device. For example, wrist-worn device 700A includes both optical sensors (e.g., 706A and/or 706B) and one or more spatial information sensors (e.g., sensors tracking the movement, orientation, and/or location of wrist-worn device 700A). In some embodiments, one or more of the hardware components described above are housed in different devices. For example, computer system 700 provides outputs via display 704 housed in wrist-worn device 700A but obtains sensor data via one or more optical sensors (e.g., optical sensors 706C) and one or more spatial information sensors housed in HMD 700B.

At FIGS. 7A-7B, while displaying user interface 707 (e.g., a watch face user interface), computer system 700 receives one or more inputs (e.g., 708A, 708B, 708C, 708D, 708E, and/or 708F) requesting to initiate active scanning of the physical environment using the one or more optical sensors (e.g., 706A, 706B, and/or 706C). Input 708A, a speech input detected using one or more audio sensors of computer system 700, includes the natural-language request, “Look at this.” For example, computer system 700 processes spoken input 708A (e.g., using speech recognition, natural-language processing, and/or AI processing) to determine that the speech corresponds to a request to scan the physical environment using the one or more optical sensors. Input 708B includes a wrist-raise gesture detected using one or more spatial information sensors of computer system 700 (e.g., moving wrist-worn device 700A into a scanning position, as described further with respect to FIGS. 9A-9K and 11L). Input 708C includes a particular gesture (e.g., and/or combination of gestures) detected via the touch-sensitive surface of display 704, such as a downwards swipe from the edge of display 704 near optical sensor(s) 706A. Input 708D and input 708E include particular button press inputs (e.g., and/or combinations of button press inputs) detected via hardware button 702A and crown 702B. Input 708F includes a particular rotation input detected via crown 702B, such as an input rotating crown 702B by at least a threshold amount and/or in a particular direction. In some embodiments, the input requesting to initiate active scanning of the physical environment includes another type of input, such as a touch input directed to a particular scanning affordance displayed via display 704 (e.g., as described with respect to FIG. 9A), an input detected by a hardware input device of HMD 700B, and/or a particular air gesture.

At FIG. 7C, in response to detecting the one or more inputs (e.g., 708A, 708B, 708C, 708D, 708E, and/or 708F) requesting to initiate active scanning of the physical environment using the one or more optical sensors, computer system 700 displays, via display 704, scanning user interface 710. Scanning user interface 710 includes scanning indicator 710A, a glow effect and/or animation displayed at the edge of display 704 near optical sensor(s) 706A (e.g., as further described with respect to FIGS. 9A-9K). Scanning user interface 710 indicates to a user that the active scan of the physical environment has been initiated, and thus, as the user positions the one or more optical sensors to capture optical scan data of the physical environment, computer system 700 will provide scan results based on features (e.g., objects, information, and/or characteristics) identified from the optical scan data as described herein with respect to FIGS. 7D-7O.

While scanning the physical environment in response to the request, computer system 700 (e.g., wrist-worn device 700A and/or HMD 700B) captures, using the one or more optical sensors, optical sensor data corresponding to field-of-view 712 of the physical environment and analyzes the optical sensor data to detect recognizable features (e.g., objects, information, and/or characteristics). For example, field-of-view 712 corresponds to a field-of-view of one or more environment- and/or forward-facing optical sensors, such as optical sensor 706A of wrist-worn device 700A and/or one or more scene cameras (e.g., 6-106) of HMD 700B. In some embodiments, computer system 700 implements one or more optical processing techniques and/or models, such as algorithmic image processing, optical character recognition, machine vision, generative AI, and/or machine learning techniques, to recognize and/or characterize (e.g., describe and/or classify) features of the physical environment from the image data, depth information, and/or luminance information captured via the optical sensors. For example, computer system 700 identifies visible objects and information of interest, such as people, pets, text, symbols, machine-readable codes (e.g., QR codes), plants, food items, landmarks, surroundings, displayed content, and/or user belongings. In some embodiments, while scanning the physical environment using the one or more optical sensors, computer system 700 captures additional data from the physical environment using one or more other sensors, such as spatial information (e.g., information indicating how computer system 700, the one or more optical sensors, and/or the user are moving within the physical environment), audio data, and/or biometric data.

At FIG. 7D, computer system 700 identifies two features included in field-of-view 712: feature 712A, a sign for a restaurant with the text “Burger Café” and an image of a burger, and feature 712B, a QR code printed on a placard sitting on a table. As illustrated in FIG. 7D, in response to detecting feature 712A and feature 712B in field-of-view 712, computer system 700 displays symbolic representation 714A and symbolic representation 714B in scanning user interface 710. Symbolic representation 714A, which includes a map pin symbol, corresponds to feature 712A, and symbolic representation 714B, which includes a QR code symbol, corresponds to feature 712B. As illustrated in FIG. 7D, symbolic representations 714A and 714B are displayed without displaying another representation of field-of-view 712, such as a live- or near-live camera feed of image data captured using the optical sensors.

At FIG. 7D, symbolic representation 714A is selected as the active scan result, as indicated by the arrangement of symbolic representations 714A and 714B in scanning user interface 710 with symbolic symbolic representation 714A in front (e.g., partially overlapping symbolic representation 714B). Accordingly, the arrangement of symbolic representations in scanning user interface 710 does not necessarily reflect the arrangement of the corresponding features in the environment. While symbolic representation 714A is selected as the active scan results, computer system 700 displays additional information 716A, the text “add or share burger café,” indicating actions computer system 700 can take based on feature 712A (e.g., as described further with respect to FIGS. 7L-7M).

At FIGS. 7D-7E, field-of-view 712 of the optical sensors (e.g., 706A, 706B, and/or 706C) changes, for example, as a result of movement 718 sweeping wrist-worn device 700A (e.g., optical sensors 706A) to the right to capture a different portion of the physical environment. At FIG. 7E, computer system 700 identifies feature 712C, a plate with a burger and fries sitting on the table, which is now included in field-of-view 712. In response to detecting the new feature 712C, computer system 700 updates scanning user interface 710 to include symbolic representation 714C, which includes a fork-and-knife symbol corresponding to feature 712C. Additionally, computer system 700 generates nonvisual output 720A, an audio output such as a chime or notification tone, and nonvisual output 720B, a tactile output (e.g., vibration), indicating the detection of feature 712C. Although field-of-view 712 no longer includes feature 712A (e.g., the restaurant sign) at FIG. 7E, computer system 700 continues to display the corresponding symbolic representation 714A. In some embodiments, computer system 700 continues to display symbolic representation 714A for at least a predetermined duration of time (e.g., 0.5 s, 1 s, 2 s, 5 s, 10 s, or 30 s) after the optical sensors stop detecting feature 712A in field-of-view 712. In some embodiments, computer system 700 continues to display symbolic representation 714A after the optical sensors stop detecting feature 712A until maintaining display of symbolic representation 714A would cause the number of symbolic representations displayed in scanning user interface 710 to exceed a capacity (e.g., 2, 3, 4, 5, 7, or 10 symbolic representations), for example, if computer system 700 were to add another symbolic representation based on detecting another feature in field-of-view 712 (e.g., as further described with respect to FIGS. 7N-7O).

As illustrated in FIG. 7E, symbolic representation 714C is selected as the active scan result (e.g., as the newest scan result), so computer system 700 updates the arrangement of the symbolic representations 714A-714C to place symbolic representation 714C in front (e.g., partially overlapping symbolic representations 714A and 714B) and displays additional information 716C, the text “log meal,” indicating an action that computer system 700 can take based on feature 712C (e.g., as described further with respect to FIG. 7K). Symbolic representations 714A and 714B are also displayed at a smaller size than symbolic representation 714C. For example, the sizing of the symbolic representations corresponds to their order in the arrangement, with symbolic representation 714C displayed at the largest size, symbolic representation 714B at a medium size, and symbolic representation 714B at the smallest size.

At FIG. 7F, while displaying symbolic representations 714A-714C, computer system 700 detects one or more inputs (e.g., 722A, 722B, 722C, 722D, 722E, 722F, and/or 722G) for reviewing the scan results. Input 722A and input 722B are movements detected using one or more spatial information sensors of computer system 700 that correspond to the user reviewing the symbolic representations on display 704. For example, input 722A corresponds to the user rotating wrist-worn device 700A to orient display 704 towards the user's eyes, and input 722B corresponds to the user rotating HMD 700B to look down at display 704. Input 722C includes a particular gesture (e.g., and/or combination of gestures), detected via the touch-sensitive surface of display 704, corresponding to navigating through the displayed symbolic representations, such as a tap input directed to symbolic representation 714B and/or a swipe input moving from near symbolic representation 714B towards the position of symbolic representation 714C (e.g., the position of the currently-selected symbolic representation in the arrangement). Input 722D and input 722E include particular button press inputs (e.g., and/or combinations of button press inputs) detected via hardware button 702A and crown 702B. Input 722F includes a particular rotation input detected via crown 702B, such as an input rotating crown 702B by at least a threshold amount and/or in a particular direction. Input 722G includes a particular air gesture (e.g., or combination of air gestures), detected via the optical sensors (e.g., 706A, 706B, and/or 706C), corresponding to navigating through the displayed symbolic representations, such as an air pinch and/or air swipe.

In response to detecting the one or more inputs (e.g., 722A, 722B, 722C, 722D, 722E, 722F, and/or 722G) for reviewing the scan results, computer system 700 pauses updating the scan results based on changes to field-of-view 712. For example, because the movements of input 722A and input 722B correspond to the user reviewing the scan results on display 704 as opposed to moving the optical sensors to scan a different portion of the physical environment using optical sensors 706A, 706B, and/or 706C (e.g., as described with respect to movement 718), computer system 700 does not update scanning user interface 710 to add new symbolic representations and/or remove displayed symbolic representations, even if field-of-view 712 includes new features and/or no longer includes a previously-detected feature.

At FIG. 7G, symbolic representation 714B is selected as the active scan result in response to detecting input 722C, input 722F, and/or input 722G, which correspond to navigating through the displayed symbolic representations. For example, rotating crown 702B (e.g., input 722C) and/or swiping across the displayed symbolic representations using a touch and/or air gesture (e.g., input 722F and/or input 722G) causes computer system 700 to successively select different symbolic representations, scrolling and/or cycling the selection in a direction and/or by an amount corresponding to the direction and/or magnitude of rotation/movement. As another example, inputs directed to a particular displayed symbolic representation other than the currently-selected symbolic representation (e.g., input 722F and/or input 722G) cause computer system 700 to select the particular displayed symbolic representation.

As illustrated in FIG. 7G, when symbolic representation 714B is selected as the active scan result, computer system 700 arranges the symbolic representations with symbolic representation 714B in front (e.g., in the position occupied by symbolic representation 714C in FIG. 7E) and at the largest size, symbolic representation 714C in the middle and at the medium size, and symbolic representation 714A in the back and at the smallest size. In some embodiments, in response to detecting input 722C, input 722F, and/or input 722G, computer system 700 animates the symbolic representations rearranging, for instance, cycling through the different sizes and positions as the selection changes. Computer system 700 also displays additional information 716B, the text “order food,” indicating an action computer system 700 can take based on feature 712B (e.g., as described further with respect to FIGS. 7H-7I).

At FIG. 7G, while symbolic representation 714B is selected as the active scan result, computer system 700 detects one or more selection inputs (e.g., 724A, 724B, 724C, 724D, and/or 724E) of symbolic representation 714B, such as touch input 724A directed to symbolic representation 714B on the touch-sensitive surface of display 704, input 724B rotating crown 702B (e.g., in a particular direction and/or by a particular amount), input 724C pressing crown 702B, input 724D pressing hardware button 702A, and/or air gesture 724E (e.g., a particular air gesture and/or combination of air gestures).

In response to detecting the one or more selection inputs (e.g., 724A, 724B, 724C, 724D, and/or 724E) of symbolic representation 714B, at FIG. 7H, computer system 700 displays scan result user interface 726, a user interface for reviewing scan results in more detail (e.g., while scanning is paused). Scan result user interface 726 includes return affordance 726A, which navigates back to scanning user interface 710 and/or resumes (e.g., un-pauses) scanning when selected, as described in further detail with respect to FIGS. 7M-7N.

As illustrated in FIG. 7H, scan result user interface 726 includes scan result stack 728, a scrollable user interface element that presents scan results corresponding to scanned features 712A-712C. As the one or more selection inputs (e.g., 724A, 724B, 724C, 724D, and/or 724E) were directed to symbolic representation 714B and/or because symbolic representation 714B was selected as the active scan result when the one or more selection inputs were received, at FIG. 7H, computer system 700 initially displays scan result stack 728 with scan result 728A, which corresponds to feature 712B/symbolic representation 714B, at the top. Scan result 728A is an affordance with the text “order more food” and an icon of a burger, indicating an action computer system 700 can take based on feature 712B, in particular, opening a URL (e.g., web link and/or application deep-link) encoded by the QR code scanned on the table placard. Computer system 700 additionally displays symbolic representation 714B in scan result user interface 726 while scan result 728A is at the top of scan result stack 728, indicating the source of the provided action.

At FIG. 7H, while scan result 728A is displayed at the top of scan result stack 728, computer system 700 detects one or more inputs selecting scan result 728A, such as input 730A (e.g., a touch input directed to scan result 728A on display 704), input 730B (e.g., a press input detected by crown 702B), input 730C (e.g., a press input detected by hardware button 702A), and/or input 720D (e.g., a particular air gesture and/or combination of air gestures). In response to detecting the one or more inputs selecting scan result 728A, computer system 700 opens the URL encoded by the QR code of feature 712B, displaying user interface 732 as illustrated in FIG. 7I, a restaurant ordering user interface for the table on which the scanned placard (e.g., feature 712B) is placed. For example, the user can interact with user interface 732 using touch, hardware, air gesture, and/or spoken inputs, such as input 734A, selecting a veggie burger item from the menu in user interface 732 to add to an order for the user's table. Computer system 700 additionally displays user interface 732 with return affordance 732A, which, when selected (e.g., via input 734B), causes computer system 700 to navigate back to scan result user interface 726 (e.g., as illustrated in FIG. 7J).

While displaying scan result user interface 726 with scan result 728A at the top of scan result stack 728 at FIG. 7J, computer system 700 detects one or more inputs for navigating scan result stack 728, such as input 736A swiping up across scan result stack 728 and/or input 736B rotating crown 702B. At FIG. 7K, in response to the one or more inputs for navigating scan result stack 728, computer system 700 updates scan result user interface 726 to include symbolic representation 714C and to display scan result 728B, which corresponds to feature 712C/symbolic representation 714C, at the top of scan result stack 728.

Scan result 728B corresponds to scanned feature 712C, the plate with the burger and fries sitting in front of the user on the table. As illustrated in FIG. 7K, scan result 728B includes a description of an action of logging a meal in a meal-tracking application (e.g., the text “log chicken burger” and/or an icon for the meal-tracking application) and additional information based on scanned feature 712C (e.g., text with the estimated calorie count, “cal: 670”). In some embodiments, computer system 700 identifies the action, information for performing the action (e.g., one or more parameters of a task), and/or the additional information based on scanned feature 712C (e.g., based on identifying one or more specific food items from the optical scan data) and/or other sensor data and/or contextual information, such as spatial information indicating the user picking up and eating the burger and fries, audio data detected when the user ordered the meal, and/or calorie estimate information provided by the meal-tracking application. As described with respect to scan result 728A and FIGS. 7H-7I, in response to detecting one or more inputs selecting scan result 728B (e.g., touch input 737A, button input 737B, button input 737C, and/or air gesture input 737D), computer system 700 initiates performance of the action of logging the chicken burger meal (e.g., via one or more API calls to the meal-tracking application), for example, causing the meal-tracking application to log the meal and/or displaying a user interface of the meal-tracking application populated with information about the chicken burger meal.

At FIG. 7K, computer system 700 detects one or more inputs for navigating scan result stack 728, such as input 738A swiping up across scan result stack 728 and/or input 738B rotating crown 702B. At FIG. 7L, in response to the one or more inputs for navigating scan result stack 728, computer system 700 updates scan result user interface 726 to include symbolic representation 714A and to display scan result 728C, which corresponds to feature 712A (e.g., the restaurant sign) and/or symbolic representation 714A, at the top of scan result stack 728. As illustrated in FIG. 7K, scan result 728C includes a description of an action of adding the identified restaurant to a “Favorites” collection in a maps application (e.g., the text “Add Burger Café to favorites” and/or an icon for the maps application), and can be selected (e.g., via input 740A, 740B, 740C, and/or 740D) to cause the action to be performed.

In response to detecting, at FIG. 7L, one or more inputs for navigating scan result stack 728 (e.g., swipe input 742A and/or rotation input 742B), at FIG. 7M, computer system 700 scan result user interface 726 to include scan result 728D, another scan result corresponding to feature 712A/symbolic representation 714A, at the top of scan result stack 728. For example, based on detecting feature 712A, computer system 700 identifies multiple candidate actions for interacting with the identified restaurant. As illustrated in FIG. 7M, scan result 728D includes a description of a second action of sharing the identified restaurant location (e.g., the text “Share Burger Café” and/or a share icon), and can be selected (e.g., via input 744A, 744B, 744C, and/or 744D) to cause the second action to be performed. For example, selecting scan result 728D causes a sharing user interface to be displayed with options for, e.g., copying the restaurant location to a data clipboard, sending the restaurant location to another person via a communication application, and/or exporting the restaurant location to a particular application.

Additionally or alternatively to navigating through scan result stack 728 in scan result user interface 726 as described herein with respect to FIGS. 7J-7M, computer system 700 displays scan user interface 726 with a particular scan result (e.g., 728A, 728B, 728C, and/or 728D) at the top of scan result stack 728 in response to selection inputs detected while displaying scanning user interface 710 with the symbolic representation corresponding to the particular scan result selected as the active symbolic representation. Accordingly, the user can review scan results and access additional actions/information either via the symbolic representations in scanning user interface 710 (e.g., as described with respect to FIGS. 7F-7G) or the scan results user interface 726.

At FIG. 7M, computer system 700 detects one or more inputs (e.g., 746A, 746B, 746C, and/or 746D) for resuming scanning the physical environment using the one or more optical sensors. Input 746A is an input (e.g., a touch and/or air gesture input) selecting return affordance 726A. Input 746 includes a particular gesture (e.g., and/or combination of gestures), detected via the touch-sensitive surface of display 704, corresponding to returning to scanning user interface 710, such as a downwards swipe across scan result user interface 726. Input 746C and input 746D are movements detected using one or more spatial information sensors of computer system 700 that correspond to the user ceasing reviewing the symbolic representations on display 704 and/or returning to a scanning position (e.g., as further described with respect to FIG. 9C). For example, the movements correspond to rotating wrist-worn device 700A and/or HMD 700B to orient optical sensors 706A, 706B, and/or 706C out towards the physical environment.

At FIG. 7N, after detecting the one or more inputs (e.g., 746A, 746B, 746C, and/or 746D) for resuming scanning the physical environment using the one or more optical sensors, computer system 700 displays scanning user interface 710 and detects a change to field-of-view 712 of the optical sensors (e.g., 706A, 706B, and/or 706C). In particular, computer system 700 detects feature 712D, a bird, landing on the placard on the user's table. As illustrated in FIG. 7N, although scanning the physical environment using the one or more optical sensors was resumed (e.g., in response to inputs 746A, 746B, 746C, and/or 746D), computer system 700 does not immediately update scanning user interface 710 in response to detecting feature 712D, instead waiting until the new feature is detected for at least a threshold period of time (e.g., 0.1 s, 0.5 s, 1 s, 2 s, 3 s, 5 s, 10 s, or 30 s).

At FIG. 7O, once feature 712D has been detected in field-of-view 712 for at least the threshold period of time, computer system 700 updates scanning user interface to include symbolic representation 714D, which includes a bird symbol corresponding to feature 712D being identified (e.g., using one or more optical processing techniques and/or models) as a bird. As illustrated in FIG. 7O, computer system 700 displays symbolic representations 714B-714D arranged with symbolic representation 714D in front and displayed at the largest size, indicating that symbolic representation 714D is selected as the active symbolic representation. Computer system 700 additionally generates nonvisual output 748A, an audio output such as a chime or notification tone, and nonvisual output 748B, a tactile output (e.g., vibration), indicating the detection of feature 712D, and displays additional information 716D, the text “Learn more,” indicating the availability of additional information system 700 can provide based on feature 712D.

As illustrated in FIG. 7O, upon displaying symbolic representation 714D, computer system 700 ceases displaying symbolic representation 714A corresponding to feature 712A, the restaurant sign that is no longer detected in field-of-view 712, based on a determination that displaying symbolic representation 714D for the newly-detected feature 712D would cause the number of symbolic representations displayed in scanning user interface 710 to exceed a capacity of three. Accordingly, computer system 700 provides users with flexibility to review scan results even as field-of-view 712 changes, while also providing up-to-date scan results and avoiding over-crowding scanning user interface 710 with symbolic representations of previously-detected features.

At FIG. 7P, computer system 700 ceases detecting feature 712D in field-of-view 712 when the bird flies away from the table. As illustrated in FIG. 7P, computer system 700 maintains displaying symbolic representation 714D for at least a threshold period of time (e.g., and/or until a new feature is detected in field-of-view 712 for which a symbolic representation is displayed), allowing the user to review and interact with symbolic representation 714D even after the bird flies away. In particular, in response to one or more inputs selecting symbolic representation 714D, such as input 750A directed to symbolic representation 714D, input 750A directed to additional information 716D, and/or inputs 750C and/or 750D detected while symbolic representation 714D is selected as the active symbolic representation, computer system 700 displays user interface 752 as illustrated in FIG. 7Q. Alternatively, in response to the one or more inputs selecting symbolic representation 714D, computer system 700 displays scan result user interface 726 with a scan result corresponding to feature 712D displayed at the top of scan result stack 728 (e.g., as described with respect to FIG. 7H), which can be selected to display user interface 752.

As illustrated in FIG. 7Q, user interface 752 provides additional information based on feature 712D, for instance, information 752A, identifying the bird's common species name (e.g., the text “Western Scrub Jay”), and information 752B, providing the bird's geographic range (e.g., the text “Range: Pacific coast”) and/or other content related to feature 712D (e.g., accessible by navigating user interface 752 using inputs such as 754A, a rotation of crown 702B). For example, computer system 700 analyzes the optical scan data using the one or more optical processing techniques and/or models to identify information 752A and obtains information 752B by performing a web search, retrieving information from a bird-watching application, and/or generating AI content based on the identified bird. User interface 752 also includes return affordance 752C, which, when selected (e.g., via input 754B), causes computer system 700 to display scanning user interface 710 and resume scanning the physical environment (e.g., as described with respect to FIG. 7N).

In some embodiments, computer system 700 ceases scanning the physical environment in response to particular inputs received while scanning the physical environment (e.g., displaying scanning user interface 710) and/or providing scan results to the user (e.g., via scan result user interface 726, user interface 732, user interface 752, and/or another user interface accessed via the symbolic representations and/or scan result stack 728), such as a particular press of hardware button 702A and/or crown 702B, a swipe in a particular direction across the touch-sensitive surface of display 704, and/or a particular air gesture. For example, in response to input 754C (e.g., a press of hardware button 702A held for at least a threshold duration of time), computer system 700 resumes displaying user interface 707 (e.g., the watch face user interface).

Additional descriptions regarding FIGS. 7A-7Q are provided below in reference to method 800 described with respect to FIG. 8.

FIG. 8 is a flow diagram of an exemplary method 800 for scanning a physical environment and providing scan results, in some embodiments. In some embodiments, method 800 is performed at a computer system (e.g., computer system 101 in FIG. 1A and/or computer system 700) including a one or more display generation components (e.g., display generation component 120 in FIGS. 1A, 3A, and 4 and/or display 704) (e.g., a display controller; a touch-sensitive display system; a display (e.g., integrated and/or connected), a 3D display, a transparent display, a projector, and/or a heads-up display) and one or more optical sensors (e.g., 6-106, 6-108, 6-114, 6-118, 6-118, 706A, 706B, and/or 706C) (e.g., imaging sensors (e.g., visible light and/or IR cameras), depth sensors (e.g., structural light sensors, time-of-flight sensors (e.g., LIDAR), and/or stereoscopic camera sensors), and/or light sensors). In some embodiments, the computer system includes a wrist-worn device (e.g., 700A). In some embodiments, the optical sensors are housed within the same device as at least one display (e.g., 704) (e.g., the computer system includes a wrist-worn device that houses both a display and the one or more optical sensors). In some embodiments, the optical sensors point in a direction that is within a threshold range (e.g., within 10°, 30°, 45°, or 60°) of perpendicular to a plane of a display (e.g., as illustrated in FIG. 11L) (e.g., the optical sensors point in one or more directions that are within a threshold range of parallel to the surface of the display). In some embodiments, the computer system is optionally in communication with one or more motion and/or orientation sensors (e.g., accelerometers, gyroscopes, magnetometers, inertial measurement units (IM), and/or location sensors). In some embodiments, the motion and/or orientation sensors measure the movement and/or orientation of the optical sensors (e.g., the IMU and optical sensors operate within the same inertial frame of reference). In some embodiments, the computer system is optionally in communication with one or more input devices, such as touch-sensitive surfaces (e.g., of display 704), hardware input devices (e.g., 702A and/or 702B) (e.g., hardware buttons, switches, keys, and/or dials), microphones, gesture input devices, air gesture input devices, and/or gaze input devices. In some embodiments, the computer system is optionally in communication with one or more additional sensors, such as capacitive sensors, intensity sensors, motion sensors, vibration sensors, audio sensors, temperature sensors, and/or biometric sensors. In some embodiments, method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

The computer system detects (802), in a portion (e.g., field-of-view and/or sensor capture area) of a physical environment captured via the one or more optical sensors (e.g., 712), a first set of one or more objects (e.g., 712A, 712B, 712C, 712D, 900A, 900B, 900C, 1100A, 1100B, 1100C, 1100D, 1100E, 1100F, 1100G, and/or 1100H). For example, the computer system processes the sensor data using optical processing techniques, such as algorithmic image processing, machine vision, and/or other machine learning techniques, to recognize features of the physical environment and identify visible objects and information of interest, such as people, pets, text, symbols, plants, food items, landmarks, surroundings, displayed content, and/or user belongings. In some embodiments, the computer system captures the portion of the physical environment via the one or more sensors in response to a user input (e.g., a request to scan the environment).

In response to detecting the first set of one or more objects (in some embodiments, and in accordance with a determination that the first set of one or more objects meet a set of object type criteria), the computer system displays (804), via the one or more display generation components, a first set of one or more symbolic representations (e.g., icons, text, and/or other user interface elements) corresponding to the first set of one or more objects (e.g., 714A, 714B, 714C, 714D, 912A, 912B, 912C, 1106A, 1106B, and/or 1106C), wherein the first set of one or more symbolic representations is displayed without displaying, via the one or more display generation components, a representation of the portion of the physical environment captured via the one or more optical sensors (e.g., as illustrated in FIGS. 7D-7G, 7N-7P, 9I, 9K, and/or 11D) (e.g., displaying the symbolic representations without displaying optical sensor data, such as a live or near-live viewfinder of the field-of-view of the one or more cameras). Displaying symbolic representations of objects detected in a physical environment without displaying an optical representation of the physical environment (e.g., a live- or near-live viewfinder) provides improved control of computer system functionality without cluttering the user interface with additional displayed controls and provides improved visual feedback to the user, which reduces the power usage and improves the battery life of the computer system by enabling the user to use the device more quickly and efficiently. For example, displaying symbolic representations of detected objects provides users with information about a physical environment and/or computer system functionality related to the physical environment without expending additional processing or power resources to display a camera (or other optical sensor) feed, which also improves readability of the information (e.g., the symbolic representations isolate information about relevant objects in the physical environment from background information). Displaying symbolic representations of objects detected in a physical environment without displaying an optical representation of the physical environment also assists the user with interacting with the physical environment via the computer system (e.g., using optical scan data) and reduces the risk that transient visual context is missed, which reduces the number of inputs needed to perform an operation (e.g., inputs to manually input context information about the physical environment and/or manually request feedback) and thus reduces the power usage and improves the battery life of the computer system by enabling the user to use the device more quickly and efficiently. For example, the symbolic representations provide the user with feedback on visual context detected by the computer system, allowing the user to confirm and review detected objects. Providing the symbolic representations also reduces the number of inputs needed to perform an operation, for example, by automatically surfacing information about relevant objects in the physical environment without requiring the user to manually input information about the physical environment and/or manually seek related functionality, which reduces the power usage and improves the battery life of the computer system by enabling the user to use the device more quickly and efficiently.

In some embodiments, displaying (804) the first set of one or more symbolic representations corresponding to the first set of one or more objects includes displaying a first symbolic representation corresponding to a first object of the first set of one or more objects and displaying a second symbolic representation (e.g., a different symbolic representation from the first symbolic representation) corresponding to a second object of the first set of one or more objects (e.g., a different object from the first object of the first set of one or more objects) (e.g., as illustrated in FIGS. 7D-7G, 7N-7P, 9I, 9K, and/or 11D). In some embodiments, the first object and second object are different types of objects, and the first symbolic representation and the second symbolic representation have different appearances (e.g., different symbols, icons, text, and/or colors) corresponding to the different types.

In some embodiments, a spatial relationship between the first symbolic representation and the second symbolic representation (e.g., 714A, 714B, 714C, and/or 714D) with respect to a display (e.g., 704) of the one or more display generation components (e.g., the relative positioning, sizing, and/or ordering of the symbolic representations with respect to the frame of reference of the display) has a first value of a respective spatial relationship characteristic, and a spatial relationship between the first object and the second object (e.g., 712A, 712B, 712C, and/or 712D) with respect to the physical environment (e.g., the relative positioning, sizing, and/or ordering of the objects with respect to the frame of reference of a field-of-view of the environment) has a second value of the respective spatial relationship characteristic, wherein the second value is different from the first value (e.g., as illustrated in FIGS. 7D-7G and 7N-7P). For example, in the physical environment, the first object is above the second object, but the first symbolic representation is displayed to the left of the second symbolic representation on the display. As another example, the first object is closer to the optical sensors than the second object (e.g., the second object is behind the first object), but the first symbolic representation is displayed partially behind the second symbolic representation on the display. In some embodiments, the spatial relationship between the first symbolic representation and the second symbolic representation on the display is based on one or more factors other than the spatial relationship between the first object and the second object with respect to the physical environment. For example, the symbolic representations are arranged based on relevance to the user, order of detection of the corresponding objects, and/or user interactions with the displayed symbolic representations, such as user inputs selecting a symbolic representation to be in focus. Displaying the symbolic representations in an arrangement that differs from the corresponding objects' arrangement in the physical environment provides improved visual feedback to the user and assists the user with interacting with the physical environment via the computer system (e.g., using optical scan data). For example, in contrast to displaying an optical representation of the physical environment, the symbolic representations are arranged on a display in a manner that improves their legibility, provides the user with relevant information, and/or provides the user with feedback on the state of detection.

In some embodiments, while displaying (e.g., initially displaying in response to detecting the first set of one or more objects) a third symbolic representation (in some embodiments, the first symbolic representation, the second symbolic representation, or another symbolic representation) of the first set of one or more symbolic representations with a respective set of visual emphasis characteristics (e.g., visual characteristics, such as color, size, position, border effects, fill effects, opacity, brightness, contrast, and/or associated display elements and/or user interface objects, that indicate the third symbolic representation is currently selected/in focus) without displaying a fourth symbolic representation of the first set of one or more symbolic representations with the respective set of visual emphasis characteristics (e.g., as illustrated in FIGS. 7F, 7G, and/or 7P), the computer system detects (e.g., via the one or more optical sensors, a touch-sensitive surface, and/or a hardware button) a respective user input (e.g., 722A-722G, 724A-724E, and/or 750A-750E) (e.g., a touch input, gesture input, air gesture input, press input, and/or rotation input). For example, the currently-focused symbolic representation is displayed in front of the other symbolic representations (e.g., partially overlaying one or more other symbolic representations without being overlaid by any other symbolic representations), at a larger size than the other symbolic representations, in a different color than the other symbolic representations (e.g., the focused symbolic representation is white, yellow, and/or red, while the other symbolic representations are gray, white, and/or blue), with a particular border effect (e.g., a bold keyline and/or an edge glow) not applied to the other symbolic representations, and/or with a user interface element (e.g., a text label, action affordance, and/or share affordance) not displayed with the other symbolic representations.

In some embodiments, in response to detecting the respective user input and in accordance with a determination that the respective user input satisfies a set of focus criteria (e.g., 722C, 722F, and/or 722G in FIG. 7F), the computer system displays the fourth symbolic representation of the first set of one or more symbolic representations with the respective set of visual emphasis characteristics without displaying the third symbolic representation of the first set of one or more symbolic representations with the respective set of visual emphasis characteristics (e.g., as illustrated in FIG. 7G). In some embodiments, the set of focus criteria includes a criterion that is satisfied when the respective user input does not include a selection input (e.g., a tap and/or press without movement) directed to the third symbolic representation. In some embodiments, if the set of symbolic representations includes three or more symbolic representations, the set of focus criteria includes a criterion that is satisfied when a characteristic (e.g., a location and/or direction of movement) of the respective user input corresponds to the fourth symbolic representation (e.g., different movement characteristics are used to change focus to different symbolic representations). In some embodiments, in response to detecting the respective user input, in accordance with a determination that the respective user input does not satisfy the set of focus criteria, the computer system forgoes changing the visual emphasis, surfaces additional information/options for the current focused symbolic representation, and/or changes the visual emphasis to a symbolic representation other than the third and fourth symbolic representations. Changing the visual emphasis of displayed symbolic representations corresponding to detected objects to indicate a currently-focused object provides improved visual feedback to the user, provides improved control of computer system functionality without cluttering the user interface with additional displayed controls and assists the user with interacting with the physical environment via the computer system (e.g., using optical scan data). For example, after scanning multiple objects, the visual emphasis clearly indicates to the user which object is selected for further interactions as the user reviews the scan results.

In some embodiments, the third symbolic representation corresponds to a third object of the first set of one or more objects, and, in response to detecting the respective user input and in accordance with a determination that the respective user input corresponds to a selection of the third symbolic representation of the first set of one or more symbolic representations (e.g., 722D-722G, 724A-724E, and/or 750A-750E) (e.g., a tap and/or press input without movement directed to the current focused symbolic representation), the computer system displays, via the one or more display generation components, one or more additional user interface elements (e.g., 728 and/or 752) (e.g., text, symbols, icons, images, and/or user interface objects) corresponding to the third object of the first set of one or more objects (e.g., 728A corresponding to 714B, 728B corresponding to 714C, 728C and/or 728D corresponding to 714A, and/or 752A and/or 752B corresponding to 714D). For example, in response to a selection of the current focused symbolic representation, the computer system displays additional information about the detected third object and/or additional options (e.g., user interface objects for performing one or more actions) based on the detected third object. In some embodiments, if the respective user input corresponds to a selection of the third symbolic representation, the respective user input does not satisfy the focus criteria (e.g., the visual emphasis is not switched to another symbolic representation in response to a selection of the current focused symbolic representation). Displaying additional information related to a detected object in response to an interaction with the corresponding displayed symbolic representation (e.g., an input focusing and/or selecting the symbolic representation) provides improved visual feedback to the user, provides improved control of computer system functionality without cluttering the user interface with additional displayed controls and assists the user with interacting with the physical environment via the computer system. For example, after scanning multiple objects, the computer system surfaces related additional information and/or functionality to the user as the user reviews the corresponding symbolic representations.

In some embodiments, while displaying the first set of one or more symbolic representations, the computer system detects (e.g., via the one or more optical sensors, a touch-sensitive surface, and/or a hardware button) a first user input (e.g., 722C-722G, 724A-724E, and/or 750A-750E) (e.g., an air gesture, touch input, press input, and/or rotation input) directed to a respective symbolic representation of the first set of one or more symbolic representations that corresponds to a respective object of the first set of one or more objects. For example, the first user input is detected at a location corresponding to a display location of the respective symbolic representation (e.g., a touch and/or air gesture directed to the location of the respective symbolic representation) and/or includes a movement in a direction corresponding to the respective symbolic representation (e.g., a gesture and/or rotation input in a direction corresponding to selecting and/or focusing the respective symbolic representation). In some embodiments, in response to detecting the first user input directed to the respective symbolic representation of the first set of one or more symbolic representations, the computer system displays, via the one or more display generation components, one or more additional user interface elements (e.g., 716A-716D, 728, 728A-728D, 752, and/or 752A-752B) (e.g., text, symbols, icons, images, and/or user interface objects) corresponding to the respective object of the first set of one or more objects (e.g., as illustrated in FIGS. 7G-7H and/or 7Q). In some embodiments, the first user input satisfies the set of focus criteria for the respective symbolic representation, and the one or more additional user interface elements include one or more visual emphasis elements, such as a text label element that is displayed for the current focused symbolic representation. In some embodiments, the first user input corresponds to selection of a current focused symbolic representation (e.g., the symbolic representation currently displayed with the respective visual emphasis characteristics), and the additional user interface elements include additional information and/or options for the respective object. Providing additional information and/or options corresponding to a detected object in response to an input selecting the corresponding displayed symbolic representation provides improved visual feedback to the user, provides improved control of computer system functionality without cluttering the user interface with additional displayed controls and assists the user with interacting with the physical environment via the computer system. For example, the computer system displays the symbolic representations to allow users to both efficiently review one or more scanned objects and selectively access additional information and/or options for the scanned objects when relevant and/or desired.

In some embodiments, the one or more additional user interface elements corresponding to the respective object of the first set of one or more objects includes textual information corresponding to the respective object (e.g., 716A-716D, 728A-728D, and/or 752A-752B). For example, the textual information includes a text label of the respective object and/or its object type, a text description of the respective object and/or its object type, text extracted from the object, and/or text indicating one or more additional options available for the object.

In some embodiments, the one or more additional user interface elements corresponding to the respective object of the first set of one or more objects includes a first user interface element that represents a first action associated with the respective object (e.g., 716A-716D and/or 728A-728D). In some embodiments, the user interface element includes a control element, such as a software button, link, and/or slider. In some embodiments, the user interface element includes an indication of the respective action, such as a text label, text description, action icon, and/or application icon. Displaying options for actions related to a detected object in response to an input selecting the corresponding displayed symbolic representation provides improved visual feedback to the user and assists the user with interacting with the physical environment via the computer system, for example, by informing users of actions the computer system can take that are relevant to the user's environmental context (e.g., the detected objects) as the user interacts with the scan results.

In some embodiments, while displaying the one or more additional user interface elements corresponding to the respective object, the computer system detects (e.g., via the one or more optical sensors, a touch-sensitive surface, and/or a hardware button) a second user input (e.g., 730A-730D, 737A-737D, 740A-740D, 744A-744D, and/or 750B) (e.g., an air gesture, touch input, and/or hardware button press input) directed to the first user interface element representing the first action associated with the respective object (e.g., as illustrated in FIGS. 7H, 7K-7M, and/or 7P). In some embodiments, the second user input satisfies one or more selection criteria, such as a criterion that is satisfied when the second user input is a selection-type input, such as a tap, air tap, and/or button press (e.g., and not a navigation-type input, such as a swipe, flick, and/or rotation input). In some embodiments, in response to detecting the second user input directed to the first user interface element representing the first action associated with the respective object, the computer system causes performance of the first action associated with the respective object (e.g., as illustrated in FIGS. 7I and/or 7Q). For example, causing performance of the first action includes performing a search based on the respective object and providing the search results; opening a link embedded in a QR code object; and/or opening a control user interface for an electronic device object; extracting, copying, and/or storing text from the object (e.g., storing an extracted address and/or phone number in a saved contact, copying text into a note, and/or searching for the text). Displaying options for performing actions based on a detected object in response to an input selecting the corresponding displayed symbolic representation reduces the number of inputs and time needed to perform an operation and assists the user with interacting with the physical environment via the computer system, for example, by automatically surfacing actions the computer system can take that are relevant to the user's environmental context (e.g., the detected objects) without requiring the user to provide additional inputs to manually request performance of the actions and/or manually enter information about the detected objects.

In some embodiments, while displaying the one or more additional user interface elements corresponding to the respective object (e.g., 716A-716D and/or 728A-728D), the computer system detects (e.g., via the one or more optical sensors, a touch-sensitive surface, and/or a hardware button) a third user input (e.g., 722C, 722F, 722G, 736A-736B, 738A-738B, and/or 742A-742B) (e.g., an air gesture, touch input, and/or hardware button press input) that satisfies one or more navigation criteria (e.g., as illustrated in FIGS. 7F and/or 7J-7L). In some embodiments, the navigation criteria include a criterion that is satisfied when the third user input includes a movement, such as a swipe, flick, and/or rotation input (e.g., and not when the input includes a selection-type input directed to the first user interface element representing the first action associated with the respective object). In some embodiments, the navigation criteria include a criterion that is satisfied when one or more actions other than the first action are available (e.g., if the computer system identifies additional actions associated with the respective object and/or actions associated with other objects of the first set of one or more objects). In some embodiments, in response to detecting the third user input, the computer system displays a second user interface element, different from the first user interface element, that represents a second action associated with at least one object of the first set of one or more objects (e.g., as illustrated in FIGS. 7G and/or 7K-7M). In some embodiments, the second action is the same as the first action, but is associated with a different object than the respective object (e.g., selecting the second user interface object causes performance of the same action based on a different object). In some embodiments, the second action is different from the first action, such as a different action associated with the respective object or a different action associated with a different object. Displaying navigable options for different actions related to one or more detected objects provides improved visual feedback to the user and assists the user with interacting with the physical environment via the computer system, for example, by informing users of actions the computer system can take that are relevant to the user's environmental context (e.g., the detected objects) as the user interacts with the scan results.

In some embodiments, the respective object of the first set of one or more objects is a respective machine-readable code (e.g., 712B, 900A, and/or 1100A) (e.g., a QR code, URL (e.g., URL text), phone number, address, and/or machine-recognizable symbol). In some embodiments, displaying the one or more additional user interface elements corresponding to the respective object of the first set of one or more objects includes, in accordance with a determination that the respective machine-readable code is a first machine-readable code (e.g., a particular QR code, URL (e.g., URL text), phone number, address, and/or machine-recognizable symbol), displaying, via the one or more display generation components, a third user interface element that represents a third action associated with the first machine-readable code (e.g., 716B, 918A, and/or 1108A). In some embodiments, the computer system identifies the third action based on the first machine-readable code (e.g., the first machine-readable code encodes information and/or instructions for performing the third action). In some embodiments, displaying the one or more additional user interface elements corresponding to the respective object of the first set of one or more objects includes, in accordance with a determination that the respective machine-readable code is a second machine-readable code that is different from the first machine-readable code (e.g., a different particular QR code, URL (e.g., URL text), phone number, address, and/or machine-recognizable symbol), displaying, via the one or more display generation components, a fourth user interface element that represents a fourth action associated with the second machine-readable code, wherein the fourth action is different from the third action (and, optionally, the fourth user interface element is different from and/or has a different appearance from the third user interface element). In some embodiments, the computer system identifies the fourth action based on the second machine-readable code (e.g., the second machine-readable code encodes information and/or instructions for performing the fourth action). For example, the computer system displays different action options for different scanned QR codes, such as opening different links (e.g., URLs and/or application deep links), sharing different information, saving different information, displaying different user interfaces, displaying different content, connecting to different networks, and/or interacting (e.g., texting, calling, and/or conducting transactions) with different contacts.

In some embodiments, while displaying the first set of one or more symbolic representations, the computer system detects (e.g., via the one or more optical sensors) a change in the portion of the physical environment captured via the one or more optical sensors (e.g., as illustrated in FIGS. 7D-7E and/or 7N-7O). In some embodiments, the change in the portion of the physical environment includes a change to a field-of-view of the one or more optical sensors, e.g., due to the one or more optical sensors moving with respect to the environment. In some embodiments, the change in the portion of the physical environment includes a change to the physical environment. For example, the computer system detects one or more new objects, ceases detecting one or more of the first set of one or more objects, and/or detects a change to one or more of the first set of one or more objects. In some embodiments, in response to detecting the change in the portion of the physical environment captured via the one or more optical sensors and in accordance with a determination that the change in the portion of the physical environment captured via the one or more optical sensors satisfies a set of one or more update criteria, the computer system updates the first set of one or more symbolic representations based on the change in the portion of the physical environment captured via the one or more optical sensors (e.g., as illustrated in FIGS. 7E and/or 7O). In some embodiments, updating the first set of one or more symbolic representations includes displaying one or more new symbolic representations, ceasing to display one or more of the first set of symbolic representations, and/or changing how one or more of the first set of symbolic representations are displayed (e.g., updating the appearance, ordering, and/or additional display elements associated with one or more displayed symbolic representations). Updating the displayed symbolic representations as the optical sensors detect certain changes in the physical environment provides improved visual feedback to the user, provides improved control of computer system functionality without cluttering the user interface with additional displayed controls and assists the user with interacting with the physical environment via the computer system. For example, the computer system updates the displayed symbolic representations to provide the user with scan results that are relevant to the current environmental context as the user scans different portions of the physical environment and/or as the physical environment changes around the user.

In some embodiments, the set of one or more update criteria includes a requirement that both a first criterion and a second criterion are satisfied in order for the set of one or more update criteria to be satisfied, wherein: the first criterion is satisfied when detecting the change in the portion of the physical environment captured via the one or more optical sensors includes detecting, in the portion of the physical environment captured via the one or more optical sensors, a respective object that is not included in the first set of one or more objects (e.g., 712D) (e.g., a new object); and the second criterion is satisfied when the respective object is detected in the portion of the physical environment captured via the one or more optical sensors for at least a threshold period of time (e.g., 0.1 s, 0.6 s, 1 s, 2.4 s, 3 s, 10 s, or 30 s) (e.g., as described with respect to FIGS. 7N-7O). In some embodiments, the first criterion further requires that the respective object (e.g., the new object) meets the set of object type criteria. In some embodiments, updating the first set of one or more symbolic representations based on the change in the portion of the physical environment captured via the one or more sensors includes displaying, via the one or more display generation components (e.g., with the first set of one or more symbolic representations), a respective symbolic representation corresponding to the respective object (e.g., 714D). In some embodiments, in accordance with a determination that the second criterion is not satisfied, the computer system forgoes displaying the respective symbolic representation corresponding to the newly-detected object. For example, the computer system waits for the threshold period of time before adding a new symbolic representation for the newly-detected object to the displayed set of symbolic representations, and does not add the new symbolic representation if the new object exits the field-of-view of the one or more optical sensors before the threshold period of time has elapsed (e.g., if the new object is only momentarily detected). Displaying a symbolic representation corresponding to a newly-detected object in the physical environment once the object has been detected for at least a threshold period of time provides improved control of computer system functionality without cluttering the user interface with additional displayed controls and improves the efficiency of display generation, for instance, by reducing the frequency of changes to the display and preventing the display of unintended and/or irrelevant scan results for objects that are only momentarily detected in the physical environment (e.g., due to the user quickly passing over the objects while moving the optical sensors to perform a scan and/or due to the environment quickly changing). Doing so also assists the user with interacting with the physical environment via the computer system, for instance, allowing the user to scan objects present in different portions of the environment without cluttering the display with symbolic representations of objects the user does not intend to scan.

In some embodiments, the set of one or more update criteria includes a requirement that both a third criterion and a fourth criterion are satisfied in order for the set of one or more update criteria to be satisfied, wherein: the third criterion is satisfied when detecting the change in the portion of the physical environment captured via the one or more optical sensors includes ceasing detecting, in the portion of the physical environment captured via the one or more optical sensors, a respective object of the first set of one or more objects (e.g., 712A), wherein the first set of one or more symbolic representations includes a respective symbolic representation associated with the respective object (e.g., 714A) (e.g., one of the objects corresponding to one of the displayed symbolic representations is no longer in the field-of-view of the one or more optical sensors); and the fourth criterion is satisfied when the respective object is not detected in the portion of the physical environment captured via the one or more optical sensors for at least a threshold period of time (e.g., as described with respect to FIGS. 7N-7O) (e.g., 0.1 s, 0.6 s, 1 s, 2.4 s, 3 s, 10 s, or 30 s). In some embodiments, updating the first set of one or more symbolic representations based on the change in the portion of the physical environment captured via the one or more optical sensors includes ceasing displaying the respective symbolic representation (e.g., as illustrated in FIG. 7O). In some embodiments, in accordance with a determination that the fourth criterion is not satisfied, the computer system maintains displaying the respective symbolic representation corresponding to the respective object. For example, when the computer system stops detecting an object corresponding to a displayed symbolic representation, the computer system waits for the threshold period of time before adding removing the symbolic representation for the object from the displayed set of symbolic representations, and does not remove the symbolic representation if the object re-enters the field-of-view of the one or more optical sensors before the threshold period of time has elapsed (e.g., if detection of the object is only momentarily interrupted). Removing a symbolic representation corresponding to an object no longer detected in the physical environment by the optical sensors only once the object is not detected for at least a threshold period of time provides improved control of computer system functionality without cluttering the user interface with additional displayed controls and improves the efficiency of display generation, for instance, by reducing the frequency of changes to the display maintaining the display of scan results for relevant objects in the physical environment for a buffer period (e.g., even if the user temporarily moves the optical sensors away from the corresponding objects and/or the corresponding objects are temporarily moved and/or obscured in the physical environment) while removing scan results that are no longer likely to be relevant. Doing so also assists the user with interacting with the physical environment via the computer system and reduces the risk that transient visual context is missed, for instance, allowing the user to conveniently and comfortably review scan results without needing to maintain detection of the corresponding objects in the environment.

In some embodiments, the set of one or more update criteria includes a requirement that a fifth criterion, a sixth criterion, and a seventh criterion are all satisfied in order for the set of one or more update criteria to be satisfied, wherein: the fifth criterion is satisfied when detecting the change in the portion of the physical environment captured via the one or more sensors includes ceasing detecting, in the portion of the physical environment captured via the one or more sensors, a first respective object of the first set of one or more objects (e.g., 712A), wherein the first set of one or more symbolic representations includes a first respective symbolic representation associated with the respective object (e.g., 714A) (e.g., one of the objects corresponding to one of the displayed symbolic representations is no longer in the field-of-view of the one or more optical sensors); the sixth criterion is satisfied when detecting the change in the portion of the physical environment captured via the one or more sensors includes detecting, in the portion of the physical environment captured via the one or more optical sensors, a second respective object (e.g., 712D) that is not included in the first set of one or more objects (e.g., a new object); and the seventh criterion is satisfied when the first set of one or more symbolic representations (e.g., the displayed set of symbolic representations) includes (e.g., at the time when the second criterion is satisfied) at least a threshold number of symbolic representations (e.g., as described with respect to FIG. 7N) (e.g., one, two, three, four, five, or ten symbolic representations). In some embodiments, the fifth criterion further requires that the first respective object is not detected for at least a threshold period of time. In some embodiments, the sixth criterion further requires that the second respective object (e.g., the new object) meets the set of object type criteria. In some embodiments, the sixth criterion further requires that the second respective object is detected for at least a threshold period of time. In some embodiments, updating the first set of one or more symbolic representations based on the change in the portion of the physical environment captured via the one or more sensors includes ceasing displaying the first respective symbolic representation of the first set of one or more symbolic representations (e.g., 714A) and displaying, via the one or more display generation components (e.g., with the first set of one or more symbolic representations), a second respective symbolic representation (e.g., 714D) corresponding to the second respective object (e.g., as illustrated in FIG. 7O). Accordingly, if the scan criterion is satisfied but the quality criterion is not satisfied, then the second set of criteria is not satisfied, and vis versa. In some embodiments, in accordance with a determination that the fifth and sixth criteria are satisfied but the third criterion is not satisfied (e.g., if less than the threshold number of symbolic representations are displayed), the computer system maintains displaying the first respective symbolic representation while displaying the second respective symbolic representation (e.g., the new symbolic representation is added without removing the previously-displayed symbolic representation). For example, the computer system adds new symbolic representations to the displayed set as new items are detected but waits to remove symbolic representations for previously-detected (e.g., no longer visible) objects until adding a new symbolic representation would exceed a threshold capacity for the displayed set. Removing a symbolic representation corresponding to an object no longer detected in the physical environment by the optical sensors only once a threshold number of symbolic representations are displayed provides improved control of computer system functionality without cluttering the user interface with additional displayed controls and improves the efficiency of display generation, for instance, by reducing the frequency of changes to the display and maintaining the display of scan results for previously-scanned objects in the physical environment until doing so would clutter the display. Doing so also assists the user with interacting with the physical environment via the computer system and reduces the risk that transient visual context is missed, for instance, allowing the user to conveniently and comfortably review scan results without needing to maintain detection of the corresponding objects in the environment.

In some embodiments, in response to detecting the change in the portion of the physical environment captured via the one or more optical sensors and in accordance with the determination that the change in the portion of the physical environment captured via the one or more optical sensors satisfies the set of one or more update criteria (e.g., if the displayed symbolic representations will be updated in response to the change), the computer system provides, via one or more output generation components (that are, optionally, different from the one or more display generation components, such as one or more non-visual output devices such as audio output devices and/or tactile output devices), an additional output that is a non-visual output (e.g., 720A, 720B, 748A, and/or 748B) (e.g., a spoken output, an audio alert sound, another audio output, and/or a tactile (e.g., haptic) output, such as a vibration or simulated tactile sensation). Providing a non-visual output when updating the displayed symbolic representations based on changes to the physical environment provides improved feedback to the user and improved control of computer system functionality without cluttering the user interface with additional displayed controls. For example, by providing a non-visual indication when the displayed scan results are updated, the computer system provides the user with feedback about the performance of the scan without distracting the user from the physical environment.

In some embodiments, while displaying the first set of one or more objects, the computer system detects, via one or more input devices in communication with the computer system, a respective user input (e.g., a touch input, gesture input, air gesture input, gaze input, press input, and/or rotation input) of a respective input type (e.g., 722A-722G) (e.g., an input indicating that a user is reviewing and/or interacting with the displayed symbolic representations). In some embodiments, the respective user input includes a set of one or more inputs selecting a displayed symbolic representation, navigating the displayed symbolic representations, and/or moving the display and/or user's gaze to review the displayed symbolic representations. In some embodiments, in response to detecting the respective input of the respective input type, the computer system sets a scan setting to a paused state (e.g., as described with respect to FIG. 7F), wherein the set of one or more update criteria includes a requirement that an active scan criterion is satisfied in order for the set of one or more update criteria to be satisfied, wherein the active scan criterion is satisfied when the scan setting is not set to the paused state (e.g., the computer system forgoes updating the displayed symbolic representations in response to detected changes in the physical environment while the scan setting is set to the paused state). In some embodiments, while the scan setting is set to the paused state, in response to detecting a user input of a second respective input type that is different from the respective input type, the computer system sets the scan setting to an active (e.g., un-paused) state. In some embodiments, while the scan setting is set to the paused state, in response to detecting an end of the respective user input of the respective input type, the computer system sets the scan setting to an active (e.g., un-paused) state. For example, the computer system pauses updates to the symbolic representation based on detected changes in the physical environment until the computer system determines that the user has stopped reviewing and/or interacting with the displayed symbolic representations (e.g., for at least a threshold period of time) and/or detects an input requesting to return to scanning.

In some embodiments, in response to detecting the change in the portion of the physical environment captured via the one or more optical sensors and in accordance with a determination that the change in the portion of the physical environment captured via the one or more optical sensors does not satisfy the active scan criterion (e.g., the change is detected while scanning is paused), the computer system forgoes updating the first set of one or more symbolic representations based on the change in the portion of the physical environment captured via the one or more optical sensors (e.g., as described with respect to FIGS. 7G-7M) (e.g., whether or not the detected change would otherwise lead to adding, removing, and/or changing a displayed symbolic representation). In some embodiments, in response to detecting the change in the portion of the physical environment and in accordance with a determination that the change in the portion of the physical environment satisfies the active scan criterion (e.g., the scan setting is not set to the paused state) and, in some embodiments, in accordance with a determination that the change in the portion of the physical environment captured via the one or more optical sensors satisfies a set of one or more update criteria), the computer system the first set of one or more symbolic representations based on the change in the portion of the physical environment captured via the one or more optical sensors. Pausing updates to the displayed symbolic representations while scanning the physical environment in response to a respective user input provides improved visual feedback to the user and assists the user with interacting with the physical environment via the computer system (e.g., using optical scan data). For example, providing the user with the option to pause updates to allows users to easily review the displayed scan results without needing to keep the optical sensors steady (e.g., to prevent changes to the field-of-view of the sensors) and/or risking losing scan results when the physical environment changes while the user is reviewing.

In some embodiments, detecting the respective user input of the respective input type includes detecting (e.g., via the one or more optical sensors and/or one or more other sensors, such as motion and/or orientation sensors included in the same housing as the one or more optical sensors) a respective movement of the computer system (e.g., 722A and/or 722B) (e.g., of the one or more display generation components and/or the one or more optical sensors), wherein the respective movement is a movement of a respective type (e.g., a rotation and/or movement indicating that the user is reviewing and/or interacting with the displayed symbolic representations, such as a rotation and/or movement of the display towards the user (e.g., into a reviewing pose) and/or a rotation and/or movement of the one or more optical sensors (e.g., out of a scanning position or pose, such as described with respect to FIGS. 7F and/or 9A-10)). In some embodiments, while the scan setting is set to the paused state, in response to detecting a movement of the computer system of a different type than the respective type, such as a rotation and/or movement of the display away from the user and/or a rotation and/or movement of the one or more optical sensors into a scanning position or pose, the computer system sets the scan setting to the active (e.g., un-paused) state. Pausing updates to the displayed symbolic representations while scanning the physical environment in response to a particular user movement reduces the number of inputs needed to perform an operation, provides improved visual feedback to the user, and assists the user with interacting with the physical environment via the computer system. For example, the computer system automatically pauses updates to the displayed symbolic representations when the user moves in a way that indicates that the user is no longer actively scanning the physical environment and/or is reviewing the displayed symbolic representations, making it easier for the user to review the displayed symbolic representations without needing to provide additional explicit user inputs to prevent the scan results from updating during the review.

In some embodiments, while displaying the first set of one or more symbolic representations and while the scan setting is set to the paused state, the computer system detects a navigation user input (e.g., 722C, 722F, and/or 722G) directed to the first set of one or more symbolic representations. For example, the navigation user input includes a manipulation of a physical control, such as a rotation of a rotatable hardware element (e.g., a crown and/or dial) and/or a gesture input, such as a touch or air gesture moving across the displayed symbolic representations. In some embodiments, the navigation user input is a type of user input that is different from the type of user input used to un-pause scanning. In some embodiments, the navigation user input is a type of user input that is different from the type of user input used to perform an action corresponding to one of the displayed symbolic representations. In some embodiments, in response to detecting the navigation user input directed to the first set of one or more symbolic representations, the computer system updates the first set of one or more symbolic representations based on the navigation user input (e.g., as illustrated in FIG. 7G). In some embodiments, updating the first set of one or more symbolic representations does not include adding or removing any symbolic representations from the first set of one or more symbolic representations (e.g., based on detecting or ceasing to detect one or more objects). In some embodiments, updating the first set of one or more symbolic representations includes changing the current focused symbolic representation (e.g., changing the symbolic representation to which visual emphasis is displayed and/or for which additional information is displayed). Updating the displayed symbolic representations based on explicit user inputs while updates to the displayed symbolic representations based on detected changes to the physical environment are paused provides improved visual feedback to the user and assists the user with interacting with the physical environment via the computer system, for example, by allowing users to flexibly navigate and interact with scan results without needing to keep the optical sensors steady and/or risking losing scan results when the physical environment changes while the user is reviewing.

In some embodiments, the computer system detects (e.g., via one or more audio sensors) a spoken input (e.g., 708A) corresponding to a request to scan the physical environment, and in response to detecting the spoken input corresponding to the request to scan the physical environment, the computer system enables a respective scan mode (e.g., initiating an active scan mode, as further described with respect to FIGS. 9A-12), wherein the first set of one or more objects is detected while the respective scan mode is enabled (e.g., detecting the first set of one or more objects is performed after initiating scanning the physical environment in response to the spoken input). Initiating scanning the physical environment in response to a spoken request provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, the computer system detects (e.g., via the one or more optical sensors and/or one or more other input devices, such as touch sensors, motion sensors, and/or depth sensors) a gesture input corresponding to a request to scan the physical environment (e.g., 708B and/or 708C). In some embodiments, the gesture input corresponding to the request to scan the physical environment includes a gesture input of a particular type, such as a particular air gesture and/or a particular swipe across a touch-sensitive surface. In some embodiments, in response to detecting the gesture input corresponding to the request to scan the physical environment, the computer system enables a respective scan mode (e.g., an active scan mode, as further described with respect to FIGS. 9A-12), wherein the first set of one or more objects is detected while the respective scan mode is enabled (e.g., detecting the first set of one or more objects is performed after enabling the respective scan mode in response to the gesture input). Initiating scanning the physical environment in response to a gesture input (e.g., an air or touch gesture) provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, the computer system detects, via one or more hardware input devices in communication with the computer system (e.g., 702A and/or 702B) (e.g., one or more hardware buttons, such as touch-sensitive, pressure-sensitive, and/or mechanically-depressible buttons, and/or rotatable hardware input devices, such as crowns and/or dials), a hardware input (e.g., 708D, 708E, and/or 708F) corresponding to a request to scan the physical environment. In some embodiments, the hardware input corresponding to the request to scan the physical environment includes a press input detected via a hardware button and/or a rotation input detected via a rotatable hardware input device. In some embodiments, in response to detecting the hardware input corresponding to the request to scan the physical environment, the computer system enables a respective scan mode (e.g., an active scan mode, as further described with respect to FIGS. 9A-12), wherein the first set of one or more objects is detected while the respective scan mode is enabled (e.g., detecting the first set of one or more objects is performed after enabling the respective scan mode in response to the gesture input). Initiating scanning the physical environment in response to a hardware input (e.g., a button press and/or a crown rotation) provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, aspects/operations of methods 800, 1000, 1200, and/or 1300 may be interchanged, substituted, and/or added between these methods. For example, scanning the environment to detect the one or more objects of method 800 optionally includes providing scanning prompts as described with respect to method 1000. For example, the symbolic representations displayed in method 800 are optionally included in scanning feedback provided according to method 1200 and/or an alert provided according to method 1300. For brevity, these details are not repeated here.

FIGS. 9A-9K illustrate examples of techniques and systems for providing environment-aware guidance for scanning a physical environment. FIG. 10 is a flow diagram of an exemplary method 1000 for providing environment-aware guidance for scanning a physical environment. The user interfaces in FIGS. 9A-9K are used to illustrate the processes described below, including the processes in FIG. 10.

At FIG. 9A, computer system 700 receives one or more inputs (e.g., 902A, 902B, 902C, and/or 902D) requesting to initiate active scanning of the physical environment (illustrated as physical environment 900) using the one or more optical sensors (e.g., 706A, 706B, and/or 706C). As illustrated in FIG. 9A, the one or more inputs specifically correspond to a request to scan the physical environment for a QR code. For example, input 902A, a speech input detected using one or more audio sensors of computer system 700, includes the natural-language request, “Scan this code,” which computer system 700 interprets as a request to initiate active scanning for a QR code in the physical environment. As another example, computer system 700 displays user interface 904, a user interface providing options for functions, applications, and/or content available via computer system 700, including option 904A corresponding to the active scan for a QR code, which can be selected to request the active scan for the QR code via the touch-sensitive surface of display 704 (e.g., input 902B), hardware button 702A (e.g., input 902C), crown 702B (e.g., input 902D and/or 902E), and/or another input device.

In response to detecting the one or more inputs requesting to scan the physical environment for a QR code, computer system 700 initiates the requested scan, capturing, using the one or more optical sensors (e.g., 706A, 706B, and/or 706C), optical sensor data corresponding to field-of-view 712 of physical environment 900 and analyzing the captured optical data to detect and provide results corresponding to one or more detected QR codes. For example, computer system 700 scans the physical environment as described with respect to FIGS. 7A-7Q (including, in some embodiments, capturing additional sensor data, such as spatial information indicating how computer system 700, the one or more optical sensors, and/or the user are moving within the physical environment).

At FIG. 9A, computer system 700 determines that physical environment 900 includes a feature of the requested type, feature 900A, which is a QR code printed on a sign. For example, computer system 700 detects feature 900A based on the optical sensor data corresponding to field-of-view 712 (e.g., captured before, during, and/or after detecting the request to scan the physical environment) and/or infers that physical environment 900 includes a QR code based on other sensor data and/or contextual information, such as input 902A (e.g., “Scan this code”).

However, as illustrated in FIG. 9A, field-of-view 712 only includes a portion of feature 900A (e.g., the bottom right corner of the QR code) captured at the edge of field-of-view 712. The detected position of feature 900A with respect to field-of-view 712 at FIG. 9A thus does not allow the one or more optical sensors to capture feature 900A with sufficient quality to successfully scan the QR code. For example, computer system 700 is unable to successfully scan the QR code because the portion of feature 900A included in field-of-view 712 represents an insufficient amount of the QR code and/or the optical scan data corresponding to the captured portion of feature 900A is too distorted and/or noisy (e.g., due to being detected at the edges of the optical sensors' range).

Accordingly, while scanning for a QR code included in the physical environment, computer system 700 provides scanning guidance to prompt the user to change a position of the one or more optical sensors (e.g., 706A, 706B, and/or 706C) based on the position of feature 900A within physical environment 900, as illustrated in FIGS. 9B-9E and described below. As illustrated in FIGS. 9B-9E, computer system 700 provides one or more scanning prompts without displaying another representation of field-of-view 712, such as a live or near-live camera feed of image data captured using the optical sensors.

At FIG. 9B, computer system 700 displays scanning prompt 906A, a glow effect and/or animation that indicates the positioning of the one or more optical sensors within computer system 700 (e.g., within wrist-worn device 700A and/or HMD 700B), prompting the user to reorient computer system 700 to aim the one or more optical sensors at feature 900A to achieve a successful scan of the QR code. As illustrated in FIG. 9B, scanning prompt 906A is animated emanating from the edge of display 704 near optical sensor(s) 706A, including an initial animation of scanning prompt 906A rippling out from the edge of display 704. In some embodiments, the appearance of the glow effect of the animation of scanning prompt 906A is similar to the glow effect of scanning indicator 710A, thus indicating to the user that computer system 700 is initiating the requested active scan. As illustrated in FIG. 9B, scanning prompt 906A overlays user interface 904 (e.g., the user interface displayed when the one or more inputs requesting to initiate active scanning of the physical environment are detected), distorting and/or obscuring portions of user interface 904 as scanning prompt 906A travels across display 704.

At FIG. 9C, computer system 700 displays scanning user interface 710 and provides one or more scanning prompts (e.g., 906B, 906C, 906D, and/or 906E) based on a determination that field-of-view 712 does not overlap with bounding box 910, an estimated and/or detected boundary defining the portion of physical environment 900 that includes feature 900A. Scanning prompt 906B includes displayed text instructions and scanning prompt 906C includes additional display content (e.g., images, graphics, and/or animations) indicating how to orient wrist-worn device 700A and/or HMD 700B with respect to physical environment 900. For example, scanning prompts 906B and/or 906C describe and/or illustrate a scanning pose, such as lifting a wrist to point optical sensor 706A of wrist-worn device 700A away from the user's body and outwards towards the physical environment.

Additionally, computer system 700 provides one or more non-visual scanning prompts, such as scanning prompt 906D, a tactile (e.g., haptic) output generated such that the user feels a tactile sensation near the location of the one or more optical sensors housed within wrist-worn device 700A and/or HMD 700B (e.g., along the upper edge of wrist-worn device 700A optical sensor 706A is housed, as illustrated in FIG. 9C) and/or scanning prompt 906E, an audio output. In some embodiments, computer system 700 provides scanning prompt 906D and/or scanning prompt 906E based on a current scan error condition. For example, scanning prompt 906D includes a particular type of tactile output (e.g., a particular vibration, simulated sensation, and/or sensation pattern) and/or tactile output intensity and/or scanning prompt 906E includes a particular type of audio output (e.g., a particular chime, notification sound effect, and/or speech output) and/or output volume, indicating that a QR code is not currently detected in field-of-view 712.

At FIG. 9D, computer system 700 detects, via the one or more optical sensors, a portion of feature 900A (e.g., the lower right corner of the QR code). For example, as described with respect to FIG. 9A, the portion of feature 900A included in field-of-view 712 (e.g., the lower right corner of the QR code) remains insufficient for a successful scan. Based on a determination that field-of-view 712 overlaps with bounding box 910 (e.g., by at least an initial threshold amount, for instance, enough to include at least 1%, 5%, 10%, 15%, 25%, or 50% of a detected and/or estimated area of feature 900A), computer system 700 changes the provided scanning guidance as illustrated in FIG. 9D, indicating that a portion of feature 900A is now included in field-of-view 712 but prompting the user to reorient computer system 700 to capture more of feature 900A (e.g., to increase the overlap between field-of-view 712 and bounding box 910).

As illustrated in FIG. 9D, computer system 700 ceases providing scanning prompt 906E (e.g., the audio output) and changes scanning prompt 906D (e.g., the tactile output). For example, computer system 700 decreases the tactile output intensity of scanning prompt 906D and/or changes the type of tactile output, indicating that the previous error condition (e.g., not detecting a QR code in field-of-view 712) has been resolved but that an orientation error condition (e.g., the one or more optical sensors not capturing a sufficient amount of feature 900A at the current orientation) persists. In some embodiments, rather than ceasing providing scanning prompt 906E, computer system 700 changes the type and/or volume of the scanning prompt 906E to indicate the changed scanning conditions.

Computer system 700 additionally prompts the user to change the orientation of the one or more optical sensors by updating scanning user interface 710 to display scanning prompts 906A, 906F, and 906G based on the detected position of feature 900A. Scanning prompt 906F includes a simulated three-dimensional arrow that is oriented to point up and to the left, towards feature 900A in physical environment 900. Scanning prompt 906G includes text describing how to move the one or more optical sensors to scan feature 900A (e.g., “Tilt up and to the left”). Computer system 700 displays scanning prompt 906A (e.g., the glow effect/animation displayed near optical sensor 706A) with an appearance indicating how much the current orientation of the one or more optical sensors with respect to feature 900A differs from a target orientation (e.g., an orientation and/or range of orientations that would provide sufficient overlap between field-of-view 712 and bounding box 910). For example, although scanning prompt 906A has an appearance (e.g., glow effect/animation) similar to that of scanning indicator 710A, scanning prompt 906A is displayed with less visual prominence (e.g., less brightly, with softer edges, and/or with a different animation) that scanning indicator 710A to indicate that computer system 700 is still unable to successfully scan the QR code at the current position.

At FIG. 9E, the orientation of the one or more sensors changes to include a larger portion of feature 900A (e.g., the lower half of the QR code) in field-of-view 712. For example, although field-of-view 712 captures more of feature 900A, the optical sensor data corresponding to feature 900A remains insufficient and/or too low-quality to decode the QR code. Based on a determination that the overlap between field-of-view 712 and bounding box 910 has increased (e.g., to over a threshold amount of overlap, for instance, enough to include at least 5%, 10%, 15%, 25%, 50%, or 60% of a detected and/or estimated area of feature 900A), computer system 700 changes the provided scanning guidance as illustrated in FIG. 9E, indicating that the overlap between field-of-view 712 and bounding box 910 has increased but still prompting the user to reorient computer system 700 to capture more of feature 900A.

In particular, computer system 700 increases the intensity of scanning prompt 906D (e.g., the tactile output) and increases the visual prominence of scanning prompt 906A (e.g., brightening and/or increasing the size of the glow effect/animation displayed near optical sensor 706A). As the orientation error criterion persists (e.g., the one or more optical sensors do not capture a sufficient amount of feature 900A at the current orientation), scanning prompt 906D remains the same type of tactile output as at FIG. 9D. In some embodiments, if the orientation of field-of-view 712 changes to include less of feature 900A than before (e.g., the orientation of the one or more sensors gets farther away from the target orientation), computer system 700 reduces the intensity of scanning prompt 906D and/or reduces the visual prominence of scanning prompt 906A.

Additionally, at FIG. 9E, computer system 700 updates scanning prompt 906F to change the direction of the simulated three-dimensional arrow to point up towards feature 900A in physical environment 900. In some embodiments, computer system 700 updates scanning prompt 906F based on the detected position of feature 900A (e.g., the captured optical sensor data) and/or spatial information (e.g., motion and/or orientation data) detected using the one or more spatial information sensors as the one or more optical sensors move with respect to physical environment. For example, computer system 700 animates the displayed arrow rotating (e.g., within a simulated three-dimensional space) so the point follows feature 900A as the user moves wrist-worn device 700A and/or HMD 700B. As illustrated in FIG. 9D, computer system ceases displaying scanning prompt 906F, for instance, based on the determined increased overlap between field-of-view 712 and bounding box 910. In some embodiments, computer system 700 instead updates the text of scanning prompt 906F based on the changed orientation of field-of-view 712 with respect to feature 900A (e.g., changing the text to “Tilt up” or another natural-language prompt to change the orientation of the optical sensors).

At FIG. 9F, the orientation of the one or more optical sensors changes to allow the one or more optical sensors to capture a sufficient amount of feature 900A at a high enough quality for computer system 700 to decode the QR code based on the optical sensor data. For example, the user is in a scanning pose, where wrist-worn device 700A and/or HMD 700B have been moved so that field-of-view 712 entirely overlaps bounding box 910. In response to detecting that the current position and orientation of the one or more optical sensors allows computer system 700 to successfully scan feature 900A in physical environment 900, computer system 700 changes the provided scanning guidance as illustrated in FIG. 9F, indicating that further changes to the position and orientation are not needed. In particular, based on a determination that the previous error conditions have resolved, computer system 700 increases the intensity and/or changes the tactile output type of scanning prompt 906D (e.g., the tactile output) and provides scanning prompt 906H (e.g., an audio output of a different type (e.g., different chime, sound effect, and/or spoken output) and/or volume of than scanning prompt 906E). Additionally, computer system 700 changes the appearance of scanning prompt 906A (e.g., the glow effect/animation displayed near optical sensor 706A). For example, computer system 700 increases the visual prominence of scanning prompt 906A (e.g., further brightening the glow effect) and/or changes the appearance of scanning prompt 906A to transition to the appearance of scanning indicator 710A (e.g., the glow effect/animation displayed while scanning recognized features in the physical environment, such as described with respect to FIGS. 7A-7Q).

While scanning feature 900A in physical environment 900 at FIG. 9F, computer system 700 displays symbolic representation 912A, a QR code icon indicating that computer system 700 has identified feature 900A as a QR code based on the captured optical sensor data. As illustrated in FIG. 9F, computer system 700 displays symbolic representation 912A along with environmental representation 914, a representation of at least a portion of physical environment 900 included in field-of-view 712 of the one or more optical sensors. For example, environmental representation 914 includes a still (e.g., freeze-frame) or near-live (e.g., viewfinder) representation of the portion of field-of-view 712 corresponding to feature 900A.

In some embodiments, computer system 700 generates environmental representation 914 by reconstructing image data corresponding to the portion of field-of-view 712 based on the optical sensor data. For example, the one or more optical sensors (e.g., 706A, 706B, 706C) used to capture field-of-view 712 are low-resolution sensors, so computer system 700 digitally reconstructs a higher-resolution image to display in environmental representation 914 (e.g., upsampling the captured optical sensor data and/or generating higher-resolution image infill using one or more optical processing techniques, such as algorithmic image processing, machine vision, machine learning, and/or generative AI techniques). In some embodiments, reconstructing the image data to include in environmental representation 914 includes processing the captured optical sensor data in other ways, such as removing distortion/noise (e.g., reconstructing a rectified view of feature 900A if the sign with the QR code is askew with respect to field-of-view 712 and/or warped by capture using a wide-angle optical sensor), correcting color, and/or increasing the visual prominence of feature 900A in the reconstructed image.

At FIG. 9G, computer system 700 updates scanning user interface 710 to provide the results of successfully scanning feature 900A. As illustrated in FIG. 9G, computer system 700 displays scanning indicator 710A, symbolic representation 912A, the QR code icon indicating that computer system 700 has identified feature 900A as a QR code based on the captured optical sensor data, and additional information 918A, which is based on the information decoded from the QR code of feature 900A. In particular, additional information 918A includes the text “Open Transit App,” indicating the action computer system 700 can take based on an application deep-link decoded from feature 900A. After displaying symbolic representation 912A and additional information 918A, the user can continue scanning for additional QR codes in the physical environment and/or interacting with scanning user interface 710 as described with respect to FIGS. 7C-7Q. For example, in response to one or more inputs selecting symbolic representation 912A and/or additional information 918A, computer system 700 opens the application deep-link encoded by the scanned QR code.

At FIG. 9G, computer system 700 detects input 920, a spoken input (e.g., “What's that bug?”) requesting to scan the physical environment for a different type of feature than a QR code. In response, computer system 700 initiates the requested scan, specifically analyzing optical sensor data captured using the one or more optical sensors to detect features in physical environment 900 that are likely to correspond to “that bug” (e.g., analyzing the optical sensor data to detect insects, arachnids, arthropods, and/or other small invertebrates).

At FIG. 9G, computer system 700 determines that physical environment 900 includes feature 900B, a bug sitting on a bollard. Although feature 900B is fully captured within field-of-view 712 at FIG. 9G, the position of the one or more optical sensors with respect to the position of feature 900B does not allow the one or more optical sensors to capture feature 900B with sufficient quality to successfully identify the bug. For example, at the current distance from the one or more optical sensors, the bug is out of focus and/or too small for the one or more optical sensors to capture with sufficient resolution. Accordingly, at FIG. 9H, computer system 700 provides scanning guidance to prompt the user to change a position of the one or more optical sensors (e.g., 706A, 706B, and/or 706C) based on the position of feature 900B within physical environment 900, and in particular, to reduce the distance between the one or more optical sensors and feature 900B. As described with respect to FIGS. 9B-9E, computer system 700 provides the scanning guidance at FIG. 9H without displaying a representation of physical environment 900.

As illustrated in FIG. 9H, computer system 700 updates scanning user interface 710 to include scanning prompt 922A, which includes text (e.g., “Move closer”) and an arrow graphic prompting the user to move forwards towards feature 900B, and scanning prompt 922B, a glow effect/animation indicating the position of the one or more optical sensors within computer system 700 (e.g., as described with respect to scanning prompt 906A). Additionally, computer system 700 provides scanning prompt 922C, a non-visual output such as a tactile output localized near the one or more optical sensors (e.g., as described with respect to scanning prompt 906D) and/or an audio output (e.g., as described with respect to scanning prompt 906E). In some embodiments, scanning prompt 922C is a different type of non-visual output than scanning prompt 906D and/or scanning prompt 906E (e.g., a different tactile sensation and/or pattern and/or a different chime, sound effect, and/or spoken output), as the current scan error condition is a distance error condition and not an orientation error condition.

As described with respect to scanning prompts 906A and 906D, in some embodiments, the appearance of scanning prompt 922B and/or the intensity of scanning prompt 922C (e.g., the non-visual output) indicates how much the current proximity of the one or more optical sensors to feature 900B differs from a target proximity (e.g., a distance and/or range of distances at which feature 900B would be captured with sufficient resolution and/or focus). For example, if the distance between the one or more sensors and feature 900B increases, computer system 700 decreases the visual prominence of scanning prompt 922B and/or the intensity of scanning prompt 922C, and if the distance between the one or more sensors and feature 900B decreases, computer system 700 increases the visual prominence of scanning prompt 922B and/or the intensity of scanning prompt 922C.

At FIG. 9H, the distance between the one or more optical sensors and feature 900B decreases enough to capture feature 900B with sufficient resolution and/or sufficiently in focus to allow computer system 700 to identify the bug sitting on the bollard. In response to detecting that the current position and orientation of the one or more optical sensors allows computer system 700 to successfully scan feature 900B in physical environment 900, computer system 700 changes the provided scanning guidance and updates scanning user interface 710 to provide the results of successfully scanning feature 900B as illustrated in FIG. 9H. As illustrated in FIG. 9H, computer system 700 increases the intensity and/or changes the non-visual output type of scanning prompt 922C (e.g., as described with respect to FIG. 9F) and displays scanning indicator 710A, symbolic representation 912B (e.g., a bug icon), and additional information 918B. Additional information 918B includes the text “Learn more about isopods,” indicating both the identity of the bug determined by computer system 700 based on the captured optical sensor data and a follow-up action computer system 700 can perform based on feature 900B (e.g., providing additional information about the identity of the scanned creature).

After displaying symbolic representation 912B and additional information 918B, the user can continue scanning for additional “bugs” in the physical environment and/or interacting with scanning user interface 710 as described with respect to FIGS. 7C-7Q. For example, in response to one or more inputs selecting symbolic representation 912B and/or additional information 918B, computer system 700 displays further information related to isopods. As illustrated in FIG. 9I, in some embodiments, computer system 700 displays both symbolic representation 912B for the newly-scanned feature (e.g., 900B) and symbolic representation 912A for the previously-scanned feature (e.g., 900A), allowing the user to review and interact with the previous scan results as described with respect to FIGS. 7C-7Q.

At FIG. 9I, computer system 700 detects input 924, a spoken input (e.g., “Save that website”) requesting to scan the physical environment for another different type of feature. In response, computer system 700 initiates the requested scan, specifically analyzing optical sensor data captured using the one or more optical sensors to detect features in physical environment 900 that are likely to correspond to a website, such as text, QR codes, and/or other machine-readable symbols.

At FIG. 9I, computer system 700 determines that physical environment 900 includes feature 900C, text printed on a sign that includes the string “.com”. Although feature 900C is partially captured within field-of-view 712 at FIG. 9G, the position of the one or more optical sensors with respect to the position of feature 900C does not allow the one or more optical sensors to capture feature 900C with sufficient quality to successfully identify a website. For example, at the current distance from the one or more optical sensors, the detected text is out of focus and the text preceding “.com” is cut off in field-of-view 712. Accordingly, at FIG. 9J, computer system 700 provides scanning guidance to prompt the user to change a position of the one or more optical sensors (e.g., 706A, 706B, and/or 706C) based on the position of feature 900C within physical environment 900, and in particular, to increase the distance between the one or more optical sensors and feature 900C. As described with respect to FIGS. 9B-9E and 9F, computer system 700 provides the scanning guidance at FIG. 9J without displaying a representation of physical environment 900.

As illustrated in FIG. 9J, computer system 700 updates scanning user interface 710 to include scanning prompt 926A, which includes text (e.g., “Back up”) and an arrow graphic prompting the user to move away from feature 900C, and scanning prompt 926B, a glow effect/animation indicating the position of the one or more optical sensors within computer system 700 (e.g., as described with respect to scanning prompts 906A and/or 922B). Additionally, computer system 700 provides scanning prompt 926C, a non-visual output such as a tactile output localized near the one or more optical sensors (e.g., as described with respect to scanning prompt 906D) and/or an audio output (e.g., as described with respect to scanning prompt 906E). In some embodiments, scanning prompt 926C is a different type of non-visual output than scanning prompt 906D, scanning prompt 906E, and/or scanning prompt 922C (e.g., a different tactile sensation and/or pattern and/or a different chime, sound effect, and/or spoken output), as the current scan error condition is an insufficient distance error condition, not an orientation error condition and/or an excessive distance error condition.

As described with respect to scanning prompts 906A and 906D, in some embodiments, the appearance of scanning prompt 926B and/or the intensity of scanning prompt 926C (e.g., the non-visual output) indicates how much the current proximity of the one or more optical sensors to feature 900C differs from a target proximity (e.g., a distance and/or range of distances at which feature 900C would be in focus and/or fully included within the frame of field-of-view 712). For example, if the distance between the one or more sensors and feature 900C decreases, computer system 700 decreases the visual prominence of scanning prompt 926B and/or the intensity of scanning prompt 926C, and if the distance between the one or more sensors and feature 900C increases, computer system 700 increases the visual prominence of scanning prompt 926B and/or the intensity of scanning prompt 926C.

At FIG. 9K, the distance between the one or more optical sensors and feature 900C increases enough that feature 900C is in focus and fully included within field-of-view 712 to allow computer system 700 to identify a website from the text printed on the sign. In response to detecting that the current position and orientation of the one or more optical sensors allows computer system 700 to successfully scan feature 900C in physical environment 900, computer system 700 changes the provided scanning guidance and updates scanning user interface 710 to provide the results of successfully scanning feature 900C, as illustrated in FIG. 9K. As illustrated in FIG. 9K, computer system 700 increases the intensity and/or changes the non-visual output type of scanning prompt 926C (e.g., as described with respect to FIG. 9F) and displays scanning indicator 710A, symbolic representation 912C (e.g., a favorites icon), and additional information 918C. Additional information 918C includes the text “Save ‘ferry.com,’” indicating both the address of the website identified by computer system 700 based on the captured optical sensor data and a follow-up action computer system 700 can perform based on feature 900C (e.g., saving the identified website to the user's favorites/bookmarks). After displaying symbolic representation 912C and additional information 918C, the user can continue scanning for additional websites in the physical environment and/or interacting with scanning user interface 710 as described with respect to FIGS. 7C-7Q. For example, in response to one or more inputs selecting symbolic representation 912C and/or additional information 918C, computer system 700 performs the action of saving the website “ferry.com” to the user's favorites.

Although the foregoing examples are described with respect to scanning for specific types of features (e.g., a QR code), in some embodiments, computer system 700 provides scanning guidance (e.g., prompts) as described with respect 9B-9E, 9H, and 9J while performing non-specific active scans, such as described with respect to FIGS. 7A-7Q. For example, during a non-specific scan, computer system 700 provides the scanning guidance based on a position of one or more recognizable features rather than based on the position of a specifically-requested type of feature.

Additional descriptions regarding FIGS. 9A-9K are provided below in reference to method 1000 described with respect to FIG. 10.

FIG. 10 is a flow diagram of an exemplary method 1000 for providing environment-aware guidance for scanning a physical environment, in some embodiments. In some embodiments, method 1000 is performed at a computer system (e.g., computer system 101 in FIG. 1A and/or computer system 700) (e.g., including one or more mobile phones, personal computers, laptops, tablets, smart watches, head-mounted displays, other wearable devices, and/or other electronic devices) that is in communication with one or more output devices (e.g., display generation components (e.g., a display controller; a touch-sensitive display system; a display (e.g., 704) (e.g., integrated and/or connected), a 3D display, a transparent display, a projector, and/or a heads-up display), audio generation components (e.g., an audio controller, one or more speakers, and/or other integrated and/or connected audio output devices), and/or tactile output generation components (e.g., haptic generators)) and one or more sensors, wherein the one or more sensors includes one or more optical sensors (e.g., 6-106, 6-108, 6-114, 6-118, 6-118, 706A, 706B, and/or 706C) (e.g., imaging sensors (e.g., visible light and/or IR cameras), depth sensors (e.g., structural light sensors, time-of-flight sensors (e.g., LIDAR), and/or stereoscopic camera sensors), and/or light sensors). In some embodiments, the one or more sensors include one or more motion and/or orientation sensors (e.g., accelerometers, gyroscopes, magnetometers, inertial measurement units (IMUs), and/or location sensors) and/or other sensors (e.g., capacitive sensors, intensity sensors, motion sensors, vibration sensors, audio sensors, temperature sensors, and/or biometric sensors). In some embodiments, the computer system includes a wrist-worn device (e.g., 700A). In some embodiments, the optical sensors are housed within the same device as at least one display (e.g., 704) (e.g., the computer system includes a wrist-worn device that houses both a display and the one or more optical sensors). In some embodiments, the optical sensors point in a direction that is within a threshold range (e.g., within 10°, 30°, 45°, or 60°) of perpendicular to a plane of a display (e.g., as illustrated in FIG. 11L) (e.g., the optical sensors point in one or more directions that are within a threshold range of parallel to the surface of the display). In some embodiments, the motion and/or orientation sensors measure the movement and/or orientation of the optical sensors (e.g., the IMU and optical sensors operate within the same inertial frame of reference). In some embodiments, the computer system is optionally in communication with one or more input devices, such as touch-sensitive surfaces (e.g., of display 704), hardware input devices (e.g., 702A and/or 702B) (e.g., hardware buttons, switches, keys, and/or dials), microphones, gesture input devices, air gesture input devices, and/or gaze input devices. In some embodiments, method 1000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1000 are, optionally, combined and/or the order of some operations is, optionally, changed.

The computer system scans (1002), via the one or more sensors, a physical environment (e.g., 900) (in some embodiments, scanning the physical environment includes capturing scan data of the physical environment, including scan data of a field-of-view of the one or more optical sensors (e.g., 712)). While scanning the physical environment (1004), in accordance with a determination that a set of criteria is satisfied, wherein the set of criteria includes a requirement that a scan criterion s satisfied in order for the set of criteria to be satisfied, wherein the scan criterion is satisfied when the physical environment includes a respective type of feature (e.g., 900A, 900B, and/or 900C) (e.g., one or more objects or items of information that are detectable (e.g., scannable) using the one or more sensors (e.g., objects or items of information that are visible in the physical environment and detectable using the one or more optical sensors) and/or recognizable to the computer system (e.g., using optical processing techniques, such as algorithmic image recognition, machine vision, and/or machine learning techniques), but the detected sensor data and/or recognition results for the one or more objects or items of information do not satisfy scan quality criteria (e.g., criteria that are satisfied when the detected sensor data and/or recognition results include sufficient detail and/or are of sufficiently high quality to perform a respective operation with respect to the one or more objects or items of information, such as extracting text, decoding a QR code, and/or identifying related information)), the computer system provides (1006), via the one or more output devices, a prompt (e.g., 906A, 906B, 906C, 906D, 906E, 906F, 906G, 922A, 922B, 922C, 926A, 926B, and/or 926C) to change a position (e.g., a spatial location and/or orientation) of the one or more optical sensors within the physical environment (e.g., as illustrated in FIGS. 9B-9E, 9H, and/or 9J), wherein the prompt is based on a detected position of the respective type of feature in the physical environment. (e.g., prompting a user to reposition the optical sensors to improve scanning of the scannable feature, for instance, by moving the optical sensors closer to the scannable feature, angling the optical sensors towards the scannable feature, and/or otherwise changing the field-of-view of the optical sensors to improve capture of the scannable feature in the environment). In some embodiments, the scan criterion is satisfied based on a user input requesting to scan the respective type of feature (e.g., a user request to perform an active scan of the physical environment and/or for a specific feature, such as text or a QR code). In some embodiments, the scan criterion is satisfied based on detection of the respective type of feature in the captured scan data. In some embodiments, the set of criteria includes a prompt criterion that is satisfied when recognition of the respective type of feature based on the scan data is unsuccessful (e.g., the recognizable feature is not detected in current and/or recent scan data) and/or when the scan data and/or recognition result does not satisfy the scan quality criteria (e.g., the portion of scan data corresponding to the scannable feature in the physical environment is too noisy, too low-resolution, too warped, incomplete, and/or otherwise insufficient to identify the scannable feature with a threshold level of confidence). In some embodiments, in accordance with a determination that the scan criterion is not satisfied (e.g., the physical environment does not include a scannable feature), the computer system foregoes displaying the prompt. In some embodiments, in accordance with a determination that the criterion is satisfied and the prompt criterion is not satisfied (e.g., recognition of the respective type of feature based on the scan data is successful and/or the scan data and/or recognition result is of sufficiently high quality), the computer system foregoes displaying the prompt and displays a symbolic representation corresponding to the respective type of feature (e.g., as described with respect to FIGS. 7A-8). Providing a prompt to change a position of optical sensors being used to scan a physical environment based on a detected location of a particular feature (e.g., object and/or item of information) in the physical environment provides improved feedback to a user and performs an operation when a set of conditions has been met (e.g., when the particular feature is detected in the physical environment) without requiring further user input, which reduces the power usage and improves the battery life of the computer system by enabling the user to use the device more quickly and efficiently. For example, the prompt to change the position of the optical sensors provides feedback to assist a user with achieving a successful scan of the detected feature, without requiring the user to spend time or provide additional inputs explicitly requesting the assistance. Providing a prompt to change a position of optical sensors being used to scan a physical environment based on a detected location of a particular feature also assists the user with interacting with the physical environment via the computer system (e.g., using optical scan data), which reduces the number of inputs needed to perform an operation (e.g., inputs to manually input context information about the physical environment and/or manually request feedback) and thus reduces the power usage and improves the battery life of the computer system by enabling the user to use the device more quickly and efficiently. For example, providing the prompt helps the user understand how to use the optical sensors for scanning the physical environment and reduces the risk that transient scan opportunities are missed (e.g., due to the optical sensors not being well-positioned to scan the feature).

In some embodiments, providing the prompt to change the position of the one or more optical sensors within the physical environment includes, in accordance with a determination that a field-of-view of the one or more optical sensors overlaps with a portion of the physical environment that includes the detected position of the respective type of feature (e.g., 910) (e.g., a bounding region defining the region of the environment in which the respective type of feature is detectable) by less than a threshold amount (e.g., as illustrated in FIG. 9C), providing, via the one or more output devices, a first prompt output (e.g., 906B, 906C, 906D, and/or 906E as illustrated in FIG. 9C). (e.g., a prompt including particular displayed, audio, and/or tactile output content); and For example, the computer system provides a first type of prompt when the one or more optical sensors are oriented such that less than a threshold amount of the respective type of feature is detected (e.g., the respective type of feature is outside of and/or cut off by the edges of the optical sensors), such that the quality of optical capture of the respective type of feature is degraded (e.g., the respective type of feature is detected in a sub-optimal region for the optical sensors), and/or such that the user is moving the optical sensors away from the respective type of feature. In some embodiments, providing the prompt to change the position of the one or more optical sensors within the physical environment includes, in accordance with a determination that the field-of-view of the one or more optical sensors does not overlap with the portion of the physical environment that includes the detected position of the respective type of feature by less than the threshold amount (e.g., as illustrated in FIGS. 9D-9E), providing, via the one or more output devices, a second prompt output that is different from the first prompt output (e.g., 906F, 906G, and/or 906D as illustrated in FIGS. 9D-9E) (e.g., a prompt including different displayed, audio, and/or tactile output content). For example, when the orientation of the optical sensors enters the bounding region for the respective type of feature, the computer system changes a displayed scan instruction, outputs an audio chime, and/or turns on or increases an intensity of a tactile (e.g., haptic) output to indicate to the user that the user is orienting the optical sensors appropriately for the scan. Providing different prompts to change the position of the optical sensors based on whether, or how much of, the respective type of feature is within the field-of-view of the optical sensors provides improved feedback to a user and assists the user with interacting with the physical environment via the computer system. For example, changing the prompt based on whether a threshold amount of the detected feature is within the field-of-view of the optical sensors provides the user with finer-grained feedback on how to position the optical sensors to achieve a successful scan.

In some embodiments, an output type (e.g., modality) of the first prompt output (e.g., audio prompt 906E as illustrated in FIG. 9C) is different from an output type of the second prompt output (e.g., visual and/or tactile prompts 906F, 906G, and/or 906D as illustrated in FIGS. 9D-9E). For example, the computer system initially provides a displayed prompt to change the position of the one or more optical sensors within the environment, and, when the orientation of the optical sensors enters the bounding region for the respective type of feature, the computer system initiates providing an audio and/or tactile output to indicate to the user that the user is improving the optical sensor orientation for scanning the respective type of feature. Changing the output type of a prompt to change the position of the optical sensors based on whether, or how much of, the respective type of feature is within the field-of-view of the optical sensors provides improved feedback and assists the user with interacting with the physical environment via the computer system, for example, by providing intuitive fine-grained feedback for scanning the feature in the physical environment. Doing so also provides improved control of computer system functionality without requiring additional displayed controls, which reduces the power usage and improves the battery life of the computer system by enabling the user to use the device more quickly and efficiently. For example, depending on the amount of the feature included in the field-of-view of the optical sensors, the computer system provides audio and/or tactile outputs (e.g., instead of or in addition to displayed outputs) to prompt the user to change the position of the optical sensors without the user needing to look away from the physical environment and/or to move the computer system to look at the display.

In some embodiments, an output intensity of the first prompt output (e.g., prompt 906D as illustrated in FIG. 9C) is different from an output intensity of the second prompt output (e.g., prompt 906D as illustrated in FIGS. 9D-9E). In some embodiments, the output intensity of the first prompt output is less than the output intensity of the second prompt output. For example, the computer system initially provides a low-volume audio output and/or a low-intensity tactile output (e.g., a low speed and/or amplitude vibration), then increases the volume and/or intensity as the user moves the optical sensors towards the respective type of feature. In some embodiments, the output intensity of the first prompt output is greater than the output intensity of the second prompt output. For example, the computer system initially provides a high-volume audio output and/or a high-intensity tactile output (e.g., a high speed and/or amplitude vibration), then decreases the volume and/or intensity as the user moves the optical sensors towards the respective type of feature. Changing the intensity (e.g., audio volume and/or tactile output intensity) of a prompt to change the position of the optical sensors based on whether, or how much of, the respective type of feature is within the field-of-view of the optical sensors provides improved control of computer system functionality without requiring additional displayed controls, provides improved feedback to the user, and assists the user with interacting with the physical environment via the computer system, for example, by providing intuitive fine-grained feedback for scanning the feature in the physical environment. For example, depending on the amount of the feature included in the field-of-view of the optical sensors, the computer system changes the intensity of audio and/or tactile outputs to prompt the user to change the position of the optical sensors without the user needing to look away from the physical environment and/or to move the computer system to look at the display.

In some embodiments, providing the prompt to change the position of the one or more optical sensors within the physical environment includes an instruction (e.g., 922A and/or 926A) (e.g. audio, haptic, and/or visual instruction) to change (e.g., increase or decrease) a respective distance from the position of the one or more optical sensors within the physical environment to the detected position of the respective type of feature in the physical environment (e.g., as illustrated in FIGS. 9H and/or 9J). In some embodiments, the instruction to change the respective distance is provided in accordance with a determination that a distance criterion is satisfied wherein the distance criterion is satisfied when the respective distance reduces optical scan quality for the respective type of feature by over a threshold amount (e.g., the one or more optical sensors are positioned too close or too far away from the respective type of feature to effectively scan the respective type of feature). In some embodiments, the optical scan quality is based on the optical features of the one or more optical sensors (e.g., the sensor range, magnification, and/or resolution) and/or the characteristics of the respective type of feature (e.g., the feature's size, level of detail, and/or boundaries). For example, the computer system provides an instruction to increase distance between the optical sensors and the respective type of feature if the feature extends outside of the sensor boundaries and/or if the sensors are too close to capture the feature in focus. As another example, the computer system provides an instruction to decrease the distance between the optical sensor and the respective type of feature if the optical sensors cannot capture the feature with sufficient resolution for a scan. In some embodiments, the set of criteria includes a criterion that is satisfied when the distance criterion and/or another quality criterion (e.g., the orientation criterion) is satisfied. Providing a prompt to change the distance between the optical sensors and the detected feature provides improved feedback to a user, performs an operation when a set of conditions has been met without requiring further user input, and assists the user with interacting with the physical environment via the computer system. For example, the computer system automatically prompts the user to change the distance between the optical sensors and the feature if the optical sensors are too far away (e.g., the feature is out of focus and/or cannot be captured with high enough resolution) or too close (e.g., the feature is out of focus and/or cut off in the field-of-view of the sensors) to effectively scan the feature in the physical environment.

In some embodiments, providing the prompt to change the position of the one or more optical sensors within the physical environment includes an instruction (e.g., 906A, 906B, 906C, 906D, 906E, 906F, and/or 906G) (e.g. audio, haptic, and/or visual instruction) to change a respective orientation between the position of the one or more optical sensors within the physical environment to the detected position of the respective type of feature in the physical environment (e.g., as illustrated in FIGS. 9B-9E) (e.g., by moving, rotating, and/or tilting the one or more optical sensors with respect to the respective type of feature). In some embodiments, the instruction to change the respective orientation is provided in accordance with a determination that an orientation criterion is satisfied, wherein the orientation criterion is satisfied when the respective orientation reduces optical scan quality for the respective type of feature by over a threshold amount. For example, the computer system provides an instruction to change the orientation of the one or more optical sensors if the feature extends outside of the sensor boundaries and/or the orientation of the optical sensors warps the scan of the feature. In some embodiments, the set of criteria includes a criterion that is satisfied when the orientation criterion and/or another quality criterion (e.g., the distance criterion) is satisfied. Providing a prompt to change the orientation of the optical sensors with respect to the detected feature provides improved feedback to a user, performs an operation when a set of conditions has been met without requiring further user input, and assists the user with interacting with the physical environment via the computer system. For example, the computer system automatically prompts the user to change the direction the optical sensors are pointing in order to capture more of a detected feature and/or to capture the detected feature with less distortion using the optical sensors.

In some embodiments, providing the prompt to change the position of the one or more optical sensors within the physical environment includes displaying, via one or more display generation components of the one or more output devices, an indicator object modeled within a simulated three-dimensional space (e.g., 906F). In some embodiments, an orientation of the indicator object within the simulated three-dimensional space corresponds to the orientation between the position of the one or more optical sensors within the physical environment with respect to the detected position of the respective type of feature in the physical environment. For example, the indicator object points in the direction in which the one or more optical sensors should move to scan the respective type of feature. In some embodiments, providing the prompt to change the position of the one or more optical sensors within the physical environment includes, while displaying the indicator object, detecting (e.g., via the one or more optical sensors and/or one or more other sensors, such as motion sensors) a respective change in the position of the one or more optical sensors within the physical environment with respect to the detected position of the respective type of feature in the physical environment (e.g., as illustrated in FIGS. 9D-9E) and, in response to detecting the respective change in the position of the one or more optical sensors within the physical environment with respect to the detected position of the respective type of feature in the physical environment, animating the indicator object moving within the simulated three-dimensional space based on the respective change (e.g., as illustrated in FIG. 9E). For example, the computer system reorients the indicator object within the simulated three-dimensional space to point towards the respective type of feature, indicating how the change affected the scan orientation and/or how the user should continue to move the optical sensors for the scan. Displaying a simulated three-dimensional indicator to prompt the user to change the orientation of the optical sensors with respect to the detected feature provides improved visual feedback to a user and assists the user with interacting with the physical environment via the computer system, for example, by providing an intuitive indication of how the user should move the optical sensors in three-dimensional space with respect to the physical environment in order to achieve a higher-quality scan of the detected feature.

In some embodiments, providing the prompt to change the position of the one or more optical sensors within the physical environment includes displaying, via a display generation component (e.g., at least one display generation component) of the one or more output devices, a visual indicator (e.g., 906A) (e.g., a display element, user interface, animation, and/or visual effect) at a location of the display generation component corresponding to (e.g., physically near and/or indicating) a location of the one or more optical sensors (e.g., a location on the display that indicates the direction in which the one or more optical sensors point). For example, the visual indicator is displayed at an edge or corner of the display physically near where the one or more optical sensors are housed. Displaying an indication of the location of the optical sensors (e.g., within the computer system housing) when prompting the user to change the orientation of the optical sensors with respect to the detected feature provides improved visual feedback to a user and assists the user with interacting with the physical environment via the computer system, for example, by providing an intuitive indication of where the optical sensors are located and the direction in which they point, helping the user understand how to reposition the optical sensors to effectively scan the physical environment.

In some embodiments, displaying the visual indicator at the location of the display corresponding to the location of the one or more optical sensors includes, while displaying, via the display generation component, a respective user interface (e.g., 904) (e.g., a scan user interface, a prompt user interface, and/or another user interface, such as a user interface that was displayed when the scan of the physical environment is initiated), displaying an animation that distorts (e.g., changes an appearance of) a portion of the respective user interface that corresponds to (e.g., is physically near and/or indicates) the location of the one or more optical sensors (e.g., as illustrated in FIG. 9B) (in some embodiments, without distorting another portion of the respective user interface). For example, the animation distorts content displayed near an edge or corner of the display physically near where the one or more optical sensors are housed and/or emanates out from the location of the one or more sensors (e.g., a shockwave animation traveling out from the sensor location and across the display). Displaying an animation distorting a portion of a user interface near the location of the optical sensors when prompting the user to change the orientation of the optical sensors with respect to the detected feature provides improved visual feedback to a user and assists the user with interacting with the physical environment via the computer system, for example, by providing an intuitive indication of where the optical sensors are located and the direction in which they point, helping the user understand how to reposition the optical sensors to effectively scan the physical environment.

In some embodiments, providing the prompt to change the position of the one or more optical sensors within the physical environment includes providing, via the one or more output devices, a non-visual output (e.g., 906D, 906E, 922C, and/or 926C) (e.g., an audio and/or tactile (e.g., haptic) output, such as a spoken output, chime, alert tone, vibration, and/or simulated tactile sensation). In some embodiments, the non-visual output is provided in accordance with a determination that a respective set of one or more criteria is satisfied that is the same as or different from the set of criteria satisfied to provide the prompt. In some embodiments, in accordance with a determination that the respective set of one or more criteria is not satisfied, the computer system foregoes providing the non-visual output but provides a visual output (e.g., a displayed prompt) (e.g., as long as the set of criteria is satisfied). Prompting the user to change the position of the optical sensors with respect to the detected feature provides improved control of computer system functionality without requiring additional displayed controls, provides improved feedback to the user, and assists the user with interacting with the physical environment via the computer system. For example, providing audio and/or tactile prompts assists the user with repositioning the optical sensors during the scan without needing the user to look away from the physical environment and/or to move the computer system to look at the display.

In some embodiments, providing the prompt to change the position of the one or more optical sensors within the physical environment includes, while providing the non-visual output (e.g., 906D, 906E, 922C, and/or 926C), detecting (e.g., via the one or more optical sensors and/or one or more other sensors that are in communication with the computer system, such as one or more motion sensors) a change to a distance between the position of the one or more optical sensors within the physical environment and the detected position of the respective type of feature in the physical environment (e.g., as described with respect to FIGS. 9H-9K) and, in response to detecting the change to the distance between the position of the one or more optical sensors within the physical environment and the detected position of the respective type of feature in the physical environment, changing (e.g., increasing or decreasing) an intensity of the non-visual output (e.g., as described with respect to FIGS. 9H-9K) (e.g., a volume level of an audio output and/or a vibration intensity of a tactile output). For example, the computer system increases the intensity of the non-visual output in response to detecting the distance between the optical sensors and the respective type of feature move closer to a target proximity range (e.g., as the user moves the optical sensors into a better position to scan the respective type of feature) and decreases the intensity of the non-visual output in response to detecting the distance between the optical sensors and the respective type of feature moves farther away from the target proximity range (e.g., as the user moves the optical sensors into a worse position to scan the respective type of feature). In some embodiments, in accordance with a determination that, after the change, the distance between the optical sensors and the respective type of feature falls within the target proximity range (e.g., a distance range appropriate for scanning the respective type of feature with the one or more optical sensors), the computer system ceases providing the non-visual output (e.g., the non-visual output stops after the one or more optical sensors are successfully repositioned to scan the respective type of feature). In some embodiments, when, after the change, the distance between the optical sensors and the respective type of feature falls within the target proximity range, the computer system optionally provides a confirmation output (e.g. an audio, haptic, and/or visual output indicating successful adjustment of the position of the one or more optical sensors). Changing an intensity of a non-visual prompt as the proximity of the optical sensors to the detected feature changes provides improved control of computer system functionality without requiring additional displayed controls, provides improved feedback to the user, and assists the user with interacting with the physical environment via the computer system, for example, by providing intuitive fine-grained feedback for scanning the feature in the physical environment that does not require the user to look at the display.

In some embodiments, the set of one or more criteria includes a requirement that an error criterion is satisfied in order for the set of one or more criteria to be satisfied, wherein the error criterion is satisfied when the position of the one or more optical sensors within the physical environment relative to the detected position of the respective type of feature in the physical environment satisfies at least one error condition (e.g., as described with respect to FIGS. 9C-9E, 9H, and/or 9J) (e.g., a distance and/or orientation of the one or more optical sensors are outside of respective target ranges for scanning the respective type of feature with the one or more optical sensors). In some embodiments, the position of the one or more optical sensors within the physical environment relative to the detected position of the respective type of feature in the physical environment satisfies at least one error condition when the distance criterion (e.g., satisfied when the distance of the optical sensors reduces optical scan quality for the respective type of feature by over a threshold amount) and/or the orientation criterion (e.g., satisfied when the orientation of the optical sensors reduces optical scan quality for the respective type of feature by over a threshold amount) is satisfied. For example, if the one or more optical sensors are too close to the respective type of feature, too far from the respective type of feature, and/or too misaligned with the respective type of feature (e.g., the position and/or orientation of the one or more optical sensors warps, obscures, and/or precludes capturing at least a portion of the respective type of feature), the computer system provides a non-visual output (e.g., with or without an accompanying visual output, such as a displayed prompt). Providing a non-visual prompt when the position of the optical sensors with respect to the detected feature satisfies an error condition (e.g., when the position of the optical sensors reduces the scan quality of the detected feature) provides improved control of computer system functionality without requiring additional displayed controls, provides improved feedback to the user, and assists the user with interacting with the physical environment via the computer system, for example, by quickly and intuitively alerting the user when the position of the optical sensors should be changed, allowing the user to quickly adjust the sensor positioning and achieve a successful scan of the feature.

In some embodiments, in accordance with a determination that the at least one error condition includes a first error condition (e.g., the one or more optical sensors are too close, too far, and/or too misaligned to appropriately capture the respective type of feature), the computer system provides, via the one or more output devices, a first non-visual output (e.g., 906D and/or 906E) (e.g., a non-visual output of a first type, first characteristics, and/or including first content), and, in accordance with a determination that the at least one error condition includes a second error condition that is different from the first error condition, the computer system provides, via the one or more output devices, a second non-visual output that is different from the first non-visual output (e.g., 922C, and/or 926C) (e.g., a non-visual output of a different type, different characteristics, and/or including different content). In some embodiments, the first and second error conditions can be met simultaneously (e.g., the optical sensors are both too far from the respective type of feature and misaligned with the respective type of feature). In some embodiments, the first and second error condition are mutually exclusive (e.g., the first error condition is met when the optical sensors are too far from the respective type of feature and the second error condition is met when the optical sensors are too close to the respective type of feature). Providing different non-visual prompt outputs based on which error condition(s) are satisfied by the position of the optical sensors with respect to the detected feature provides improved control of computer system functionality without requiring additional displayed controls, provides improved feedback to the user, and assists the user with interacting with the physical environment via the computer system, for example, by providing the user with specific feedback on how to move the optical sensors to improve the scan quality in the current context.

In some embodiments, while scanning the physical environment, the computer system displays, via a display generation component (e.g., at least one display generation component) of the one or more output devices, a visual indicator (e.g., 710A, 906A, 922B, and/or 926B) (e.g., a display element, user interface, animation, and/or visual effect) at a location of the display generation component corresponding to (e.g., physically near and/or indicating) a location of the one or more optical sensors (e.g., a location on the display that indicates the direction in which the one or more optical sensors point). In some embodiments, providing the prompt to change the position of the one or more optical sensors within the physical environment (e.g., in accordance with the determination that the first set of criteria is satisfied) includes changing an appearance of the visual indicator. For example, the computer system animates the visual indicator (e.g., displaying a shockwave animation emanating from the location of the one or more optical sensors); changes a size, shape, color, brightness, and/or other visual characteristic of the visual indicator; and/or temporarily ceases displaying the visual indicator (e.g., overlaying and/or obscuring the visual indicator with other visual prompt content, such as displayed instructions). Displaying an indication of the location of the optical sensors (e.g., within the computer system housing) when scanning the environment with the optical sensors provides improved visual feedback to a user and assists the user with interacting with the physical environment via the computer system, for example, by providing an intuitive indication of where the optical sensors are located and the direction in which they point, helping the user understand how to reposition the optical sensors to effectively scan the physical environment.

In some embodiments, while scanning the physical environment and in accordance with a determination that a second set of criteria is satisfied, the computer system provides, via the one or more output devices, a respective non-visual output (e.g., 906H and/or 906D as illustrated in FIG. 9F, 922C as illustrated in FIG. 9I, and/or 926C as illustrated in FIG. 9K) (e.g., an audio and/or tactile (e.g., haptic) output, such as a spoken output, chime, alert tone, vibration, and/or simulated tactile sensation). For example, the respective non-visual output includes audio and/or tactile content indicating that the respective type of feature is successfully captured (e.g., scanned) via the one or more optical sensors. In some embodiments, the second set of criteria includes a requirement that both the scan criterion and a quality criterion are satisfied in order for the second set of criteria to be satisfied, wherein: the scan criterion is satisfied when the physical environment includes the respective type of feature and the quality criterion is satisfied when scan data captured by the one or more optical sensors (e.g., from the sensors' current position within the physical environment) that corresponds to the respective type of feature meets a threshold quality level (e.g., as described with respect to FIGS. 9F, 9I, and/or 9K). Accordingly, if the scan criterion is satisfied but the quality criterion is not satisfied, then the second set of criteria is not satisfied, and if the scan criterion is not satisfied but the quality criterion is satisfied, then the second set of criteria is not satisfied. ISE, the computer system provides the respective non-visual output in accordance with a determination that at least one of the scan criterion and the quality criterion is met. In some embodiments, scan data of the respective type of feature meets a threshold quality level if the scan data captures the respective type of feature with sufficient completeness (e.g., less than a threshold amount of the feature is excluded from the scan field-of-view), sufficient accuracy (e.g., the feature is not warped and/or obscured more than a threshold amount in the scan data), and/or sufficient clarity (e.g., the feature is captured with enough detail and/or resolution) to identify the respective type of feature from the scan data (e.g., using image processing and/or machine vision techniques). Providing a non-visual output when the optical sensors successfully scan a detected feature (e.g., when the position of the optical sensors with respect to the detected feature allows the optical sensors to capture the feature with sufficiently high quality) provides improved control of computer system functionality without requiring additional displayed controls, provides improved feedback to the user, and assists the user with interacting with the physical environment via the computer system. For example, the non-visual output provides the user with positive feedback for a successful scan, which also alerts the user that scan results are available to review and that the user no longer needs to hold the optical sensors at the current position with respect to the scanned feature.

In some embodiments, providing the prompt to change the position of the one or more optical sensors within the physical environment includes displaying, via one or more display generation components of the one or more output devices, a visual output (e.g., 906A, 906B, 906C, 906F, 906G, 922A, 922B, 926A, and/or 926B) (e.g., including text, icons, images, graphics, and/or animations prompting the user to change the position of the one or more optical sensors within the physical environment), wherein the visual output is displayed without displaying, via the one or more display generation components, a representation of a field-of-view of the physical environment captured via the one or more optical sensors (e.g., as illustrated in FIGS. 9B-9E, 9H, and/or 9J) (e.g., the prompt is displayed without displaying optical sensor data, such as a live or near-live viewfinder of the field-of-view of the one or more cameras). Displaying a prompt to change the position of the optical sensors with respect to the detected feature provides improved control of computer system functionality without requiring additional displayed controls, provides improved visual feedback to the user, and assists the user with interacting with the physical environment via the computer system. For example, the prompt provides the user with scanning guidance without expending additional processing or power resources to display a camera (or other optical sensor) feed, which also improves readability of the prompt.

In some embodiments, while scanning the physical environment and in accordance with a determination that a third set of criteria is satisfied, wherein the third set of criteria includes a requirement that the scan criterion is satisfied in order for the third set of criteria to be satisfied, wherein the scan criterion is satisfied when the physical environment includes the respective type of feature, the computer system displays, via one or more display generation components of the one or more output devices, one or more symbolic representations corresponding to the respective type of feature (e.g., 912A, 912B, and/or 912C) (e.g., symbolic representations corresponding to one or more objects recognized in the physical environment, e.g., as described with respect to FIGS. 7A-8). In some embodiments, the third set of criteria is the same as the set of criteria (e.g., the computer system displays the symbolic representation as part of the prompt to change the position to better capture the respective type of feature). In some embodiments, the third set of criteria is the same as the second set of criteria (e.g., the computer system displays the symbolic representation when the respective type of feature is scanned successfully). Displaying symbolic representations of features (e.g., objects and/or items of information) detected when scanning a physical environment with the optical sensors provides improved visual feedback to the user and assists the user with interacting with the physical environment via the computer system, for example, by providing users with easily-readable scan results indicating information about the physical environment and/or computer system functionality related to the physical environment.

In some embodiments, while displaying the one or more symbolic representations corresponding to the respective type of feature, the computer system detects (e.g., via the one or more optical sensors and/or one or more other sensors, such as motion sensors) a change in a portion of the physical environment captured via the one or more optical sensors (e.g., as described with respect to FIGS. 7D-7E, 7N-7P, and/or 9H-9K). In some embodiments, the change in the portion of the physical environment includes a change to a field-of-view of the one or more optical sensors, e.g., due to the one or more optical sensors moving with respect to the environment. In some embodiments, the change in the portion of the physical environment includes a change to the physical environment. In some embodiments, in response to detecting the change in the portion of the physical environment captured via the one or more optical sensors and in accordance with a determination that the change in the portion of the physical environment captured via the one or more optical sensors satisfies a set of one or more update criteria, the computer system updates the one or more symbolic representations based on the change in the portion of the physical environment captured via the one or more optical sensors (e.g., as illustrated in FIGS. 7E, 7I, 9I, and/or 9K). In some embodiments, updating the one or more symbolic representations includes displaying one or more new symbolic representations, ceasing to display one or more symbolic representations, and/or changing how one or more of the symbolic representations are displayed (e.g., updating the appearance, ordering, and/or additional display elements associated with one or more displayed symbolic representations). Updating the displayed symbolic representations as the optical sensors detect certain changes in the physical environment provides improved visual feedback to the user, provides improved control of computer system functionality without cluttering the user interface with additional displayed controls and assists the user with interacting with the physical environment via the computer system. For example, the computer system updates the displayed symbolic representations to provide the user with scan results that are relevant to the current environmental context as the user scans different portions of the physical environment and/or as the physical environment changes around the user.

In some embodiments, while displaying the one or more symbolic representations corresponding to the respective type of feature, the computer system detects a respective user input (e.g., 722C, 722F, and/or 722G) (e.g., an air gesture, touch input, press input, and/or rotation input) directed to the one or more symbolic representations, and, in response to detecting the respective user input, the computer system updates the one or more symbolic representations based on the respective user input (e.g., as illustrated in FIGS. 7F-7G). For example, as described with respect to FIGS. 7A-8, updating the one or more symbolic representations based on the respective user input includes changing visual emphasis characteristics of one or more symbolic representations (e.g., in response to an input changing the focused symbolic representation), displaying (e.g., or removing) additional information related to one or more symbolic representations, and/or rearranging the one or more symbolic representations.

In some embodiments, while displaying the one or more symbolic representations corresponding to the respective type of feature (e.g., 912A), the computer system displays, via the one or more display generation components of the one or more output devices, a representation (e.g., 914) of a field-of-view of the physical environment captured via the one or more optical sensors (e.g., as illustrated in FIG. 9F) (e.g., an optical sensor data preview, such as a live or near-live viewfinder of the physical environment). In some embodiments, the representation of the field-of-view of the physical environment is displayed and in accordance with a determination that one or more criteria are satisfied. For example, the representation of the field-of-view of the physical environment is only displayed while performing certain types of scans (e.g., when performing a specific scan for a QR code). Displaying a symbolic representation of a scanned feature along with a representation of a field-of-view of the one or more optical sensors provides improved visual feedback to the user and assists the user with interacting with the physical environment via the computer system. For example, the representation of the field-of-view of the one or more optical sensors allows the user to confirm the portion of the physical environment that was scanned for the displayed symbolic representation of the scan result, assisting the user with scanning the physical environment as intended.

In some embodiments, scanning the physical environment includes capturing, via the one or more optical sensors, optical scan data at a first resolution (e.g., the computer system obtains one or more low-resolution optical sensor captures and/or recordings) and displaying the representation (e.g., 914) of the field-of-view of the physical environment captured via the one or more optical sensors includes generating, based on the optical scan data, the representation of the field-of-view of the physical environment at a second resolution that is higher than the first resolution (e.g., the representation of the field-of-view of the physical environment is a higher-resolution representation digitally reconstructed from the lower-resolution optical sensor). Digitally reconstructing a higher-resolution representation of a field-of-view of the one or more optical sensors to display with a symbolic representation of a scan result provides improved visual feedback to the user and assists the user with interacting with the physical environment via the computer system. For example, the computer system reduces power usage and extends the battery life of the system by using lower-resolution optical sensors to perform scans, but generating a higher-resolution representation of the sensor data to allow the user to confirm the portion of the physical environment that was scanned for the displayed symbolic representation.

In some embodiments, the computer system detects (e.g., via one or more audio sensors) a spoken input (e.g., 708A, 902A, 920, and/or 924) corresponding to a request to scan the physical environment, wherein scanning the physical environment is initiated in response to detecting the spoken input. In some embodiments, the spoken input includes an indication of the respective type of feature (e.g., the request to scan the physical environment includes a request to scan for a specific feature, such as text or a QR code). Initiating scanning the physical environment in response to a spoken request provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, the computer system detects (e.g., via the one or more optical sensors and/or one or more other input devices, such as touch sensors, motion sensors, and/or depth sensors) a gesture input (e.g., 708B, 708C, and/or 902B) corresponding to a request to scan the physical environment, wherein scanning the physical environment is initiated in response to detecting the gesture input. In some embodiments, the gesture input corresponding to the request to scan the physical environment includes a gesture input of a particular type, such as a particular air gesture and/or a particular swipe across a touch-sensitive surface. In some embodiments, the gesture input corresponding to the request to scan the physical environment includes a gesture input directed to a user interface element corresponding to scanning the physical environment (e.g., a touch or air tap directed to a software button for performing a scan). In some embodiments, the gesture input indicates the respective type of feature (e.g., a touch or air tap directed to a software button for performing a scan for a specific feature, such as text or a QR code). Initiating scanning the physical environment in response to a gesture input (e.g., an air or touch gesture) provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, the computer system detects, via one or more hardware input devices in communication with the computer system (e.g., 702A and/or 702B) (e.g., one or more hardware buttons, such as touch-sensitive, pressure-sensitive, and/or mechanically-depressible buttons, and/or rotatable hardware input devices, such as crowns and/or dials), a hardware input (e.g., 708D, 708E, 708F, 902C, 902D, and/or 902E) corresponding to a request to scan the physical environment, wherein scanning the physical environment is initiated in response to detecting the hardware input. In some embodiments, the hardware input corresponding to the request to scan the physical environment includes a press input detected via a hardware button and/or a rotation input detected via a rotatable hardware input device. In some embodiments, the hardware input indicates the respective type of feature (e.g., using the hardware input device(s) to select an option to scan for a specific feature, such as text or a QR code). Initiating scanning the physical environment in response to a hardware input (e.g., a button press and/or a crown rotation) provides improved control of computer system functionality without cluttering the user interface with additional displayed controls and assists the user with interacting with the physical environment via the computer system, for example, by allowing users to quickly and intuitively begin a scan without needing to look at a display and/or provide other inputs that would distract the user from the physical environment (e.g., risking missing transient scan opportunities).

In some embodiments, aspects/operations of methods 800, 1000, 1200, and/or 1300 may be interchanged, substituted, and/or added between these methods. For example, detecting one or more objects according to method 800, scanning the environment in one or more different scan modes according to method 1200, and/or detecting different information in the physical environment according to method 1300 optionally include providing scanning prompts as described with respect to method 1000. For brevity, these details are not repeated here.

FIGS. 11A-11L illustrate examples of techniques and systems for providing scanning outputs based on scanning a physical environment. FIG. 12 is a flow diagram of an exemplary method 1200 for providing feedback while scanning a physical environment in different scanning modes. FIG. 13 is a flow diagram of an exemplary method 1200 for providing alerts based on different information detected while scanning a physical environment. The user interfaces in FIGS. 11A-11L are used to illustrate the processes described below, including the processes in FIGS. 12 and 13.

At FIG. 11A, computer system 700 scans the physical environment by capturing, via the one or more optical sensors (e.g., 706A, 706B, and/or 706C) optical scan data representing visible features within the physical environment, and in particular, optical scan data representing field-of-view 712 and field-of-view 713. For example, field-of-view 712 is a field-of-view of one or more forward optical sensors (e.g., optical sensor 706A and/or one or more forward-oriented sensors of optical sensors 706C), and field-of-view 713 is a field-of-view of one or more optical sensors oriented in a different direction (e.g., optical sensor 706B and/or one or more rear-, side-, and/or downward-oriented optical sensors of optical sensors 706C). As illustrated in FIG. 11A, the captured optical scan data representing field-of-view 712 and field-of-view 713 includes optical scan data that allows computer system 700 to identify feature 1100A, a QR code printed on a paper restaurant check; feature 1100B, the restaurant check that includes a restaurant bill subtotal, a line for writing a tip (e.g., gratuity) amount, and a line for writing the total bill amount; feature 1100C, a fork; and feature 1100D, a mostly-empty glass of water.

While scanning the physical environment, computer system 700 captures additional scan data using one or more spatial information sensors (e.g., accelerometers, gyroscopes, magnetometers, inertial measurement units (IMUs), and/or location sensors), capturing spatial information representing the position, orientation, and/or movement of computer system 700, the one or more optical sensors (e.g., 706A, 706B, and/or 706C), and/or the user of computer system 700 within the physical environment. For example, in addition to capturing optical scan data representing field-of-view 712 and field-of-view 713 at FIG. 11A, computer system 700 captures spatial information corresponding to the user's location (e.g., an address and/or coordinates of the restaurant) and/or movements, such as motion information corresponding to the user picking up the glass of water to drink, reaching for the restaurant check, and/or moving the one or more optical sensors to point towards one or more of the features. In some embodiments, while scanning the physical environment, computer system 700 captures additional scan data using one or more other sensors. For example, computer system 700 captures audio data (e.g., speech inputs, ambient speech, non-speech verbalizations, ambient sounds, audio playback from sources other than computer system 700, and/or audio intensity information), biometric data (e.g., heart rate, electrocardiogram readings, body temperature, and/or blood oxygen), and/or environmental data (e.g., environmental temperature, sun exposure, and/or humidity data) using one or more other sensors. In some embodiments, while scanning the physical environment, computer system 700 obtains contextual information, such as computer system information (e.g., battery levels, connectivity information, and/or processor usage), application information, user information (e.g., user settings, preferences, usage history, and/or personal information), and/or other types of information (e.g., communications received from other computer systems, weather information obtained from a weather service, and/or geographic information obtained from a mapping service).

FIGS. 11B-11E illustrate examples of providing scanning outputs based on captured optical scan data representing field-of-view 712 and field-of-view 713 as illustrated in FIG. 11A while computer system 700 scans the physical environment in different scan modes. In particular, FIGS. 11B-11C illustrate examples of scanning outputs provided in one or more passive scan modes, FIG. 11D illustrates an example of scanning outputs provided in a general active scan mode, and FIG. 11E illustrates an example of scanning outputs provided in a specific active scan mode.

FIGS. 11B-11C illustrates computer system 700 scanning the physical environment in one or more passive scan modes. While a passive scan mode is enabled, computer system 700 captures, analyzes, and/or provides scan results based on the optical scan data representing field-of-view 712 and/or field-of-view 713 automatically, rather than in response to one or more inputs corresponding to an explicit user request to perform a scan, such as described with respect to FIGS. 7A-7B, 9A, 9G, and/or 9I.

Accordingly, while scanning the physical environment in a passive scan mode, computer system 700 does not display an active scanning user interface (e.g., scanning user interface 710), a scanning indicator (e.g., 710A), and/or scanning guidance (e.g., such as described with respect to FIGS. 9B-9K). For example, as illustrated in FIG. 11A, computer system 700 displays user interface 707, watch face user interface, while capturing the optical scan data representing field-of-view 712 and field-of-view 713. Additionally, while scanning the physical environment in the passive scan mode, computer system 700 does not display a representation of field-of-view 712 and/or field-of-view 713, such as a live- or near-live camera feed of image data captured using the optical sensors.

In some embodiments, the one or more passive scan modes include different passive scan modes in which computer system 700 automatically captures, analyzes, and/or provides scan results in accordance with detecting different sets of conditions. For example, as described further below with respect to FIGS. 11B-11C, the passive scan modes include an ambient passive scan mode, where scan results are provided in accordance with determining certain conditions (e.g., requirements) in the optical scan data, and/or a contextual passive scan mode, where computer system 700 captures, analyzes, and/or provides scan results based on the optical sensor data in accordance with determining certain conditions based on sensor data and/or contextual information other than the optical scan data. Additional examples of scanning and providing scan results in a passive scan mode are illustrated and described with respect to FIGS. 11F-11K. In some embodiments, computer system 700 can enable a respective passive scan mode at the same time as one or more other scan modes (e.g., an active scan mode and/or another passive scan mode).

As illustrated in FIG. 11B, while a passive scan mode is enabled, computer system 700 displays notification stack 1102 including notification outputs 1102A and 1102B generated in response to detecting, based on the optical scan data representing field-of-view 712 and field-of-view 712-1, feature 1100B and feature 1100D. In some embodiments, computer system 700 provides one or more non-visual outputs based on detecting feature 1100B and feature 1100D, such as tactile and/or audio outputs indicating that computer system 700 is providing a passive scan result. In some embodiments, while a passive scan mode is enabled, computer system 700 does not generate notification outputs based on feature 1100A and/or feature 1100C (e.g., even if computer system 700 identifies the features based on the optical scan data). As illustrated in FIGS. 11B-11C, while a passive scan mode is enabled, computer system 700 displays notification stack 1102 while maintaining displaying at least a portion of user interface 707 (e.g., or another non-scanning user interface) and without displaying a representation of field-of-view 712 and/or field-of-view 712-1, such as a live- or near-live camera feed of image data captured using the optical sensors.

As illustrated in the left panel of FIG. 11B, notification output 1102A is a suggestion based on feature 1100B, the paper receipt with the restaurant bill and tip line. Notification output 1102A includes the text “Calculate tip” and includes a calculator icon, indicating an action computer system 700 can perform based on feature 1100B. For example, in response to an input selecting notification output 1102A, computer system 700 displays a tip calculator user interface, populates the tip calculator user interface with the bill total identified from feature 1100B (e.g., $85.00), and/or displays one or more calculated tip suggestions for the bill total identified from feature 1100B (e.g., tip and/or total amounts calculated for a 10%, 18%, 20%, 25%, and/or 30% gratuity).

In some embodiments, while an ambient passive scan mode is enabled, computer system 700 provides notification output 1102A in accordance with detecting a restaurant bill based on the captured optical sensor data. In some embodiments, while a contextual passive scan mode is enabled, computer system 700 provides notification output 1102A in accordance with detecting, based on captured spatial information, that the current location of computer system 700 is a location of restaurant, café, and/or other food service establishment and in accordance with detecting, based on the captured optical sensor data, one or more features associated with paying a restaurant bill, such as feature 1100B and/or other objects, information, and/or visual characteristics indicating that the user is likely to be paying a bill at the detected location.

As illustrated in FIG. 11B, notification output 1102B is an alert based on feature 11001D, the nearly-empty glass of water. In response to one or more inputs navigating suggestion stack 1102, such as input 1104A (e.g., a swipe gesture directed up across suggestion stack 1102) and/or input 1104B (e.g., a rotation of crown 702B), computer system 700 displays notification output 1102B at the top of notification stack 1102, as illustrated in the right panel of FIG. 11B. Notification output 1102B includes the text “Hydration goal met” and includes a water glass icon, indicating that computer system 700 has proactively performed the action of logging the user's hydration (e.g., in a health, fitness, and/or hydration-tracking application) and informing the user that a hydration goal was met. In some embodiments, in response to detecting an input selecting notification output 1102B, computer system 700 provides additional information, such as displaying previously-logged hydration information. In some embodiments, while a contextual passive scan mode is enabled, computer system 700 provides notification output 1102B in accordance with detecting, via the one or more spatial information sensors, a movement of the user indicating that the user picked up a glass and took a drink, and in accordance with detecting, based on the optical sensor data corresponding to feature 1100D, that the drink was water.

In some embodiments, while in a passive scanning mode, computer system 700 delays providing one or more notification outputs (e.g., 1102A, 1102B, and/or 1102C) based on sensor data captured while scanning the physical environment. For example, at FIG. 11B, computer system 700 determines, based on the captured optical sensor data, audio sensor data, and/or other sensor data, that the user of computer system 700 is engaged in a conversation with another person at the restaurant. Accordingly, in response to receiving one or more incoming electronic communications (e.g., emails, text messages, and/or chats), computer system 700 refrains from providing a notification output corresponding to the incoming communications. As illustrated in FIG. 11C, once computer system 700 determines that the user of computer system 700 is no longer engaged in the conversation, computer system 700 displays notification output 1102C, which includes the text “3 new messages in Group Chat” (e.g., at the top of notification stack 1102).

FIG. 11D illustrates computer system 700 scanning the physical environment in a general active scan mode. The general active scan mode is enabled (e.g., initiated) in response to one or more inputs requesting scanning of the environment using the one or more optical sensors, such as the inputs described with respect to FIGS. 7A-7B (e.g., 708A, 708B, 708C, 708D, 708E, and/or 708F). In some embodiments, computer system 700 enables the general active scan mode in accordance with a determination that the one or more inputs requesting scanning of the environment using the one or more optical sensors do not specify a particular type of feature (e.g., by selecting a specific scan affordance, as described with respect to input 902B, and/or specifying a feature type in a spoken input, such as inputs 902A, 920, and/or 924). As illustrated in FIG. 11D, while scanning the physical environment in the general active scan mode, computer system 700 displays scanning user interface 710 including scanning indication 710A. For example, in response to the one or more inputs requesting scanning of the environment, computer system 700 ceases displaying user interface 707 (e.g., the watch face user interface) and/or another user interface displayed when the inputs are detected.

At FIG. 11D, while the general active scan mode is enabled, computer system 700 provides scanning outputs based on objects detected in field-of-view 712, as described above with respect to FIGS. 7A-7Q. In some embodiments, while the general active scan mode is enabled, computer system 700 only provides scanning outputs based on objects detected using one or more environment-facing optical sensors (e.g., 706A) (e.g., in field-of-view 712) and not based on objects detected using one or more user-facing optical sensors (e.g., 706B). For example, while the general active scan mode is enabled, computer system 700 provides scanning guidance for scanning the physical environment using the active optical sensor, such as scanning indicator 710A and/or the prompts described with respect to FIGS. 9A-9K.

In response to detecting, based on the optical sensor data representing field-of-view 712, feature 1100A, feature 1100B, and feature 1100C, computer system 700 displays corresponding symbolic representations 1106A (e.g., a QR code icon), 1106B (e.g., a calculator icon), and 1106C (e.g., a search icon) as illustrated in the right panel of FIG. 11D. Additionally, computer system 700 displays additional information related to the detected features, such as additional information 1108C, the text “Search similar flatware,” indicating an action computer system 700 can take based on feature 1100C (e.g., performing a visual search for flatware similar to the fork), the symbolic representation currently selected as active. In some embodiments, computer system 700 provides one or more non-visual outputs based on detecting feature 1100A, feature 1100B, and/or feature 1100C, such as tactile and/or audio outputs indicating detection of a new feature and/or an update to the displayed symbolic representations. As described with respect to FIGS. 7A-7Q, the user can interact with scanning user interface 710, symbolic representations 1106A-1106C, and/or additional information 1108C via inputs such as 1110A, 1110B, and/or 1110C to review the general active scan results, obtain additional information, and/or cause computer system 700 to take follow-up actions based on feature 1100A, feature 1100B, and/or feature 1100C.

FIG. 11E illustrates computer system 700 scanning the physical environment in a specific active scan mode. The specific active scan mode is enabled (e.g., initiated) in response to one or more inputs requesting scanning of the environment using the one or more optical sensors, such as the inputs described with respect to FIGS. 9A, 9G, and 9I (e.g., 902A-902E, 920, and/or 924), which specify a particular type of feature (e.g., by selecting a specific scan affordance, as described with respect to input 902B, and/or specifying a feature type in a spoken input, such as inputs 902A, 920, and/or 924). For example, the particular type of feature is a specific object type (e.g., requesting a scan for animals, birds, insects, plants, food, or landmarks), a specific information type (e.g., requesting a scan for a machine-readable code, such as a QR code or bar code, text, URLs, prices, phone numbers, addresses, or contact information), or a feature with specific characteristics (e.g., requesting scanning of an object the user is holding, information printed on a particular sign, or a QR code that encodes an application deep-link). As illustrated in FIG. 11E, while scanning the physical environment in the general active scan mode, computer system 700 displays scanning user interface 710 including scanning indication 710A. For example, in response to the one or more inputs requesting scanning of the environment, computer system 700 ceases displaying user interface 707 (e.g., the watch face user interface) and/or another user interface displayed when the inputs are detected.

At FIG. 11E, while the specific active scan mode is enabled, computer system 700 provides scanning guidance and scanning outputs based on objects of the requested type detected in field-of-view 712 and/or field-of-view 712-1, as described above with respect to FIGS. 9A-9K. In some embodiments, while the specific active scan mode is enabled, computer system 700 provides scanning outputs based on objects of the requested type detected in a field-of-view of the one or more optical sensors selected based on the requested type. For example, computer system 700 selects to scan field-of-view 712 (e.g., using one or more environment-facing optical sensors) and not field-of-view 712-1 (e.g., using one or more user-facing optical sensors) in response to a request to scan for QR codes but selects to scan field-of-view 712-1 in response to a request to scan an object the user is holding.

As illustrated in FIG. 11E, in response to detecting, based on the optical sensor data representing field-of-view 712, feature 1100A (e.g., the QR code printed on the receipt), computer system 700 displays corresponding symbolic representation 1106A (e.g., the QR code icon), without displaying symbolic representations corresponding to features 1100B-1100D, which are not features of the requested type. In some embodiments, as illustrated by the left panel of FIG. 11E, computer system 700 additionally displays environmental representation 914 (e.g., including a digitally-reconstructed representation of feature 1100A). As illustrated in the right panel of FIG. 11E, computer system 700 displays additional information related to the detected QR code feature, such as additional information 1108A, the text “Download restaurant app,” indicating an action computer system 700 can take based on feature 1100A (e.g., opening an application download link encoded by feature 1100A). In some embodiments, computer system 700 provides one or more non-visual outputs based on successfully detecting a feature of the requested type, such as tactile and/or audio outputs indicating detection of a new feature and/or an update to the displayed symbolic representations. As described with respect to FIGS. 7A-7Q, the user can interact with scanning user interface 710, symbolic representations 1106A, and/or additional information 1108A to review the specific active scan results, obtain additional information, and/or cause computer system 700 to take follow-up actions based on the specifically-detected feature.

Additional examples of scanning the physical environment in a passive scan mode are described below with respect to FIGS. 11F-11K. In particular, in the examples described with respect to FIGS. 11F-11K, computer system 700 captures, analyzes, and/or provides scan results based on the optical sensor data in accordance with detecting the occurrence of contextual events. For example, computer system 7000 detects the occurrence of contextual events using one or more spatial information sensors, such as one or more motion, orientation, and/or location sensors (e.g., accelerometers, gyroscopes, magnetometers, inertial measurement units (IMUs), and/or location sensors).

At FIG. 11F, computer system 700 detects, via the one or more spatial information sensors, that the current location of computer system 700 is a grocery store location (e.g., a location event). In response to detecting that the current location of computer system 700 is a grocery store location, computer system 700 captures and analyzes optical sensor data corresponding to field-of-view 712 of the physical environment in order to generate notification outputs (e.g., alerts) based on particular features detected within the physical environment at the grocery store location. For example, as illustrated in FIGS. 11F-11I, the one or more optical sensors capture optical sensor data corresponding to a user's shopping cart, which computer system 700 analyzes to visually identify grocery items obtained by the user and/or other environmental conditions, such as aisle names and/or items available on nearby shelves.

As illustrated in FIG. 11F, when computer system 700 detects, based on the optical sensor data, that the user has placed a bag of flour in the shopping cart (e.g., feature 1100E), computer system 700 performs the action of checking list item 1112A off in virtual grocery list 1112 (e.g., illustrated in FIG. 11G) and displays notification stack 1102 with notification output 1102D, alerting the user that the action was performed (e.g., displaying the text “Grocery List: flour” with a checkmark icon). Likewise, if computer system 700 detects that the user has placed potatoes in the shopping cart (e.g., feature 1100F), computer system 700 performs the action of checking list item 1112B off in virtual grocery list 1112 and displays a notification output alerting the user that the list item for potatoes has been checked off in virtual grocery list 1112. As illustrated in FIGS. 11F-11G, in response to detecting an input directed to notification output 1102D, computer system 700 displays virtual grocery list 1112, in which list items 1112A and 1112B are checked off.

In some embodiments, computer system 700 detects feature 1100E (e.g., the flour placed in the user's grocery cart) and/or feature 1100F (e.g., the potatoes placed in the user's grocery cart) based on virtual grocery list 1112. For example, the user creates virtual grocery list 1112 by providing the grocery list items to computer system 700, for instance, generating the list in a notes application, grocery application, recipe application, or meal-tracking application. Computer system 700 automatically analyzes virtual grocery list 1112 to “look for” (e.g., detect, using the one or more optical sensors) the grocery list items (e.g., flour, potatoes, and tuna cat treats) when the contextual event of being at the grocery store is detected. In some embodiments, computer system 700 analyzes other user information to automatically determine conditions for providing alerts when contextual events are detected. For example, computer system 700 uses one or more natural-language processing techniques to analyze text from messages, emails, notes, documents, and/or media items and determine specific information to look for in the physical environment when a given event occurs.

At FIG. 11H, in response to detecting that the current location of computer system 700 is a grocery store location, computer system 700 detects that the user has placed a bag of chicken cat treats in the shopping cart (e.g., feature 1100G). Based on feature 1100G and virtual grocery list 1112, computer system 700 determines that the user has obtained the wrong kind of cat treats. Accordingly, computer system 700 displays notification stack 1102 with notification output 1102E, which includes the text “Did you get tuna cat treats?” and an alert icon. As illustrated in FIG. 11H, in response to detecting feature 1100G, computer system 700 also provides non-visual output 1114A, a tactile output indicating an alert based on feature 1110G (e.g., a wrong-item alert). Accordingly, in response to detecting that the current location of computer system 700 is the grocery store location, computer system 700 generates different alerts (e.g., 1102D, 1102E, and/or 1114A) based on different event conditions determined using the optical sensor data.

The following description provides additional examples of conditions for generating alerts in response to detecting that the current location of computer system 700 is at a particular location (e.g., location events). In some embodiments, computer system 700 generates an alert that includes automatically displaying an option for calculating a tip (e.g., notification output 1102A for the tip calculator, as described with respect to FIG. 11B) based on a determination that the captured field-of-view of the physical environment (e.g., field-of-view 712 and/or field-of-view 712-1) includes features corresponding to a particular restaurant location (e.g., features 1100A-1100D). For example, in response to detecting location sensor information corresponding to a restaurant location, computer system 700 surfaces the tip calculator to the user when the optical sensor data indicates that the user is sitting at a table in the restaurant dining room.

In some embodiments, computer system 700 generates an alert that includes automatically activating an airplane mode (e.g., a mode in which communication via one or more communication networks, such as a cellular network and/or a Wi-Fi network, is temporarily disabled) based on a determination that the captured field-of-view of the physical environment includes features corresponding to the interior of an airplane cabin. For example, in response to detecting location sensor information corresponding to an airport location, computer system 700 activates the airplane mode and/or provides one or more notification outputs (e.g., visual, audio, and/or tactile notifications) when the optical sensor data includes features such as airplane seats, windows, aisles, baggage compartments, and/or flight attendants that allow computer system 700 to visually identify that the user is in an airplane cabin.

In some embodiments, computer system 700 generates an alert that includes automatically activating a theater mode (e.g., a mode in which computer system 700 temporarily delays and/or suppresses providing certain types of outputs, such as audio, display, and/or tactile notification outputs) based on a determination that the captured field-of-view of the physical environment includes features corresponding to an auditorium. For example, in response to detecting location sensor information corresponding to a theater, performance venue, and/or school, computer system 700 activates the airplane mode and/or provides one or more notification outputs (e.g., visual, audio, and/or tactile notifications) when the optical sensor data includes features such as theater seating, a stage, a movie screen, a podium, and/or an audience that allow computer system 700 to visually identify that the user is in an auditorium.

In some embodiments, computer system 700 generates an alert that includes displaying controls (e.g., a control user interface) for a set of one or more smart home devices associated with a particular room within the particular location based on a determination that the captured field-of-view of the physical environment includes features corresponding to the particular room. For example, in response to detecting that the user is at home, computer system 700 displays controls for a television, thermostat, and sound system associated with the user's living room based on visually identifying the living room's furniture and décor, and displays controls for a kitchen fan, oven, and thermostat associated with the user's kitchen based on visually identifying the kitchen's appliances.

In some embodiments, computer system 700 generates an alert that includes displaying controls (e.g., a control user interface) for a particular smart home device associated with the particular location based on a determination that the captured field-of-view of the physical environment includes features corresponding to the particular smart home device. For example, in response to detecting that the user is at home, computer system 700 displays controls for specific devices visually identified within the field-of-view of the one or more optical sensors (e.g., indicating that the computer system 700 is physically close to the specific devices).

At FIG. 11I, computer system 700 detects, via the one or more spatial information sensors, that computer system 700 is departing a particular location (e.g., a departure event). For example, computer system 700 determines, based on motion sensor data, that the user is departing the location at which the user placed the chicken cat treats in the grocery cart, a pet supply aisle in the grocery store (e.g., visually identified from field-of-view 712 as illustrated in FIG. 11H). In response to detecting that computer system 700 is departing the pet supply aisle, computer system 700 displays alert output 1116, an alert with the text “Grocery List: Did you get tuna cat treats?” and an alert icon, based on determining that the user's grocery cart still includes the chicken cat treats (e.g., feature 1100G) and/or still does not include any tuna cat treats. In response to detecting that computer system 700 is departing the pet supply aisle, computer system 700 additionally provides tactile alert output 1118A and/or audio alert output 1118B based determining that the user's grocery cart does not include any tuna cat treats and that the user is at the grocery store checkout (e.g., feature 1100H). Accordingly, in response to detecting a departure from the pet supply aisle of the grocery store, computer system 700 generates different alerts (e.g., 1116, 1118A, and/or 1118B) based on different event conditions determined using the optical sensor data.

At FIGS. 11J-11K, computer system 700 detects, via the one or more spatial information sensors, spatial information corresponding to movement of a user of computer system 700 (e.g., a motion event). At FIG. 11J, computer system 700 detects, based on motion and/or location sensor data, that computer system 700 has started moving in a particular way in the physical environment. In some embodiments, computer system 700 detects that the initiated movement has particular movement characteristics and/or indicates a particular type of movement. For example, computer system 700 detects that computer system 700 has started moving with over a threshold speed (e.g., over 1, 2, 3, 5, or 10 miles per hour) and/or in a manner that indicates that the user is engaging in a physical activity (e.g., pedaling).

In response to detecting the initiated movement, computer system 700 determines that the optical sensor data includes features corresponding to the user riding a bicycle outside, such as detecting the text “Bike Lane” painted on a road in field-of-view 712 and/or detecting light levels corresponding to outdoor sunlight. Accordingly, computer system 700 performs the action of initiating tracking of a biking workout and displays user interface 1120, a workout-tracking user interface for an outdoor biking workout indicated by bicycle icon 1120A, alerting the user to the initiated workout. In response to detecting the movement, computer system 700 additionally displays notification output 1102F with the text “Warning: High UV” and a sun icon based on the optical sensor data (e.g., detecting light levels corresponding to bright sunlight) and/or information obtained from an external sensor, such as information about a current UV intensity rating obtained from a weather service.

At FIG. 11K, computer system 700 detects, based on motion and/or location sensor data, that computer system 700 has stopped moving in a particular way in the physical environment. For example, computer system 700 detects that the user of computer system 700 has abruptly decelerated, indicating that the user has potentially crashed and/or fallen. In response to detecting the abrupt cessation of movement, computer system 700 determines that the features of field-of-view 712 indicate the user is lying down on the ground outside in the grass. Accordingly, computer system 700 displays alert user interface 1122, including text 1122A (e.g., “It looks like you've taken a hard fall”), option affordance 1122B for initiating a call to emergency services (e.g., including the text “Emergency call” and a “SOS” icon), and option affordance 1122C for dismissing alert user interface 1122 (e.g., including the text “I'm OK”).

In some embodiments, in response to detecting a particular movement (e.g., an initiated, ongoing, and/or ceased movement), computer system 700 provides different alerts in accordance with detecting, based on captured optical sensor data (e.g., and/or other sensor data and/or contextual information), different conditions than those described with respect to FIGS. 11J-11K. For example, based on detecting features from the optical sensor data that correspond to different types of workouts (e.g., lifting free weights, running on a treadmill, swimming, playing basketball, riding a bicycle outside, and/or riding a stationary bicycle), computer system 700 initiates workout tracking for the detected workout type and displays a corresponding workout tracking user interface. For example, based on detecting features from the optical sensor data that correspond to getting off a bicycle, getting out of a pool, moving away from workout equipment, sitting or lying down to stretch, and/or leaving a gym, computer system 700 ceases workout tracking (e.g., for an ongoing workout) and/or displays an alert such as a completed workout summary. For example, based on detecting features from the optical sensor data that indicate that a detected movement (e.g., or cessation of movement) was unintentional, that the user is injured/incapacitated, and/or that the user is in danger, computer system 700 displays an alert, provides options for performing one or more emergency/safety actions, and/or automatically performs one or more emergency/safety actions.

FIG. 11L illustrates example configurations of optical sensors used to scan the physical environment within a device of computer system 700, such as optical sensors 706A and/or 706B housed within wrist-worn device 700A. Axes 1130 represent a frame of reference defined with respect to the hardware (e.g., device housing) of computer system 700. In wrist-worn device 700A, display 704 faces up along axis 1130A (e.g., the vertical axis of axes 1130), optical sensor 706A points in a positive direction along axis 1130B (e.g., the horizontal axis), and optical sensor 706B points in a negative direction along axis 1130B. For example, optical sensor 706A captures field-of-view 1132A and optical sensor 706B captures field-of-view 1132B. In some embodiments, the optical sensors are oriented to point within a threshold range (e.g., within 3°, 10°, 15°, 30°, 45°, or 60°) of axis 1130B (e.g., or, put differently, within a threshold range of perpendicular to the direction of display 704). For example, optical sensor 706A is oriented to capture field-of-view 1132B, a field-of-view that points slightly upwards towards display 704 and, when wrist-worn device 700A is worn on a wrist of a user, away from the wrist. As another example, optical sensor 706A is oriented to capture field-of-view 1132C, a field-of-view that points slightly downwards, away from display 704.

In some embodiments, computer system 700 includes one or more spatial information sensors, such as one or more orientation sensors (e.g., gyroscopes, magnetometers, and/or IMUs) that measure the orientation of axes 1130 (e.g., the frame of reference of the hardware of computer system 700) with respect to the physical environment. Accordingly, while scanning the physical environment using optical sensors 706A and/or 706B, the orientation sensors provide spatial information indicating the portion of the physical environment captured in field(s)-of-view 1132A, 1132B, 1132C, and/or 1132D. For example, computer system 700 detects input 708B, the wrist-raise gesture corresponding to a request to initiate active scanning described with respect to FIG. 7A, based on detected spatial information indicating that the field-of-view of optical sensor 706 (e.g., field-of-view 1132A, 1132B, and/or 1132C) has been rotated to point within a threshold range of perpendicular to the direction of gravity's pull (e.g., pointing towards a horizon of the physical environment in a “scanning position”) For example, computer system 700 detects input 722A, the wrist-rotation gesture corresponding to a request to review displayed scan results described with respect to FIG. 7F, based on detected spatial information indicating that the field-of-view of optical sensor 706A (e.g., field-of-view 1132A, 1132B, and/or 1132C) has been rotated to point within a threshold range of opposite to the direction of gravity's pull (e.g., rotating display 704 towards the user's face in a “reviewing position”). For example, computer system 700 provides scanning guidance to change the orientation of optical sensor 706A, such as displayed scanning prompts 906B, 906C, 906F, and/or 906G and/or changes to the intensity of visual, tactile, and/or audio prompt outputs as described with respect to FIGS. 9C-9F, based on the detected orientation of axes 1130 with respect to the physical environment and/or a target orientation range, wherein field-of-view 1132A, 1132B, and/or 1132C include optical sensor data corresponding to a particular scannable feature.

The following description provides additional examples of conditions for generating alerts in response to detecting spatial information corresponding to particular movements (e.g., motion events). In some embodiments, computer system 700 generates an alert that includes automatically displaying an option for calculating a tip (e.g., notification output 1102A for the tip calculator, as described with respect to FIG. 11B) based on a determination that the captured field-of-view of the physical environment (e.g., field-of-view 712 and/or field-of-view 712-1) includes features corresponding to a particular restaurant location (e.g., features 1100A-1100D). For example, in response to detecting location sensor information corresponding to a restaurant location, computer system 700 surfaces the tip calculator to the user when the optical sensor data indicates that the user is sitting at a table in the restaurant dining room.

Additional descriptions regarding FIGS. 11A-11L are provided below in reference to method 1200 described with respect to FIG. 12 and/or method 1300 described with respect to FIG. 13.

FIG. 12 is a flow diagram of an exemplary method 1200 for providing feedback while scanning a physical environment in different scanning modes, in some embodiments. In some embodiments, method 1200 is performed at a computer system (e.g., computer system 101 in FIG. 1A and/or computer system 700) that is in communication with one or more output devices (e.g., display generation components (e.g., a display controller; a touch-sensitive display system; a display (e.g., 704) (e.g., integrated and/or connected), a 3D display, a transparent display, a projector, and/or a heads-up display), audio generation components (e.g., an audio controller, one or more speakers, and/or other integrated and/or connected audio output devices), and/or tactile output generation components (e.g., haptic generators)) and one or more sensors, wherein the one or more sensors includes one or more optical sensors (e.g., 6-106, 6-108, 6-114, 6-118, 6-118, 706A, 706B, and/or 706C) (e.g., imaging sensors (e.g., visible light and/or IR cameras), depth sensors (e.g., structural light sensors, time-of-flight sensors (e.g., LIDAR), and/or stereoscopic camera sensors), and/or light sensors) (in some embodiments, the one or more sensors include one or more motion and/or orientation sensors (e.g., accelerometers, gyroscopes, magnetometers, inertial measurement units (IMUs), and/or location sensors) and/or other sensors (e.g., capacitive sensors, intensity sensors, motion sensors, vibration sensors, audio sensors, temperature sensors, and/or biometric sensors)). In some embodiments, the computer system includes a wrist-worn device (e.g., 700A). In some embodiments, the optical sensors are housed within the same device as at least one display (e.g., the computer system includes a wrist-worn device that houses both a display and the one or more optical sensors). In some embodiments, the optical sensors point in a direction that is within a threshold range (e.g., within 10°, 30°, 45°, or 60°) of perpendicular to a plane of a display (e.g., as illustrated in FIG. 11L) (e.g., the optical sensors point in one or more directions that are within a threshold range of parallel to the surface of the display). In some embodiments, the motion and/or orientation sensors measure the movement and/or orientation of the optical sensors (e.g., the IMU and optical sensors operate within the same inertial frame of reference). In some embodiments, the computer system is optionally in communication with one or more input devices, such as touch-sensitive surfaces (e.g., of display 704), hardware input devices (e.g., 702A and/or 702B) (e.g., hardware buttons, switches, keys, and/or dials), microphones, gesture input devices, air gesture input devices, and/or gaze input devices. In some embodiments, method 1200 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1200 are, optionally, combined and/or the order of some operations is, optionally, changed.

The computer system scans 1202, via the one or more sensors, a physical environment, wherein scanning the physical environment includes capturing (1204), via the one or more optical sensors, optical scan data representing a field-of-view of the one or more optical sensors (e.g., 712) while the field-of-view of the one or more optical sensors moves (e.g., changes position and/or orientation) with respect to the physical environment (e.g., as illustrated in FIGS. 7A-7Q, 9A-9K, and/or 11A-11L). In some embodiments, scanning the physical environment includes capturing other types of scan data (e.g., using the other sensors). For example, scanning the physical environment optionally includes capturing, using one or more motion and/or orientation sensors, movement data, such as movement data corresponding to the movement of the computer system and/or the field-of-view of the one or more optical sensors with respect to the physical environment. While scanning (1202) the physical environment, the computer system provides (1206), via the one or more output devices, scanning feedback (e.g., 710A, 714A-714D, 716A-716D, 720A-720B, 748A-748B, 906A-906H, 912A-912C, 914, 918A-918C, 922A-922C, 926A-926C, 1102A-1102F, 1106A-1106C, 1114A, 1118A-1118B, 1116, 1120, and/or 1122A-1122C) indicating information about the physical environment. In some embodiments, providing the scanning feedback includes providing one or more display outputs, audio outputs, and/or tactile outputs. In some embodiments, providing the scanning feedback includes providing symbolic representations of detected content (e.g., FIGS. 7A-8), outputting a prompt for improving the scan (e.g., FIGS. 9A-10), and/or generating an alert (e.g., FIG. 13).

Providing (1206) the scanning feedback includes, in accordance with a determination that a first scan mode (e.g., a mode for scanning for a particular type of content, an active (e.g., user-prompted and/or user-directed) scanning mode, and/or a passive (e.g., automatic and/or background) scanning mode) is active (e.g., enabled), initiating (1208) a first process for providing, via the one or more output devices, first scanning feedback of a first feedback type and, in accordance with a determination that a second scan mode is active, wherein the second scan mode is different from the first scan mode, initiating (1210) a second process for providing, via the one or more output devices, second scanning feedback of a second feedback type that is different from the first feedback type. In some embodiments, in accordance with a determination that neither the first scan mode nor the second scan mode is active (e.g., if a third scan mode is active), the computer system foregoes initiating the first process and the second process and, in some embodiments, initiates a third process for providing third scanning feedback of a third feedback type that is different from the first and second feedback types. Scanning a physical environment with optical sensors as the field-of-view of the optical sensors moves around the environment and providing different types of scanning feedback (e.g., information about the physical environment detected while scanning) based on the currently-active scan mode provides improved control of computer system functionality without cluttering the user interface with additional displayed controls and provides improved feedback to the user, which reduces the power usage and improves the battery life of the computer system by enabling the user to use the device more quickly and efficiently. For example, by providing different types of scanning feedback depending on the scan mode, the computer system tailors the feedback to the current context, which reduces the display and/or output of scanning feedback that is unlikely to be desirable and/or relevant to the user without requiring the display of numerous controls for configuring scanning and scan feedback. Providing different types of scanning feedback based on the currently-active scan mode also assists the user with interacting with the physical environment via the computer system (e.g., using optical scan data) and reduces the risk that transient visual context is missed, which reduces the number of inputs needed to perform an operation (e.g., inputs to manually input context information about the physical environment and/or manually request feedback) and thus reduces the power usage and improves the battery life of the computer system by enabling the user to use the device more quickly and efficiently. For example, the different scan modes provide the user with flexible and varied options for frictionlessly interacting with the physical environment using the optical sensors, improving the user experience with the computer system.

In some embodiments, scanning the physical environment includes capturing, via one or more spatial information sensors (e.g., accelerometers, motion sensors, gyroscopes, magnetometers, inertial measurement units (IMUs), and/or location sensors) of the one or more sensors, spatial scan data (e.g., movement, orientation, and/or location data) corresponding to the field-of-view of the one or more optical sensors while the field-of-view of the one or more optical sensors (e.g., 712) moves with respect to the physical environment (e.g., as illustrated in FIGS. 7D-7E, 9A-9K, 11A, 11F, and/or 11I-11K). For example, the motion scan data captures how the one or more optical sensors move while capturing the optical scan data. Scanning the physical environment by capturing both optical sensor information and spatial sensor information assists the user with interacting with the physical environment via the computer system. For example, the computer system uses the optical sensor information and spatial sensor information in tandem to determine more detailed and/or accurate information about the physical environment, such as contextualizing the captured optical sensor data within the three-dimensional space of the physical environment and/or supplementing the visual information with information about the user and/or computer system's movements.

In some embodiments, the first process for providing the first scanning feedback of the first feedback type includes providing a suggestion output (e.g., 1002A-1102F, 1116, 1120, and/or 1122A-1122C) (e.g., a displayed and/or spoken output including a suggestion based on context information determined from the optical and/or spatial scan data). In some embodiments, providing the suggestion output is performed in accordance with a determination that a set of one or more suggestion criteria is satisfied based on one or more features of the physical environment identified from the optical scan data (e.g., and/or based on the spatial scan data). In some embodiments, the suggestion output includes one or more displayed, audio, and/or tactile outputs. In some embodiments, the first scan mode is a passive scan mode (e.g., the computer system initiates scanning the physical environment without receiving an explicit user input requesting to perform a scan the environment). For example, the suggestion output is provided without displaying a scanning user interface (e.g., the first scan mode is performed as a background process, and the suggestion output is provided to surface scan results when relevant to the user). In some embodiments, the suggestion is a contextual alert provided, for instance, as described with respect to FIG. 13. For example, the suggestion criteria are satisfied when a movement and/or location event is detected along with the one or more features of the physical environment (e.g., visual information confirming and/or refining the computer system's detection of the event). As another example, the suggestion criteria are satisfied when the optical scan data, spatial scan data, and/or other sensor data indicate the presence of certain conditions along with the detected one or more features of the physical environment.

In some embodiments, the second process for providing the second scanning feedback of the second feedback type includes providing a prompt (e.g., a displayed, audio, and/or tactile prompt) to change a position of the one or more optical sensors in the physical environment based on a detected position of one or more features of the physical environment (e.g., 710A, 906A-906H, 922A-922C, and/or 926A-926C) (e.g., as described with respect to FIGS. 9A-10; in some embodiments, the prompt is different from the suggestion output). In some embodiments, providing the prompt to change the position is performed in accordance with a determination that a set of one or more prompt criteria is satisfied based on the one or more features of the physical environment identified from the optical scan data (e.g., if the one or more features include a respective type of feature, as described with respect to FIGS. 9A-10), wherein the set of one or more prompt criteria is different from the set of one or more suggestion criteria. In some embodiments, the second scan mode is an active scan mode. For example, the computer system initiates scanning the physical environment and providing the prompt in response to detecting a user input requesting scanning of the physical environment and/or of a particular type of feature in the physical environment. In some embodiments, the determination that the set of prompt criteria is satisfied and/or the prompt to change the position of the one or more optical sensors are based on the spatial scan data captured along with the optical scan data. Conditionally providing suggestion feedback in a first scan mode and conditionally providing scanning guidance feedback in a second scan mode performs an operation when a set of conditions has been met without requiring further user input, reduces the number of inputs needed to perform an operation, and assists the user with interacting with the physical environment via the computer system. For example, when scanning in the first mode, the computer system automatically surfaces relevant suggestions without requiring the user to provide additional inputs to seek contextually-relevant information, and when scanning in the second mode, the computer system automatically provides scanning guidance to assist the user with capturing the physical environment using the optical sensors without requiring the user to provide additional inputs requesting assistance.

In some embodiments, scanning the physical environment while the first scan mode is active includes determining (e.g., using optical processing and/or machine vision techniques) whether one or more objects of a first object type (e.g., a particular type of object/feature in the physical environment, such as a machine-readable code (e.g., a QR code), text, contact information, and/or another specific type of object) (e.g., 712B, 900A, and/or 1100A) are included in a portion of the physical environment represented by the optical scan data (e.g., as illustrated in FIG. 11E) (in some embodiments, without detecting whether one or more objects of a second object type, different from the first object type, are included in the portion of the physical environment represented by the optical scan data). In some embodiments, the first scan mode is an active scan for the first object type (e.g., a specific active scan), such as a scan performed in response to a specific user request to scan for the first object type and while displaying a scan user interface (e.g., as described with respect to FIGS. 7A-10). In some embodiments, scanning the physical environment while the second scan mode is active includes, determining whether one or more objects of one or more respective object types included in a plurality of object types (e.g., a set of object types recognized by the computer system; in some embodiments, the plurality of object types includes the first object type and the second object type) (e.g., 712A, 712C, 712D, 900B, 900C, 1100B, and/or 1100C) are included in the portion of the physical environment represented by the optical scan data (e.g., as illustrated in FIG. 11D). In some embodiments, the second scan mode is an active scan for any recognized objects (e.g., a general active scan), such as a scan performed in response to a specific user request to scan the physical environment and while displaying a scan user interface (e.g., as described with respect to FIGS. 7A-10). Conditionally analyzing the optical scan data to detect a specific type of object in a first scan mode and conditionally analyzing the optical scan data to detect various types of objects in a second scan mode reduces the power usage and improves the battery life of the computer system by tailoring the analysis of optical scan data to the current context, for instance, expending less time and power on analysis when the scan is a targeted scan but providing a wider range of scan functionality when the scan is a general scan.

In some embodiments, the first process for providing the first scanning feedback of the first feedback type includes, in accordance with a determination that one or more objects of the first object type are included in the portion of the physical environment represented by the optical scan data (e.g., if the computer system detects and/or scans an object/feature of the specified type), providing the first scanning feedback of the first type (e.g., as illustrated in FIG. 11E). In some embodiments, providing the first scanning feedback of the first type includes displaying one or more symbolic representations corresponding to the one or more objects of the first object type (e.g., as described with respect to FIGS. 7A-8), displaying additional information corresponding to one or more of the objects of the first object type (e.g., as described with respect to FIGS. 7A-8), and/or providing a prompt to reposition the one or more optical sensors with respect to the one or more objects of the first object type (e.g., as described with respect to FIGS. 9A-10). In some embodiments, the second process for providing the second scanning feedback of the second feedback type includes, in accordance with a determination that one or more objects of one or more respective object types included in the plurality of object types (e.g., a set of object types recognized by the computer system; in some embodiments, the plurality of object types includes the first object type) are detected in the portion of the physical environment represented by the optical scan data (e.g., if the computer system detects and/or scans any recognizable object/feature in the environment), providing the second scanning feedback of the second type (e.g., as illustrated in FIG. 11D). In some embodiments, providing the second scanning feedback of the second type includes displaying one or more symbolic representations corresponding to the one or more detected objects (e.g., as described with respect to FIGS. 7A-8), displaying additional information corresponding to one or more of the detected objects (e.g., as described with respect to FIGS. 7A-8), and/or providing a prompt to reposition the one or more optical sensors with respect to the one or more detected objects (e.g., as described with respect to FIGS. 9A-10). Conditionally providing scan feedback when a specific type of object is detected in a first scan mode and conditionally providing scan feedback when various types of objects (e.g., generally recognizable objects) are detected in a second scan mode performs an operation when a set of conditions has been met without requiring further user input, reduces the number of inputs needed to perform an operation, and assists the user with interacting with the physical environment via the computer system. For example, when scanning in the first mode, the computer system automatically limits (e.g., targets) feedback to specific features, reducing the number of inputs needed to scan and review information about the specific features, and when scanning in the second mode, the computer system surfaces feedback about a variety of features, reducing the number of inputs needed to find and review a variety of information and functionality using the computer system.

In some embodiments, the computer system detects, via one or more input devices in communication with the computer system (e.g., touch-sensitive surfaces, hardware input devices (e.g., hardware buttons, switches, keys, and/or dials), microphones, gesture input devices, air gesture input devices, and/or gaze input devices), a user input (e.g., one or more touch inputs, air gestures, spoken inputs, hardware inputs, and/or other types of input) corresponding to a request to scan the physical environment (e.g., 708A-708F, 902A-902E, 920, and/or 924) (e.g., as described with respect to FIGS. 7A-7B and/or 9A-9I). In some embodiments, in response to detecting the user input corresponding to the request to scan the physical environment, the computer system: initiates scanning the physical environment; in accordance with a determination that the user input corresponding to the request to scan the physical environment includes a request to scan for the first object type (e.g., a specific object type, such as the first object type), activates the first scan mode (e.g., as described with respect to FIGS. 9A-9K and/or 11E); and, in accordance with a determination that the user input corresponding to the request to scan the physical environment does not include a request to scan for a respective object type of the plurality of object types (e.g., any specific object type), activates the second scan mode (e.g., as described with respect to FIGS. 7A-7C and/or 11D). In some embodiments, the first scan mode includes providing the first type of scanning feedback if one or more objects of the first object type are included in the portion of the physical environment represented by the optical scan data (e.g., the first scan mode is a scan for the first object type). In some embodiments, the second scan mode includes providing the second type of scanning feedback if one or more objects of a respective plurality of object types are included in the portion of the physical environment represented by the optical scan data (e.g., the second scan mode is a general scan). In some embodiments, in accordance with a determination that the user input includes a request to scan for a different object type of the plurality of object types, the computer system activates a specific active scan mode for the different object type and initiates a process for providing a different type of feedback if the different object type is detected. Conditionally initiating scanning in different scan modes based on whether or not the request to initiate scanning includes an indication of a particular type of object performs an operation when a set of conditions has been met without requiring further user input and provides improved control of computer system functionality without cluttering the user interface with additional displayed controls. For example, rather than displaying additional controls and/or requiring explicit user inputs to select between scan modes, the computer system automatically selects the scan mode based on how specific a request to scan is.

In some embodiments, the request to scan for the first object type includes a respective speech input (e.g., detected via one or more audio input devices/sensors) indicating the first object type (e.g., 902A, 920, and/or 924). Conditionally initiating scanning in different scan modes based on whether or not a spoken request to initiate scanning indicates a particular type of object performs an operation when a set of conditions has been met without requiring further user input and provides improved control of computer system functionality without cluttering the user interface with additional displayed controls. For example, rather than displaying additional controls and/or requiring additional explicit user inputs to select between scan modes, the computer system allows the user to initiate different types of scanning using intuitive natural-language inputs by automatically selecting the scan mode based on whether the natural-language inputs specify particular scan targets.

In some embodiments, determining whether the one or more objects of the first object type are included in the portion of the physical environment represented by the optical scan data includes determining whether a first type of machine-readable code (e.g., a QR code, URL (e.g., URL text), phone number, address, and/or machine-recognizable symbol) is included in the physical environment (e.g., as illustrated in FIGS. 9A-9G and/or 11E) (e.g., the first scan mode is an active scan for a particular type of information from the physical environment). Conditionally analyzing the optical scan data to detect a machine-readable code in a first scan mode reduces the power usage and improves the battery life of the computer system by tailoring the analysis of optical scan data to the current context. For example, by providing users with an option for a scan mode that only “looks for” QR codes and/or other machine-readable codes/information, the computer system reduces the amount of time and power expended on analysis of the optical scan data.

In some embodiments, determining whether the one or more objects of the first object type are included in the portion of the physical environment represented by the optical scan data includes determining whether a user is holding one or more objects in the portion of the physical environment represented by the optical scan data (e.g., as described with respect to FIG. 11E) (e.g., the first scan mode is an active scan specifically for objects held by the user). Conditionally analyzing the optical scan data to detect an object held by a user in a first scan mode reduces the power usage and improves the battery life of the computer system by tailoring the analysis of optical scan data to the current context. For example, by providing users with an option for a scan mode that only analyzes held objects (e.g., objects detected within a particular portion of the field-of-view of the optical sensors), the computer system reduces the amount of time and power expended on analysis of the optical scan data.

In some embodiments, the first process for providing the first scanning feedback of the first feedback type includes, in accordance with a determination that a set of one or more suggestion criteria is satisfied based on one or more features of the physical environment identified from the optical scan data (e.g., and/or based on the spatial scan data), providing a suggestion output (e.g., 1002A-1102F, 1116, 1120, and/or 1122A-1122C) (e.g., a displayed and/or spoken output including a suggestion based on context information determined from the optical scan data). In some embodiments, the suggestion output includes one or more displayed, audio, and/or tactile outputs. In some embodiments, the first scan mode is a passive scan mode (e.g., the computer system initiates scanning the physical environment without receiving an explicit user input requesting to perform a scan the environment). For example, the suggestion output is provided without displaying a scanning user interface (e.g., the first scan mode is performed as a background process, and the suggestion output is provided to surface scan results when relevant to the user). In some embodiments, the suggestion is a contextual alert provided, for instance, as described with respect to FIG. 13. For example, the suggestion criteria are satisfied when a movement and/or location event is detected along with the one or more features of the physical environment (e.g., visual information confirming and/or refining the computer system's detection of the event). As another example, the suggestion criteria are satisfied when the optical scan data, spatial scan data, and/or other sensor data indicate the presence of certain conditions along with the detected one or more features of the physical environment. In some embodiments, the second process for providing the second scanning feedback of the second feedback type includes, in accordance with a determination that a set of one or more detection criteria is satisfied, wherein the set of one or more detection criteria includes a requirement that a respective criterion is satisfied in order for the set of one or more detection criteria to be satisfied, wherein the respective criterion is satisfied when one or more objects of one or more respective object types are detected in the portion of the physical environment represented by the optical scan data (e.g., if the computer system recognizes one or more objects in the physical environment, as described with respect to FIGS. 7A-8), displaying (e.g., via one or more display generation components of the one or more output devices) one or more symbolic representations corresponding to the one or more objects of the one or respective object types (e.g., 714A-714B, 912A-912C, and/or 1106A-1106C) (e.g., as described with respect to FIGS. 7A-8). In some embodiments, the second scan mode is an active scan mode. For example, the computer system initiates scanning the physical environment and providing the symbolic representations in response to detecting a user input requesting scanning of the physical environment and/or of a particular type of feature in the physical environment. Conditionally providing suggestion feedback in a first scan mode and conditionally providing symbolic representations of detected objects in a second scan mode reduces the number of inputs needed to perform an operation and assists the user with interacting with the physical environment via the computer system. For example, the computer system reduces the time and number of inputs needed for users to access contextually-relevant information (e.g., suggestions and/or symbolic representations of detected objects) by automatically providing suggestions in the first mode (e.g., without the user needing to explicitly request a scan) and by allowing users to intuitively interact with different objects in the physical environment in the second mode (e.g., without the user needing to provide additional inputs manually specifying context and/or manually seeking out related information and/or functionality).

In some embodiments, the set of one or more suggestion criteria is further satisfied based on location data captured via the one or more sensors (e.g., as described with respect to FIGS. 11B-11C and/or 11F-11K) (e.g., GPS data, network data, and/or motion data). For example, the computer system uses both location data and optical sensor data to determine a user's location (e.g., determining that the user is in a particular room at home, sitting at a table in a restaurant, boarding a plane at an airport, and/or walking through a particular aisle in a grocery store) and provide location-based suggestions (e.g., reminders, alerts, notifications, and/or user interfaces relevant to the context of the user's location, e.g., as described with respect to FIG. 13). Automatically providing suggestion feedback based on location information and features detected in the physical environment using the optical sensors reduces the number of inputs needed to perform an operation, provides improved feedback to the user, and assists the user with interacting with the physical environment via the computer system. For example, using both optical and location data to refine the provided suggestions provides users with efficient access to currently-relevant information and/or functionality.

In some embodiments, the set of one or more suggestion criteria includes a requirement that a second respective criterion is satisfied in order for the set of one or more suggestion criteria to be satisfied, wherein the second respective criterion is satisfied when the one or more features of the physical environment identified from the optical scan data correspond to a respective user activity (e.g., as described with respect to FIGS. 11B-11C and/or 11F-11K) (e.g., if the visual context of the physical environment indicates a likely past, present, and/or future activity performed by the user, such as working out, eating a meal, watching television, and/or commuting to work). For example, the computer system uses the optical sensor data to identify candidate user activities and provide activity-based suggestions, such as reminders, alerts, notifications, and/or user interfaces relevant to the activities the user has done, is doing, or could do in the current environmental context (e.g., as described with respect to FIG. 13). In some embodiments, the respective user activity is determined based on spatial sensor data (e.g., the computer system uses both motion and/or location data and optical sensor data to determine the user's current activity). Automatically providing suggestion feedback based on a user activity determined based on features detected in the physical environment using the optical sensors reduces the number of inputs needed to perform an operation, provides improved feedback to the user, and assists the user with interacting with the physical environment via the computer system. For example, identifying a user activity to refine the provided suggestions provides users with efficient access to currently-relevant information and/or functionality.

In some embodiments, the first process for providing the first scanning feedback of the first feedback type includes, in accordance with a determination that a first set of suggestion criteria is satisfied, providing a first suggestion output, wherein the first set of suggestion criteria is based on a current context computer system that is detected in response to an occurrence of a triggering condition being detected (e.g., as described with respect to FIGS. 11B-11C and/or 11F-11K). In some embodiments, the first set of suggestion criteria includes a trigger criterion that is satisfied based on a portion of scan data captured via the one or more sensors (e.g., one or more sensors other than the one or more optical sensors) that does not include the optical scan data (e.g., the trigger criterion is satisfied when the non-visual sensors detect a particular triggering event and/or condition), and a first context criterion that is satisfied based on the optical scan data (e.g., the first context criterion is satisfied when the optical sensors detect particular visual context information). For example, the first scan mode is a passive scanning mode that provides contextual suggestions (e.g., suggestions based on the current context of the physical environment) if certain triggering events or conditions are detected, such as providing a suggestion to track a workout activity detected using the optical sensors if the computer system detects that the user has started to move and/or increase their heart rate. In some embodiments, in accordance with a determination that the trigger criterion is satisfied, the computer system provides a suggestion output if at least one context criterion is satisfied based on the optical scan data, and provides different suggestion outputs based on whether the satisfied context criterion is the first context criterion and/or a different context criterion (e.g., as further described with respect to FIG. 13). In some embodiments, the second process for providing the second scanning feedback of the second feedback type includes, in accordance with a determination that a second set of suggestion criteria is satisfied, providing a second suggestion output, wherein the second set of suggestion criteria includes a requirement that a second context criterion is satisfied, based on the optical scan data (e.g., the second context criterion is satisfied when the optical sensors detect particular visual context information), in order for the second set of suggestion criteria to be satisfied, wherein the occurrence of the triggering condition being detected is not a requirement of the second set of suggestion criteria (e.g., as described with respect to FIG. 11B) (e.g., the second context criterion is satisfied when the optical sensors detect visual context information whether or not the trigger condition is satisfied based on the other sensor data). For example, the second scan mode is an ambient scanning mode that provides contextual suggestions based on the current context of the physical environment without requiring a triggering event/condition. Requiring an additional trigger condition to provide scan feedback based on optical sensor data in the first scan mode without requiring the additional trigger condition to provide scan feedback based on optical sensor data in the second scan mode reduces the power usage and improves the battery life of the computer system by providing limited, contextually-relevant scan feedback in the first mode while providing users with the flexibility to access additional scan feedback in the second mode.

In some embodiments, while scanning the physical environment, the computer system displays, via one or more display generation components of the one or more output devices, a respective user interface (e.g., 710) (e.g., a scan user interface, a scan result user interface, a suggestion user interface, an application user interface, and/or a watch face user interface) without displaying a representation of a field-of-view of the physical environment captured via the one or more optical sensors (e.g., as illustrated in FIGS. 7C-7G, 7N-7P, 9C-9E, 9G-9K, and/or 11D) (e.g., an optical sensor data preview, such as a live or near-live viewfinder of the physical environment). In some embodiments, the computer system provides the scanning feedback indicating the information about the physical environment without displaying a representation of a field-of-view of the physical environment captured via the one or more optical sensors (e.g., as described with respect to FIGS. 7A-8). Scanning the physical environment without displaying an optical representation of the physical environment (e.g., a live- or near-live viewfinder) provides improved control of computer system functionality without cluttering the user interface with additional displayed controls and assists the user with interacting with the physical environment via the computer system. For example, the different types of scan feedback provided while scanning provides users with information about a physical environment and/or computer system functionality related to the physical environment without expending additional processing or power resources to display a camera (or other optical sensor) feed.

In some embodiments, while scanning the physical environment and in accordance with a determination that the first scan mode is active, the computer system displays, via one or more display generation components of the one or more output devices, a scanning user interface (e.g., 710) (e.g., a user interface including scanning prompts and/or results, as described with respect to FIGS. 7A-10). In some embodiments, while scanning the physical environment and in accordance with a determination that the second scan mode is active, the computer system forgoes displaying the scanning user interface (e.g., as illustrated in FIGS. 11B-11C and/or 11F-11K) (e.g., the second scan mode is a passive/ambient scan mode performed as a background process). Conditionally displaying a scan-specific user interface depending on the active scan mode provides improved control of computer system functionality without cluttering the user interface with additional displayed controls (e.g., by providing certain scan functionality and feedback without displaying additional controls in the first mode) and provides improved visual feedback to the user (e.g., by providing the user with displayed scan prompts, symbolic representations of detected objects, and/or other visual information relevant to the physical environment in the second mode).

In some embodiments, prior to scanning the physical environment, the computer system displays, via one or more display generation components of the one or more output devices, a respective user interface (e.g., 707) (e.g., as illustrated in FIGS. 7B and/or 11A). In some embodiments, while scanning the physical environment and in accordance with a determination that the second scan mode is active, the computer system maintains displaying the respective user interface while capturing the optical scan data (e.g., as illustrated in FIGS. 11B-11C and/or 11F-11I). For example, in the second scan mode, the computer system maintains a previous display state (e.g., without displaying a scan-specific user interface) at least until the second process provides scanning feedback including display content. In some embodiments, providing the second scanning feedback includes displaying a visual output while maintaining displaying at least a portion of the respective user interface (e.g., the computer system provides the scanning feedback as a partial overlay of the previous user interface). In some embodiments, while scanning the physical environment, in accordance with a determination that the first scan mode is active, the computer system ceases displaying the respective user interface and, optionally, displays, via the one or more display generation components, a scanning user interface, scanning feedback, and/or scan results.

In some embodiments, aspects/operations of methods 800, 1000, 1200, and/or 1300 may be interchanged, substituted, and/or added between these methods. For example, the different scan modes according to method 1200 optionally include scan modes for providing symbolic representations of detected objects according to method 800, scan modes that include providing scanning prompts according to method 1000, and/or scan modes that include providing conditional alerts according to method 1300. For brevity, these details are not repeated here.

FIG. 13 is a flow diagram of an exemplary method 1300 for providing alerts based on different information detected while scanning a physical environment, in some embodiments. In some embodiments, method 1300 is performed at a computer system (e.g., computer system 101 in FIG. 1A and/or computer system 700) (e.g., including one or more mobile phones, personal computers, laptops, tablets, smart watches, head-mounted displays, other wearable devices, and/or other electronic devices) that is in communication with one or more output devices (e.g., display generation components (e.g., a display controller; a touch-sensitive display system; a display (e.g., 704) (e.g., integrated and/or connected), a 3D display, a transparent display, a projector, and/or a heads-up display), audio generation components (e.g., an audio controller, one or more speakers, and/or other integrated and/or connected audio output devices), and/or tactile output generation components (e.g., haptic generators)) and one or more sensors, wherein the one or more sensors includes one or more optical sensors (e.g., 6-106, 6-108, 6-114, 6-118, 6-118, 706A, 706B, and/or 706C) (e.g., imaging sensors (e.g., visible light and/or IR cameras), depth sensors (e.g., structural light sensors, time-of-flight sensors (e.g., LIDAR), and/or stereoscopic camera sensors), and/or light sensors) and one or more spatial information sensors (e.g., one or more motion, orientation, and/or location sensors, such as accelerometers, gyroscopes, magnetometers, inertial measurement units (IMUs), and/or location sensors) (in some embodiments, the one or more sensors include one or more other sensors, such as capacitive sensors, intensity sensors, motion sensors, vibration sensors, audio sensors, temperature sensors, and/or biometric sensors). In some embodiments, the computer system includes a wrist-worn device (e.g., 700A). In some embodiments, the optical sensors are housed within the same device as at least one display (e.g., 704) (e.g., the computer system includes a wrist-worn device that houses both a display and the one or more optical sensors). In some embodiments, the optical sensors point in a direction that is within a threshold range (e.g., within 10°, 30°, 45°, or 60°) of perpendicular to a plane of a display (e.g., as illustrated in FIG. 11L) (e.g., the optical sensors point in one or more directions that are within a threshold range of parallel to the surface of the display). In some embodiments, the motion, orientation, and/or location sensors measure the movement and/or orientation of the optical sensors (e.g., the IMU and optical sensors operate within the same inertial frame of reference). In some embodiments, the computer system is optionally in communication with one or more input devices, such as touch-sensitive surfaces (e.g., of display 704), hardware input devices (e.g., 702A and/or 702B) (e.g., hardware buttons, switches, keys, and/or dials), microphones, gesture input devices, air gesture input devices, and/or gaze input devices. In some embodiments, method 1300 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1300 are, optionally, combined and/or the order of some operations is, optionally, changed.

The computer system detects (1302), based at least in part on spatial information (e.g., motion, orientation, and/or location data) captured via the one or more spatial information sensors that indicates a location and/or movement of the computer system, occurrence of an event (e.g., as described with respect to FIGS. 11A and/or 11F-11K) (e.g., arrival at a location, departure from a location, movement between locations, a user gesture, a user pose, a physical user activity, a sudden movement, a sudden halt in movement, and/or another occurrence at least partially detectable using the spatial information sensors).

In response to detecting the occurrence of the event based on the spatial information, the computer system generates (1304), via the one or more output devices, an alert (e.g., 1102A-1102F, 1114A, 1116, 1118A-1118B, 1120, and/or 1122A-1122C) based on optical sensor data captured via the one or more optical sensors (e.g., as illustrated in FIGS. 11B, 11F, and/or 11H-11K) (e.g., that are different from the one or more spatial information sensors). In some embodiments, generating the alert includes providing, via the one or more output devices, one or more display outputs (e.g., a displayed notification and/or user interface including graphics, text, user interface objects, and/or other visual elements), audio outputs, and/or tactile outputs. In some embodiments, generating the alert includes providing the one or more outputs at a respective time after detecting the occurrence of the event, for instance, at a time when specific conditions are detected in the physical environment by the one or more sensors.

Generating (1304) the alert includes, in accordance with a determination that first information (e.g., information indicating the presence of a specific event condition in the physical environment, such as specific surroundings, objects, and/or activities relevant to the event) is detected based on the optical sensor data captured via the one or more optical sensors (e.g., is detected within the field-of-view of the one or more optical sensors), generating (1306) a first alert including first content. For example, the computer system processes the optical sensor data using optical processing techniques, such as algorithmic image processing, machine vision, and/or other machine learning techniques, to detect information about the physical environment, such as identifying people, pets, text, symbols, plants, food items, landmarks, surroundings, displayed content, and/or user belongings. In some embodiments, in accordance with a determination that the first information is detected, the computer system generates a first type of alert (e.g., an alert of a particular format, output modality, output timing, and/or type of information/content). In some embodiments, the first alert including the first content is the first type of alert. Generating (1304) the alert includes, in accordance with a determination that second information is detected based on the optical sensor data captured via the one or more optical sensors, wherein the second information is different from the first information (e.g., the second information indicates the presence of a different event condition in the physical environment than the first information), generating (1308) a second alert including second content, wherein the second content is different from the first content (e.g., the second content is a different type of content, includes different information, and/or is provided using a different output modality). In some embodiments, in accordance with a determination that the second information is detected, the computer system generates a second type of alert that is different from the first type of alert. In some embodiments, the second alert including the second content is the second type of alert. Generating alerts in response to detected spatial (e.g., movement and/or location) events, where different alerts are generated based on different information detected based on optical sensor data (e.g., information about the visible surroundings of the physical environment) reduces the number of inputs needed to perform an operation and provides improved feedback to the user, which reduces the power usage and improves the battery life of the computer system by enabling the user to use the device more quickly and efficiently. For example, the computer system uses the optical sensor data to confirm and/or refine the detection of the spatial event, thereby providing the user with alerts that include more accurate, context-specific information and/or functionality. Surfacing accurate, context-specific alerts to the user assists the user in using the computer system to interact with the environment without needing to provide additional inputs specifying the current environmental context and/or manually seeking out relevant information/functionality. Generating optical sensor data-based alerts in response to detected spatial events also improves computer system efficiency by distributing context gathering between different types of sensors (e.g., the spatial information sensors and optical sensors). For example, confirming and/or refining detection of a spatial event using optical sensor data allows the computer system to provide more accurate, context-specific alerts using lower-resolution, lower-rate, and/or lower-quality sensor data and/or data processing techniques, reducing the time and/or power usage required.

In some embodiments, detecting the occurrence of the event includes detecting that a location of the computer system corresponds to a respective location (e.g., as described with respect to FIGS. 11A-11B and/or 11F-11K). For example, generating the alert is enabled and/or triggered based on the user of the computer system being in a particular location (e.g., the user's home, the user's workplace, the user's gym, a city, a neighborhood, and/or a national park) and/or a particular type of location (e.g., a residence address, a commercial address, a gym, an airport, and/or a park). In some embodiments, the first information includes information corresponding to a first sub-location of the respective location, and the second information includes information corresponding to a second sub-location of the respective location that is different from the first sub-location. For example, the optical sensor data includes information indicating a more specific (e.g., more precise) location than the location detected using the one or more spatial information sensors, and the computer system provides different alerts at the respective location depending on the specific/precise location determined using the optical sensor data. Generating alerts in response to detected location events, where different alerts are generated based on different information detected based on optical sensor data (e.g., information about the visible surroundings of the physical environment) reduces the number of inputs needed to perform an operation and provides improved feedback to the user.

In some embodiments, the first information indicates that the location of the computer system corresponds to a cabin of an airplane at the respective location; and generating the first alert including the first content includes activating an airplane mode of the computer system (e.g., a mode in which the computer system temporarily disables communication via one or more communication networks, such as a cellular network and/or a WiFi network). For example, the respective location is an airport, airport building (e.g., a particular terminal), and/or a location with an airport (e.g., the airport grounds or neighborhood). In some embodiments, activating the airplane mode includes displaying an alert, such as a notification with text indicating that the airplane mode has been automatically activated and/or an airplane mode status icon. In some embodiments, activating the airplane mode includes providing a non-visual output, such as an audio output and/or tactile output alerting the user that the airplane mode has been automatically activated. Generating alerts that include activating an airplane mode in response to detecting information indicating that the location is an airplane cabin, where different alerts are generated based on different information detected based on optical sensor data (e.g., information about the visible surroundings of the physical environment) reduces the number of inputs needed to perform an operation and provides improved feedback to the user.

In some embodiments, the first information indicates that the location of the computer system corresponds to an entertainment venue at the respective location; and generating the first alert including the first content includes activating a theater mode of the computer system (e.g., a mode in which the computer system temporarily disables (e.g., delays and/or suppresses) providing one or more types of notification outputs, such as audio outputs, display outputs, and/or tactile outputs indicating that a notification is available for the user). For example, the respective location is a location that includes a theater, a school, a performance venue, and/or a convention center, and the first information includes information corresponding to an auditorium, audience seating area, and/or other venue location. In some embodiments, activating the theater mode includes providing an output indicating that theater mode has been activated, such as displaying a theater mode status icon and/or providing a tactile output. Generating alerts that include activating a theater mode in response to detecting information indicating that the location is an auditorium, where different alerts are generated based on different information detected based on optical sensor data (e.g., information about the visible surroundings of the physical environment) reduces the number of inputs needed to perform an operation and provides improved feedback to the user.

In some embodiments, the first information indicates that the location of the computer system corresponds to a food service establishment (e.g., a restaurant. café, food hall, and/or other food service establishment) at the respective location (e.g., as illustrated in FIG. 11A); and generating the first alert including the first content includes displaying (e.g., via one or more display generation components of the one or more output devices) a tip (e.g., gratuity) calculator user interface object (e.g., 1102A) that, when selected, initiates a process for calculating a tip (e.g., as illustrated FIG. 11B) (e.g., a software button for calculating a tip and/or accessing a tip calculator). For example, the tip calculator user interface object includes one or more selectable user interface objects that, when selected, calculate a tip of a particular amount (e.g., 5%, 10%, 15%, 18%, 20%, 25%, or 30%), for instance, based on a bill and/or other cost information detected using the optical sensors. Generating alerts that include displaying a tip calculator utility in response to detecting that the location is restaurant location, where different alerts are generated based on different information detected based on optical sensor data (e.g., information about the visible surroundings of the physical environment) reduces the number of inputs needed to perform an operation and provides improved feedback to the user.

In some embodiments, the first information indicates that the location of the computer system corresponds to a first room of the respective location; and generating the first alert including the first content includes displaying, via one or more display generation components of the one or more output devices, a first set of one or more control user interface objects corresponding to a first set of one or more devices associated with the respective location (e.g., software home automation controls for a particular subset of smart home devices). For example, the respective location is a home, another lodging (e.g., a hotel, dormitory, and/or rental home), and/or another building (e.g., an office and/or commercial establishment) instrumented with smart home devices that a user can control via the computer system. In some embodiments, the first set of one or more devices include one or more smart home devices associated with the first room, such as a smart light device located in the first room and/or a smart thermostat that controls the climate in the first room. In some embodiments, the second information indicates that the location of the computer system corresponds to a second room of the respective location that is different from the first room of the respective location, and generating the second alert including the second content includes displaying (e.g., via one or more display generation components of the one or more output devices) a second set of one or more control user interface objects corresponding to a second set of one or more devices associated with the respective location, wherein the second set of one or more devices is different from the first set of one or more devices (e.g., software home automation controls for a different set of smart home devices). In some embodiments, the second set of one or more devices include one or more smart home devices associated with the second room, such as a smart television located in the second room and/or a smart thermostat that controls the climate in the second room. In some embodiments, the first and second set of devices partially overlap (e.g., if both rooms use the same smart thermostat). Generating alerts that include displaying controls for a particular set of devices in response to detecting that the location is a room associated with the particular set of devices, where different alerts are generated based on different information detected based on optical sensor data (e.g., information about the visible surroundings of the physical environment) reduces the number of inputs needed to perform an operation and provides improved feedback to the user.

In some embodiments, the first information indicates that the respective location is near (e.g., physically close to) a first device (e.g., a smart home device that can be controlled via the computer system); and generating the first alert including the first content includes displaying (e.g., via one or more display generation components of the one or more output devices) a first control user interface object that, when selected, initiates a process for controlling the first device (e.g., the first control user interface object includes software home automation controls for the first device). In some embodiments, the first information indicates that respective location is near the first device if the first device is included within a field-of-view of the one or more optical sensors (e.g., the computer system identifies the first device from the optical sensor data). In some embodiments, the first information indicates that respective location is near the first device if the optical sensor data indicates that the respective location is within a threshold distance (e.g., 2 inches, 6 inches, 2 feet, 5 feet, 10 feet, or 50 feet) of the first device (e.g., the computer system determines a proximity of the first device from depth information included in the optical sensor data). In some embodiments, the second information indicates that the respective location is near a second device that is different from the first device; and generating the second alert including the first content includes displaying (e.g., via one or more display generation components of the one or more output devices) a second control user interface object that, when selected, initiates a process for controlling the second device (e.g., the second control user interface object includes software home automation controls for the first device). In some embodiments, the computer system detects an input directed to the first user interface control object and, in response to detecting the input, initiates the process for controlling the first device. For example, the process for controlling the first device includes changing a state of the first device (e.g., turning the first device on or off and/or setting an operation mode for the first device), performing an action using the first device (e.g., playing media on a speaker and/or television system, preheating an oven, and/or unlocking a door), and/or setting a parameter for an action performed using the first device (e.g., selecting a thermostat set point, turning media playback volume up or down, and/or dimming or brightening a light). Generating alerts that include displaying controls for a particular device in response to detecting that the location is close to the particular device, where different alerts are generated based on different information detected based on optical sensor data (e.g., information about the visible surroundings of the physical environment) reduces the number of inputs needed to perform an operation and provides improved feedback to the user.

In some embodiments, detecting the occurrence of the event includes detecting that the computer system has departed from a respective location (e.g., as illustrated in FIGS. 11H-11I) (e.g., has left or moved more than a threshold distance from a particular location). In some embodiments, detecting the departure includes detecting the computer system arriving at and/or leaving a particular location and/or a particular type of location. In some embodiments, detecting the includes detecting the computer system moving by at least a threshold amount/magnitude (e.g., leaving a 50, 100, 1,000, or 2,000 foot radius of the user's home, walking half a mile, and/or crossing a city limit) from a previous location. In some embodiments, the first information includes information corresponding departing from a first location, and the second information includes information corresponding to departing from a second location that is different from the first location. For example, the optical sensor data includes information indicating a more specific (e.g., more precise) location than the location detected using the one or more spatial information sensors. In some embodiments, the first information includes information corresponding to first departure conditions, and the second information includes information corresponding to second departure conditions that are different from the first departure conditions.

In some embodiments, the respective location includes a respective section (e.g., an aisle, counter, and/or department) of a retail location (e.g., a grocery store, hardware store, bulk retailer, and/or department store), and the first information indicates that a user of the computer system has not obtained a respective item included in a shopping list (e.g., a shopping list associated with the retail location such as a particular store and/or a shopping list associated with a particular category of retail location like a grocery shopping list for a grocery store or a hardware shopping list for a hardware store), wherein the respective item is associated with the respective section of the retail location (e.g., as illustrated in FIGS. 11H-11I) (e.g., the optical sensors have not detected the user picking up the item and/or do not detect the item in the user's shopping basket or cart when the user leaves the area of the retail establishment where the item is found).

In some embodiments, the first information includes information corresponding to detecting, via the one or more optical sensors, a first object (e.g., and/or a first type of object), and the second information includes information corresponding to detecting, via the one or more optical sensors, a second object that is different from the first object (e.g., as illustrated in FIGS. 11B, 11F, and/or 11H-11K) (e.g., and/or a second type of object that is different from the first type of object). In some embodiments, detecting the occurrence of the event includes detecting a particular location, a particular change in location, a particular movement, and/or a particular change in movement. Providing different alerts based on detecting different objects in the physical environment with the optical sensors reduces the number of inputs needed to perform an operation and provides improved feedback to the user, for example, by surfacing relevant information and/or functionality without the user needing to provide additional inputs specifying relevant objects in the physical environment and/or manually seeking the information/functionality. In some embodiments, the first object is an object (e.g., 1100G) that is not included in a predetermined set of objects (e.g., 1112) (e.g., not in a shopping list). In some embodiments, the first information corresponds to detecting the user obtaining the “wrong” item in a store compared to the items included in the shopping list.

In some embodiments, generating the alert includes providing (e.g., outputting) a respective alert output (e.g., a visual, audio, and/or tactile output), wherein providing the respective alert output includes: in accordance with a determination that respective context information is detected based on sensor data captured via the one or more sensors (e.g., information indicating the presence of specific environmental context, such as specific surroundings, objects, and/or activities), providing, via the one or more output devices, the respective alert output at a first time; and in accordance with a determination that the respective context information is not detected based on sensor data captured via the one or more sensors, providing, via the one or more output devices, the respective alert output at a second time that is different from the first time (e.g., as described with respect to FIGS. 11B-11C). In some embodiments, the respective context information is information that indicates an alert output should be delayed (e.g., the respective alert output is provided after a respective delay). In some embodiments, if information that indicates that the alert output should be delayed is not detected, the computer system provides the respective alert output without delay. In some embodiments, the first time is selected based on the first context information. For example, the respective alert output is provided once the respective context information is no longer detected based on the sensor data captured via the one or more sensors. Timing the provision of alerts in response to detecting spatial events based on sensor data detected from the physical environment performs an operation when a set of conditions has been met without requiring further user input and provides improved feedback to the user. For example, the computer system automatically surfaces information and/or functionality to the user at a convenient time, while reducing time and power expended providing the alert when the sensor data indicates the user is preoccupied, distracted, and/or engaged in an activity that should not be interrupted.

In some embodiments, the alert includes respective content that is based on an incoming communication (e.g., 1102C) (e.g., the alert is generated in response to receiving a communication at the computer system, such as a text message, chat message, email, phone call, and/or video call), and the respective context information includes information indicating that a user of the computer system is interacting with one or more people in a physical environment (e.g., as described with respect to FIGS. 11B-11C) (e.g., the user is talking to other people, in a meeting with other people, and/or having a meal with other people). For example, if the one or more sensors detect that the user is interacting with people in the physical environment, alerts generated based on incoming communications are delayed (in some embodiments, until the one or more sensors detect that the interaction has ended, paused, and/or changed in a manner that indicates that the alert will not inappropriately interrupt the interaction). Timing the provision of an alert based on an incoming communication in response to detecting spatial events based on sensor data indicating that the user is currently interacting with other people in the physical environment performs an operation when a set of conditions has been met without requiring further user input and provides improved feedback to the user. Doing so also reduces the risk that the alert is missed by the user (e.g., due to the user not noticing and/or not wanting to interrupt the personal interaction), which improves conserves computer system resources by reducing the need to repeat and/or maintain provision of the alert.

In some embodiments, detecting the occurrence of the event includes detecting a respective motion (e.g., as described with respect to FIGS. 11J-11K) (e.g., and/or type of motion). For example, the respective motion includes a motion of a user's body and/or body parts, such as a crash, a fall, and/or a workout motion. In some embodiments, the first content includes a respective portion of the first information detected based on the optical sensor data (e.g., 1120, 1120A, and/or 1102F, as illustrated in FIG. 11J), and the second content includes a respective portion of the second information detected based on the optical sensor data (e.g., 1122 and/or 1122A, as illustrated in FIG. 11K). For example, the generated alert includes a description and/or other information indicating one or more features of the user's surroundings at the time of the respective motion event. Providing alerts that include information about the physical environment in response to detecting a respective motion performs an operation when a set of conditions has been met without requiring further user input and provides improved feedback to the user. For example, surfacing accurate, context-specific alert information to the user assists the user in using the computer system to interact with the environment without needing to provide additional inputs specifying the current environmental context.

In some embodiments, detecting the respective motion includes detecting a crash motion (e.g., a sudden and/or significant deceleration indicating a collision with something in the physical environment) and/or a fall motion (e.g., a sudden and/or significant acceleration indicating the user falling, tripping, slipping, collapsing, and/or fainting) (e.g., as described with respect to FIG. 11K). Providing alerts that include information about the physical environment in response to detecting a crash/fall motion performs an operation when a set of conditions has been met without requiring further user input and provides improved feedback to the user.

In some embodiments, detecting the respective motion includes detecting an initiation of a respective exercise motion (e.g., as described with respect to FIG. 11J) (e.g., the user begins to move in a manner indicating a workout such as running, biking, swimming, lifting weights, doing yoga, and/or playing a sport). Providing alerts that include information about the physical environment in response to detecting initiation of a workout activity performs an operation when a set of conditions has been met without requiring further user input and provides improved feedback to the user. In some embodiments, detecting the respective motion includes detecting an end of a respective exercise motion (e.g., the user stops moving in a manner indicating a workout). Providing alerts that include information about the physical environment in response to detecting the end of a workout activity performs an operation when a set of conditions has been met without requiring further user input and provides improved feedback to the user.

In some embodiments, the first information includes information indicating that the respective motion is a first type of exercise motion, and the second information includes information indicating that the respective motion is a second type of exercise motion that is different from the first type of exercise motion (e.g., as described with respect to FIG. 11J). For example, the computer system identifies the specific type of exercise motion based at least in part on the optical sensor data and generates an alert that identifies the detected exercise type and/or provides related functionality (e.g., an option to begin tracking a workout of the identified type and/or a user interface for tracking the workout of the identified type). For example, if the respective motion indicates that the user is playing a sport, the computer system provides a workout tracking user interface for a tennis workout based on detecting a tennis court, tennis net, tennis racket, and/or tennis ball, and the computer system provides a workout tracking user interface for a basketball workout based on detecting a basketball court, basketball hoop, and/or basketball. For example, if the respective motion indicates that the user is lifting weights, the computer system provides different workout tracking information based on detecting different weights (e.g., 5 pounds, 10 pounds, 40 pounds, 100 pounds, or a different size of weight) and/or different types of lifts (e.g., curls, lifts, pulls, presses, and/or squats). Providing different alerts that include information about an identified type of workout in response to detecting a respective motion (e.g., an exercise motion) performs an operation when a set of conditions has been met without requiring further user input and provides improved feedback to the user.

In some embodiments, the first information includes information corresponding to a first condition of a physical environment captured via the one or more sensors, and the second information includes information corresponding to a second condition of the physical environment captured via the one or more sensors (e.g., as described with respect to FIGS. 11J-11K). For example, the computer system generates alerts based on detecting various temperature, UV rating, humidity, precipitation, and/or noise level conditions. Providing alerts based on conditions detected in the physical environment in response to detecting a respective motion provides improved feedback to the user. For example, surfacing accurate, context-specific alert information to the user assists the user in using the computer system to interact with the environment without needing to provide additional inputs specifying the current environmental conditions.

In some embodiments, the first information is further detected based on respective information that is not captured via the one or more sensors (e.g., as described with respect to FIGS. 11C and/or 11F-11I). For example, the computer system generates the alert based on the optical sensor data combined with additional information, such as information obtained from an external source (e.g., an internet search, a weather service, and/or an incoming communication), user information (e.g., user settings, usage history, and/or a media library), and/or application information (e.g., information from a weather application, workout application, health application, notes application, and/or messaging application). Providing alerts in response to detected spatial events, where the alerts are based on both optical sensor data and additional context information reduces the number of inputs needed to perform an operation and provides improved feedback to the user. For example, supplementing the optical sensor data with non-sensor data allows the computer system to further confirm and/or refine contextual understanding and thus to provide more accurate and context-specific alerts.

In some embodiments, the respective information includes information associated with a user of the computer system. For example, detecting the first information indicates a user-specific event condition, such as detecting a particular object owned by the user and/or detecting information that is likely to be of interest to the user. In some embodiments, the information associated with the user of the computer system includes user-provided text (e.g., 1114, as described with respect to FIGS. 11F-11I). In some embodiments, the user-provided text includes text directly input by the user (e.g., typed, written, copied/pasted, and/or saved text), text extracted from an audio input (e.g., text representing speech recognized from a voice memo, dictation input, speech input, and/or media capture), and/or text extracted from a visual input (e.g., text represented in a media item (e.g., a photo, video, and/or screen capture) and/or optical sensor data). For example, the computer system uses a large-language model (e.g., and/or another intelligence model) to analyze a note, message, email, and/or other item of user data to automatically set up reminders to be provided when an event occurs, such as analyzing a user-provided grocery list (e.g., text of a grocery list extracted from a photo of a grocery list, a notes application, and/or a voice memo) to set up reminders to be provided when the user moves between different aisles of the grocery store.

In some embodiments, aspects/operations of methods 800, 1000, 1200, and/or 1300 may be interchanged, substituted, and/or added between these methods. For example, providing the conditional alerts according to method 1300 optionally includes providing symbolic representations of detected objects according to method 800 and/or providing scanning prompts according to method 1000. For example, the scanning modes of method 1200 optionally include a mode for providing conditional alerts according to method 1300. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve scanning the physical environment and providing relevant and useful scan results. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to customize and/or refine results of scanning the physical environment. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing users with environmental scan results, the present technology can be configured to allow users to select to “opt in” or “opt out” of participation in the collection of personal information data during registration for services or anytime thereafter. In another example, users can select not to provide data for use in providing scan results. In yet another example, users can select to limit the length of time data is maintained or entirely prohibit its use for providing scan results. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, scan results can be generated by inferring preferences based on non-personal information data or a bare minimum amount of personal information, such as the content being requested by the device associated with a user, other non-personal information available to the service, or publicly available information.

1-116. (canceled)

117. A computer system configured to communicate with one or more output devices and one or more sensors, wherein the one or more sensors includes one or more optical sensors and one or more spatial information sensors, the computer system comprising:
one or more processors; and
memory storing one or more programs configured to be executed by the one or more processors, the one or more programs including instructions for:
detecting, based at least in part on spatial information captured via the one or more spatial information sensors that indicates a location and/or movement of the computer system, occurrence of an event; and
in response to detecting the occurrence of the event based on the spatial information, generating, via the one or more output devices, an alert based on optical sensor data captured via the one or more optical sensors, wherein generating the alert includes:
in accordance with a determination that first information is detected based on the optical sensor data captured via the one or more optical sensors, generating a first alert including first content; and
in accordance with a determination that second information is detected based on the optical sensor data captured via the one or more optical sensors, wherein the second information is different from the first information, generating a second alert including second content, wherein the second content is different from the first content.

118. The computer system of claim 117, wherein detecting the occurrence of the event includes detecting that a location of the computer system corresponds to a respective location.

119. The computer system of claim 118, wherein:
the first information indicates that the location of the computer system corresponds to a cabin of an airplane at the respective location; and
generating the first alert including the first content includes activating an airplane mode of the computer system.

120. The computer system of claim 118, wherein:
the first information indicates that the location of the computer system corresponds to an entertainment venue at the respective location; and
generating the first alert including the first content includes activating a theater mode of the computer system.

121. The computer system of claim 118, wherein:
the first information indicates that the location of the computer system corresponds to a food service establishment at the respective location; and
generating the first alert including the first content includes displaying a tip calculator user interface object that, when selected, initiates a process for calculating a tip.

122. The computer system of claim 118, wherein:
the first information indicates that the location of the computer system corresponds to a first room of the respective location; and
generating the first alert including the first content includes displaying, via one or more display generation components of the one or more output devices, a first set of one or more control user interface objects corresponding to a first set of one or more devices associated with the respective location.

123. The computer system of claim 118, wherein:
the first information indicates that the respective location is near a first device; and
generating the first alert including the first content includes displaying a first control user interface object that, when selected, initiates a process for controlling the first device.

124. The computer system of claim 117, wherein:
detecting the occurrence of the event includes detecting that the computer system has departed from a respective location.

125. The computer system of claim 124, wherein:
the respective location includes a respective section of a retail location; and
the first information indicates that a user of the computer system has not obtained a respective item included in a shopping list, wherein the respective item is associated with the respective section of the retail location.

126. The computer system of claim 117, wherein:
the first information includes information corresponding to detecting, via the one or more optical sensors, a first object; and
the second information includes information corresponding to detecting, via the one or more optical sensors, a second object that is different from the first object.

127. The computer system of claim 126, wherein the first object is an object that is not included in a predetermined set of objects.

128. The computer system of claim 117, wherein generating the alert includes:
providing a respective alert output, wherein providing the respective alert output includes:
in accordance with a determination that respective context information is detected based on sensor data captured via the one or more sensors, providing, via the one or more output devices, the respective alert output at a first time; and
in accordance with a determination that the respective context information is not detected based on sensor data captured via the one or more sensors, providing, via the one or more output devices, the respective alert output at a second time that is different from the first time.

129. The computer system of claim 128, wherein:
the alert includes respective content that is based on an incoming communication; and
the respective context information includes information indicating that a user of the computer system is interacting with one or more people in a physical environment.

130. The computer system of claim 117, wherein:
detecting the occurrence of the event includes detecting a respective motion;
the first content includes a respective portion of the first information detected based on the optical sensor data; and
the second content includes a respective portion of the second information detected based on the optical sensor data.

131. The computer system of claim 130, wherein detecting the respective motion includes detecting a crash motion and/or a fall motion.

132. The computer system of claim 130, wherein detecting the respective motion includes detecting an initiation of a respective exercise motion.

133. The computer system of claim 130, wherein detecting the respective motion includes detecting an end of a respective exercise motion.

134. The computer system of claim 130, wherein:
the first information includes information indicating that the respective motion is a first type of exercise motion; and
the second information includes information indicating that the respective motion is a second type of exercise motion that is different from the first type of exercise motion.

135. The computer system of claim 117 wherein:
the first information includes information corresponding to a first condition of a physical environment captured via the one or more sensors; and
the second information includes information corresponding to a second condition of the physical environment captured via the one or more sensors.

136. The computer system of claim 117, wherein the first information is further detected based on respective information that is not captured via the one or more sensors.

137. The computer system of claim 136, wherein the respective information includes information associated with a user of the computer system.

138. The computer system of claim 137, wherein the information associated with the user of the computer system includes user-provided text.

139. A non-transitory computer-readable storage medium storing one or more programs configured to be executed by one or more processors of a computer system that is in communication with one or more output devices and one or more sensors, wherein the one or more sensors includes one or more optical sensors and one or more spatial information sensors, the one or more programs including instructions for:
detecting, based at least in part on spatial information captured via the one or more spatial information sensors that indicates a location and/or movement of the computer system, occurrence of an event; and
in response to detecting the occurrence of the event based on the spatial information, generating, via the one or more output devices, an alert based on optical sensor data captured via the one or more optical sensors, wherein generating the alert includes:
in accordance with a determination that first information is detected based on the optical sensor data captured via the one or more optical sensors, generating a first alert including first content; and
in accordance with a determination that second information is detected based on the optical sensor data captured via the one or more optical sensors, wherein the second information is different from the first information, generating a second alert including second content, wherein the second content is different from the first content.

140. A method, comprising:
at a computer system that is in communication with one or more output devices and one or more sensors, wherein the one or more sensors includes one or more optical sensors and one or more spatial information sensors:
detecting, based at least in part on spatial information captured via the one or more spatial information sensors that indicates a location and/or movement of the computer system, occurrence of an event; and
in response to detecting the occurrence of the event based on the spatial information, generating, via the one or more output devices, an alert based on optical sensor data captured via the one or more optical sensors, wherein generating the alert includes:
in accordance with a determination that first information is detected based on the optical sensor data captured via the one or more optical sensors, generating a first alert including first content; and
in accordance with a determination that second information is detected based on the optical sensor data captured via the one or more optical sensors, wherein the second information is different from the first information, generating a second alert including second content, wherein the second content is different from the first content.
